SEQUENCE LISTING (2 sequences)

SEQ ID NO: 1 - DNA, 42 bp, Artificial Sequence
  Synthetic oligonucleotide
tacgccctaagaatccgaactttacgccctaagaatccgaac

SEQ ID NO: 2 - DNA, 20 bp, Artificial Sequence
  Synthetic oligonucleotide
gttcggattcttagggcgta

(19) United States
(12) Patent Application Publication
(10) Pub. No.: US 2017/0276578 A1
(43) Pub. Date: Sep. 28, 2017

(54) EXPANSION MICROSCOPY METHODS AND KITS

(71) Applicant: University of Washington, Seattle, WA (US)

(72) Inventors: Joshua Charles VAUGHAN, Seattle, WA (US); Tyler J. CHOZINSKI, Seattle, WA (US); Aaron R. HALPERN, Seattle, WA (US); Hyeon-Jin KIM, Seattle, WA (US)

(21) Appl. No.: 15/466,025

(22) Filed: Mar. 22, 2017

Related U.S. Application Data
(60) Provisional application No. 62/320,301, filed on Apr. 8, 2016.
(60) Provisional application No. 62/311,638, filed on Mar. 22, 2016.

(51) Int. Cl. G01N 1/36; G01N 1/30

(52) U.S. Cl. CPC G01N 1/36; G01N 1/30; G01N 2001/364

(57) ABSTRACT

Methods and kits useful in expansion microscopy are described. In particular, the present disclosure relates to methods and kits for expanding or enlarging fixed samples of interest for microscopy by synthesizing a water-swellable compound within a fixed sample, which can be physically expanded, resulting in physical magnification of the sample. Furthermore, the methods and kits disclosed allow the use of fluorescent proteins expressed within the sample and/or the use of standard fluorophore-labeled secondary antibodies (referred to as conventional secondary antibodies) in expansion microscopy (ExM). Thus, conventional secondary antibodies and/or fluorescent proteins expressed within the sample can be used with conventional immunostaining for the optical imaging of a sample of interest with resolution better than the standard microscopy diffraction limit.

### CROSS REFERENCE

This application is a non-provisional application of, and claims the benefit of priority to, U.S. Application Ser. No. 62/311,638, filed Mar. 22, 2016, and U.S. Application No. 62/320,301, filed Apr. 8, 2016, the disclosures of each of which are incorporated by reference herein in their entirety.

### STATEMENT REGARDING FEDERALLY SPONSORED RESEARCH

This invention was made with U.S. government support under DGE-1256082, awarded by the National Science Foundation, and under EY10699 and EY17101, awarded by the National Institutes of Health. The U.S. Government has certain rights in the invention.

### SEQUENCE LISTING

The sequence listing submitted herewith, entitled “17-077-US_SequenceListing_ST25.txt” and 1 kb in size, is incorporated by reference in its entirety.

### BACKGROUND

Expansion Microscopy (ExM) has been shown to be a super-resolution microscopy technique that uses physical expansion of fixed specimens to allow features closer than the diffraction limit of light (˜250 nm) to become resolvable in the expanded specimen (see Chen et al., Science 347:543-48 (2015)). Unlike other super-resolution techniques which rely on specialized instruments, ExM is compatible with standard microscopes (e.g., widefield, confocal, etc.) and is poised to make a significant impact based on its accessibility and on its strong performance in thick specimens.

In the initial report on ExM, imaging with ˜65 nm resolution was demonstrated in cultured cells and in brain tissue using a procedure entailing: staining of a specimen with polymer-linkable probes, growth of a swellable polymer within the specimen which links to the probes, protease digestion of the specimen, and expansion of the polymer through dialysis. The polymer-linkable probes consisted of antibodies labeled with doubly-modified DNA oligonucleotides containing a fluorophore and a methacryloyl group designed to become covalently incorporated into the polymer. These DNA-labeled antibodies are custom-made and require a 1-2 day multi-step protocol to prepare with expensive reagents.

The presently available methods require extensive sample preparation and custom reagents. There is currently a need for ExM using commonly available reagents and/or less sample preparation.

### SUMMARY

The present disclosure relates to methods and kits for expanding or enlarging fixed samples of interest for microscopy by synthesizing a water-swellable compound within a fixed sample, which can be physically expanded, resulting in physical magnification of the sample. Furthermore, the methods and kits disclosed allow the use of fluorescent proteins expressed within the sample and/or the use of standard fluorophore-labeled secondary antibodies (referred to as conventional secondary antibodies) in expansion microscopy (ExM). Thus, conventional secondary antibodies and/or fluorescent proteins expressed within the sample can be used with conventional immunostaining for the optical imaging of a sample of interest with resolution better than the standard microscopy diffraction limit.

In one aspect, the disclosure provides a method for preparing an expanded sample for microscopy comprising: (a) incubating a fixed cell sample or a fixed tissue sample comprising a detectably labeled moiety with a linking agent, for a time and under conditions to promote cross-linking by the linking agent of a target in the sample to the detectably labeled moiety, to produce a cross-linked sample; (b) permeating the cross-linked sample with hydrophilic monomers to produce a permeated sample; (c) polymerizing the monomers within the permeated sample to provide a water-swellable composition; (d) incubating the water-swellable composition for a time and under conditions to promote the formation of linkages between the linking agent and the water-swellable composition, to produce an anchored sample; (e) treating the anchored sample with a homogenizing agent for a time and under conditions to promote homogenization of the anchored sample, to produce a processed sample; and (f) dialyzing the processed sample in water, thereby expanding the water-swellable composition in the processed sample to produce an expanded sample. In certain embodiments, the linking agent comprises a polymerizable group (e.g., a vinyl moiety) and a label-reactive group (e.g., an aldehyde, an N-hydroxysuccinimidyl ester, a maleimide, an epoxide, a thiosulfonate, an imidoester, a pentafluorophenyl ester, a haloacetyl, a thiosulfonate, a vinylsulfone, a pyridylsulfide, or a carbodiimide group). In some embodiments, the linking agent is methacrylic acid N-hydroxy succinimidyl ester, acrylic acid N-hydroxy succinimidyl ester, or glutaraldehyde.

In certain embodiments of the method, the fixed cell sample or the fixed tissue sample is first contacted with a detectably labeled binding moiety for a time and under conditions to promote binding between the detectably labeled binding moiety and a target in the sample, to produce a labeled sample, wherein incubating the labeled sample with the linking agent promotes cross-linking by the linking agent of the target in the labeled sample to the detectably labeled binding moiety, to produce the cross-linked sample. In some embodiments, the binding moiety is an antibody, a nanobody, a protein, a polypeptide, a nucleic acid, or a small molecule. In certain embodiments, the detectably labeled binding moiety is labeled with a fluorophore and the fluorophore is a bis-benzimide, a coumarin, a cyanine, a merocyanine, a pyrene, a fluorescein, a rhodamine, an oxazine, a carbopyronine, a semiconductor quantum dot, a polymer dot, or any combination thereof. In some embodiments, the water-swellable composition comprises one or more of a polyacrylic acid, a polyacrylamide, a polyvinyl alcohol, an alginate, a chitosan, or polymers thereof.

In some embodiments, the method is performed in less than 8 hours, less than 10 hours, less than 12 hours, less than 14 hours, less than 16 hours, less than 18 hours, less than 20 hours, less than 22 hours, or less than 24 hours.

In certain embodiments, the method further comprises contacting the sample with one or more of a second binding moiety, a third binding moiety, a fourth binding moiety, or a fifth binding moiety. In an embodiment, the method further comprises contacting the processed sample with a dye.

In another aspect the disclosure provides a kit comprising:
(a) a linking agent;
(b) hydrophilic monomers;
(c) reagents for polymerizing the hydrophilic monomers to the water-swellable composition; and
(d) a homogenizing agent.

In certain embodiments of the kit, the water-swellable composition comprises a polyacrylic acid, a polyacrylamide, a polyvinyl alcohol, an alginate, a chitosan, or polymers thereof. In an embodiment, the linking agent comprises a polymerizable group and a label-reactive group. In some embodiments, the linking agent is methacrylic acid N-hydroxy succinimidyl ester, acrylic acid N-hydroxy succinimidyl ester, or glutaraldehyde.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a schematic illustration of expansion microscopy and label retention strategies. The boxed region highlights the difference between the DNA method and the post-stain linker-group functionalization method (“MA/GA method”) presented in this disclosure. In the DNA method, the specimen is immunostained with a custom-prepared antibody bearing doubly-modified DNA linked to a fluorophore and an acrydite moiety (“A”). In contrast, with the MA/GA method, methacrylic acid N-hydroxy succinimidyl ester (MA-NETS) or glutaraldehyde (GA) are used to label the entire sample with polymer-linking groups after conventional immunostaining with fluorophore-labeled antibodies (only secondary antibodies are shown). For both methods, the next steps are gelation, digestion with a protease, and expansion through dialysis into deionized water. The acrydite (“A”), MA, and GA groups allow formation of a linkage to a hydrogel. Dyes are retained through a connection to antibody fragments that also contain a linkage to the gel. Fluorescent proteins are also retained using the MA/GA method through a similar method but are not shown here for the sake of clarity.

FIG. 2A-FIG. 2M show confocal fluorescence images of expanded cultured cells. FIG. 2A shows BS-C-1 cell immunostained for tyrosinated tubulin (green) and detyrosinated tubulin (magenta) using conventional secondary antibodies and partially overlaid with corresponding pre-expansion image (top). Specimen was treated with MA-NETS after immunostain. Zoom-in of boxed region labeled as “(c)” in FIG. 2A showing corresponding pre-expansion in FIG. 2B and post-expansion in FIG. 2C images of tyrosinated tubulin signal along with corresponding line profiles labeled as “(d)” in FIG. 2B and FIG. 2C and shown in a line profile graph in FIG. 2D. FIG. 2E shows a pre-expansion image and FIG. 2F shows a post-expansion image of a dividing PtK1 cell immunostained for tubulin (green) and the kinetochore protein HEC1 (red) using conventional secondary antibodies and also stained for DNA (blue) using TO-PRO-3. Specimen was treated with GA after immunostain. FIG. 2G and FIG. 2H show a zoom-in of microtubule-kinetochore attachments from boxed regions labeled “(g)” and “(h)” in FIG. 2E and FIG. 2F, respectively. FIG. 2I shows pre-expansion and FIG. 2J shows post-expansion end-on views of boxed regions labeled “(i)” and “(j)” in FIG. 2E and FIG. 2F, respectively (DNA channel omitted for clarity). FIG. 2K shows a maximum intensity projection of a fixed BS-C-1 cell expressing the endoplasmic reticulum (ER) tag Sec61B-GFP (green) and the inner mitochondrial membrane tag mito-DsRed (blue) and immunostained against the outer mitochondrial membrane protein TOM20 using a conventional secondary antibody (red). The specimen was treated with GA after immunostain and only briefly digested in order to retain GFP and DsRed fluorescence. FIG. 2L shows a zoom-in of boxed region labeled “(l)” in FIG. 2K showing close apposition of an ER tubule with two mitochondria. FIG. 2M shows a cross-sectional profile of boxed region labeled “(m)” in FIG. 2L. All distances and scale bars are in pre-expansion units. Scale bars: (FIGS. 2A, 2I, 2J, and 2K) 2 μm; (FIGS. 2B, 2C, 2G, 2H, and 2L) 500 nm; (FIGS. 2E and 2F) 5 μm.

FIG. 3A-FIG. 3J shows confocal (a-f) and epifluorescence (i, j) images of expanded mouse brain tissue using the MA-NETS treatment method. FIG. 3A shows a single pre-expansion focal plane of a THY1-YFP-H mouse brain slice indirectly immunostained for YFP (blue), the presynaptic marker Bassoon (green), and the postsynaptic marker Homer (red) using conventional secondary antibodies. FIG. 3B shows the same area in FIG. 3A after expansion, displayed with the relative size compared to FIG. 3A, in order to show the relative amount of physical expansion. FIG. 3C and FIG. 3D show a zoom-in of the boxed regions labeled “(c)” and “(d)” in FIG. 3B before expansion and FIG. 3E and FIG. 3F show a zoom-in of the boxed regions labeled “(e)” and “(f)” in FIG. 3B after expansion revealing that the presynaptic and postsynaptic markers are well-resolved and aligned with dendritic spines. FIG. 3G and FIG. 3H show cross-sectional profiles of the boxed regions labeled “(g)” and “(h)” in FIG. 3E and FIG. 3F, respectively. FIG. 3I shows an epifluorescence image of a neuron in an expanded THY1-YFP-H mouse brain slice using YFP itself as the fluorescence reporter; image was recorded using a 20×0.45 NA objective lens. The specimen was treated with MA-NHS and only briefly (1 hour) digested in order to retain FP fluorescence. FIG. 3J shows a zoom in of the boxed region labeled “(j)” in FIG. 3I showing clearly resolved dendritic spines. All distances and scale bars correspond to pre-expansion dimensions. Scale bars: (FIG. 3A and FIG. 3B) 5 μm; (FIG. 3C, FIG. 3D, FIG. 3F and FIG. 3G) 500 nm; (FIG. 3I) 4 μm; (FIG. 3F) 1 μm.

FIG. 4A-FIG. 4C show epifluorescence images of expanded BS-C-1 cells that were immunostained against tubulin using conventional fluorophore-labeled antibodies and then treated as indicated prior to gelation, digestion, and expansion. FIG. 4A shows an omission of post-stain treatment leads to heavy distortion due to lack of retention along the original structure. Post-stain treatment of immunostained cells with FIG. 4B MA-NETS (methacrylic acid N-hydroxyl succinimidyl ester) or FIG. 4C GA (glutaraldehyde) both conferred excellent retention of fluorescence and structure. Scale bars are 2.4 μm and are all in pre-expansion dimensions.

FIG. 5A-FIG. 5F show confocal fluorescence measurements of microtubule cross-sectional profile for 4.15× expanded specimens and estimate of spatial resolution. FIG. 5A shows a confocal fluorescence image of an expanded BS-C-1 cell conventionally immunostained for tyrosinated tubulin and treated with GA prior to gelation. Red dashes are positions at which cross-sectional profiles were measured. FIG. 5B shows a representative cross-sectional profiles of microtubules (red lines) and Gaussian fits (dashed black lines). FIG. 5C shows an analysis of microtubule profiles (red lines in FIG. 5A) yielded an average Gaussian-fitted full width at half maximum (FWHM) of 79±9 nm (mean±SD, 362 microtubule profiles). FIG. 5D-FIG. 5F show a cross-sectional profile analysis for an expanded, MA-NHS treated, conventionally immunostained BS-C-1 cell showing an average FWHM of 80±7 nm (mean±SD, 353 microtubule profiles). All distances and scale bars correspond to pre-expansion dimensions. Scale bars are 5 μm. Resolution estimate: The observed ˜80 nm FWHM profile of microtubules is consistent with the convolution of the double-peaked spatial profile of indirectly immunostained microtubules (measured by localization microscopy at ˜20 nm resolution, FIG. 8) with an effective ˜65 nm Gaussian point spread function (PSF) for expansion microscopy. The value of 65 nm is also approximately equal to the physical PSF of our microscope (˜265 nm FWHM, when configured with the 63×1.2 NA water-immersion lens used here) divided by the measured expansion factor of 4.15.

FIG. 6A-FIG. 6H show a comparison of pre-expansion and post-expansion images recorded by confocal fluorescence microscopy for a region of a BS-C-1 cell immunostained for tyrosinated tubulin with a conventional Atto 488 secondary antibody and treated with MA-NETS before gelation (data from FIG. 2). FIG. 6A shows an overlay of pre-expansion image (magenta) and post-expansion image (green) after alignment of the post-expansion image using similarity registration (i.e., translation, rotation, and magnification—see methods for further details). FIG. 6B shows an overlay of post-expansion image before (magenta) and after (green) a non-rigid transformation procedure that uses B-spline registration to “warp” the post-expansion image to optimally fit the pre-expansion image. Arrows indicate the direction and relative magnitude (scaled 8×) of the transformation required to optimally align the post-expansion to the pre-expansion image. FIG. 6C-FIG. 6F show zoom-in images of boxed regions labeled “(c)” “(d)” “(e)” and “(f)” respectively in FIG. 6B showing that distortions are generally very small. FIG. 6G shows a schematic of procedure used to measure distances m and m′ between features a and b in the post-B-spline-registration (green) and corresponding features a′ and b′ in pre-B-spline-registration (magenta). FIG. 6H shows a quantification of root mean square (RMS) error of m-m′ as a function of distance m for matching image features (black line) with plus or minus standard deviation. The plot in FIG. 6H was calculated from a 20 μm×20 μm data set; the image in FIG. 6A shows a 12 μm×12 μm zoom-in of the data set. All distances and scale bars correspond to pre-expansion dimensions. Scale bars: (FIG. 6A and FIG. 6B) 2 μm; (FIG. 6C-FIG. 6F) 200 nm.

FIG. 7A-FIG. 7E show a comparison of pre-expansion and post-expansion images recorded by confocal fluorescence microscopy for a region of a BS-C-1 cell immunostained for tubulin with DNA-labeled secondary antibodies and hybridized with a modified complementary strand (5′ acrydite and 3′ Atto 488) prior to gelation. FIG. 7A shows an overlay of pre-expansion image (magenta) and post-expansion image (green) after alignment of the post-expansion image using similarity registration. FIG. 7B shows an overlay of post-expansion image before (magenta) and after (green) using a non-rigid B-spline registration. Arrows indicate the direction and relative magnitude (scaled 8×) of the transformation required to optimally align the images. FIG. 7C and FIG. 7D show zoom-in images of boxed regions labeled “(c)” and “(d)” in FIG. 7B showing that distortions are generally very small. FIG. 7E shows a RMS error versus length distortion analysis for data in FIG. 7A (see FIG. 6). The plot in FIG. 7E was calculated from a 20 μm×20 μm data set; the image in FIG. 7A shows a 12 μm×12 μm zoom-in of the data set. All distances and scale bars correspond to pre-expansion dimensions. Scale bars: (FIG. 7A and FIG. 7B) 2 μm; (FIG. 7C and FIG. 7D) 200 nm.

FIG. 8A-FIG. 8H show a comparison of pre-expansion image measured by localization microscopy and post-expansion image measured by epifluorescence microscopy for a BS-C-1 cell immunostained with conventional antibodies and treated with GA prior to gelation. FIG. 8A shows an overlay of pre-expansion image (green) and post-expansion image (magenta) after alignment of the post-expansion image using similarity registration. FIG. 8B shows a zoom-in of boxed region labeled “(b)” in FIG. 8A showing close agreement between localization microscopy image and expansion microscopy image. FIG. 8C and FIG. 8D show line profiles of the boxed regions labeled “(c)” and “(d)” in FIG. 8B. FIG. 8E shows an overlay of post-expansion image before (magenta) and after (green) B-spline registration as described in FIG. 6. FIG. 8F and FIG. 8G show zoom-in images from boxed regions labeled “(f)” and “(g)” in FIG. 8E showing that distortions are generally very small. FIG. 8H shows a RMS error versus length distortion analysis for data in FIG. 8A (see FIG. 6). The plot in FIG. 8H was calculated from a 20 μm×20 μm data set; the image in FIG. 8A shows an 8 μm×8 μm zoom-in of the data set. All distances and scale bars correspond to pre-expansion dimensions. Scale bars: (FIG. 8A and FIG. 8E) 2 μm; (FIG. 8B) 500 nm; (FIG. 8F and FIG. 8G) 250 nm.

FIG. 9A-FIG. 9G show comparison of attachments of kinetochore fibers (K-fibers) and chromosomes for mitotic cell from FIG. 2. FIG. 9A shows a maximum intensity projection of a post-expansion image of a dividing PtK1 cell that was immunostained against tyrosinated tubulin (green) and HEC1 (red) using conventional Atto 488 and dually labeled Alexa Fluor 546 and biotin secondary antibodies, respectively, and stained for DNA using TO-PRO-3 (blue). FIG. 9B and FIG. 9C show a comparison of pre-expansion images from regions labeled “(b)” “(c)” “(d)” “(e)” “(f)” “(g)” “(h)” and “(i)” in FIG. 9A of kinetochore attachments with corresponding post-expansion images, both imaged by confocal microscopy in z-sections from 400-800 nm thickness. FIG. 9D-FIG. 9G show that a subset of attachments showed double-peaked signals that were not resolvable in the pre-expansion images. Cross-sectional profiles of HEC1 signal from regions labeled “(b)” “(c)” “(g)” and “(h)”, respectively, for pre-expansion images (solid black), post-expansion images (red), and a double-Gaussian fit to the post-expansion signals (dashed black lines). Double peaks are separated by 149 nm, 201 nm, 214 nm, and 204 nm, respectively. All distances and scale bars correspond to pre-expansion dimensions. Scale bars: (FIG. 9A) 5 μm; (FIG. 9B and FIG. 9C) 500 nm.

FIG. 10A-FIG. 10F show an image processing on post-expansion mitotic spindle data. Unprocessed confocal maximum intensity projection FIG. 10A shows a mitotic cell from FIG. 2 and binarized kinetochore mask FIG. 10B resulting from image filtering (see methods for additional details). Cross-sectional maximum intensity projection of boxed area in FIG. 10A showing non-specific adsorption of the HEC1 antibody (red) to the cell periphery FIG. 10C and processed cross-section FIG. 10D. FIG. 10E shows the unprocessed images from sections labeled “(e)” “(f)” and “(g)” in FIG. 10C versus processed images from sections labeled “(h)” “(i)” and “(j)” in FIG. 10D single z-section (˜225 nm thickness) showing that kinetochore attachments are retained after processing. All distances and scale bars correspond to pre-expansion dimensions. Scale bars: (FIG. 10A and FIG. 10B) 5 μm; (FIG. 10C-FIG. 10J) 2 μm.

FIG. 11A-FIG. 11C show a comparison of pre-expansion and post-expansion images recorded by confocal fluorescence microscopy for immunostained mitotic PtK1 cell (data from FIG. 2, only tubulin channel). FIG. 11A shows a XY maximum intensity projection overlay of pre-expansion (magenta) and post-expansion (green) images after alignment using three-dimensional similarity registration. FIG. 11B shows a XZ maximum intensity projection along yellow line labeled “(b)” in FIG. 11A. FIG. 11C shows a RMS error vs length distortion analysis in three dimensions (see FIG. 6). Scale bars 2 μm. All distances and scale bars correspond to pre-expansion dimensions.

FIG. 12A-FIG. 12F show a gallery of expanded cellular structures. Epifluorescence images of expanded BS-C-1 cells indirectly immunostained with Atto 488 against FIG. 12A tyrosinated tubulin, FIG. 12B vimentin, FIG. 12C TOM20 (outer mitochondrial membrane), FIG. 12D PMP70 (peroxisomal membrane protein), FIG. 12E mito-GFP (inner mitochondrial membrane marker) and FIG. 12F Sec61β-GFP (endoplasmic reticulum marker) and treated with GA. Scale bars are 4.8 μm and are all in pre-expansion dimensions.

FIG. 13A-FIG. 13C show epifluorescence images of expanded BS-C-1 cells stained for tyrosinated tubulin using different procedures. In FIG. 13A, fixed cells were immunostained using conventional fluorescently-labeled antibodies and then treated with GA. In FIG. 13B, fixed cells were immunostained using conventional fluorescently-labeled antibodies and then treated MA-NHS prior to gelation. In FIG. 13C, fixed cells were immunostained using DNA-labeled antibodies which were prepared according as published (see Chen et al., “Expansion microscopy.” Science 347:543-48 (2015)). Image contrasts have been matched to show the relative brightness of the stain achieved in each case; the specimens treated with MA-NETS or GA were both approximately 3-4 times brighter than that of the specimen stained using the DNA-labeled antibody. The number of fluorophores per antibody with the DNA-labeled antibodies was not reported in the original Chen et al. publication. The DNA-labeled antibodies would be unlikely to achieve brighter stains than conventional (directly) fluorescently-labeled antibodies due to the more than ten-fold difference in molecular weight between an individual fluorophore and a 20-mer single-stranded oligonucleotide and due to the large number of negative charges introduced by the oligonucleotides. Scale bars are 2.4 μm and are all in pre-expansion dimensions.

FIG. 14A-FIG. 14C show a determination of fluorescence retention for each method performed in this work using epifluorescence imaging. In each case, the total fluorescence of individual mitochondria was measured before and after expansion using a 20×0.45 NA air objective. Fluorescence retention of GFP was measured using the inner mitochondrial membrane tag mito-GFP while all other methods used an outer mitochondria immunostain for TOM20 using Atto 488. FIG. 14A shows a pre-expansion image of a representative area used in the determination of GFP fluorescence retention. FIG. 14B shows a corresponding area in FIG. 14A after expansion. Scale bars are 10 μm in pre-expansion dimensions. FIG. 14C shows a bar graph of fluorescence retention for each method used in this work. Error bars represent the standard deviation in measured fluorescence retention (n=20).

FIG. 15A and FIG. 15B show epifluorescence images of expanded BS-C-1 cells prepared using the GA treatment method. Cells were indirectly immunostained for tyrosinated tubulin using either a homemade Atto 488 donkey anti-rat secondary antibody as shown in FIG. 15A or a commercially available Alexa Fluor 488 donkey anti-rat secondary antibody as shown in FIG. 15B. Image contrasts were adjusted to be proportional to exposure time in order to show that the two stains are comparable in brightness. Scale bars are 2.4 μm and are all in pre-expansion dimensions.

FIG. 16A-FIG. 16C show epifluorescence images of expanded BS-C-1 cells stained for tyrosinated tubulin, treated with GA, and digested for 0 minutes (FIG. 16A), 30 minutes (FIG. 16B), or 18 hours (FIG. 16C). Digestion times shorter than 30 minutes show prominent distortions while these are largely absent for digestion times of 30 minutes or longer. Scale bars are 2.4 μm and are all in pre-expansion dimensions.

FIG. 17A-FIG. 17C show epifluorescence images of expanded BS-C-1 cells stained for tyrosinated tubulin, treated with MA-NETS, and digested for 0 minutes (FIG. 17A), 2 hours (FIG. 17B), or 18 hours (FIG. 17C). Digestion times of many hours were required to avoid prominent distortions. Scale bars are 2.4 μm and are all in pre-expansion dimensions.

FIG. 18A-FIG. 18C show epifluorescence images of expanded BS-C-1 cells expressing Sec61β-GFP and treated with GA during fixation; intrinsic GFP signal is only retained for short digestion times in cultured cells. In FIG. 18A, the sample was digested for 30 minutes. In FIG. 18B, the sample was digested for 18 hours. The images in FIG. 18A and FIG. 18B were acquired under identical illumination conditions, exposure durations, and are displayed with the same contrast. Panel FIG. 18c is the same image as in FIG. 18B but with 7× contrast to show weak residual fluorescence. Scale bars are 2.4 μm and are all in pre-expansion dimensions.

FIG. 19A-FIG. 19C show epifluorescence images of expanded BS-C-1 cells expressing mito-GFP and digested for 30 minutes; intrinsic GFP signal is only retained for GA-treated cells. FIG. 19A shows treatment with a mixture of PFA/GA (paraformaldehyde and glutaraldehyde) during fixation retains intrinsic fluorescence from mito-GFP, whereas FIG. 19B shows treatment with only PFA does not. Both specimens were subjected to a digestion time of 30 minutes. FIG. 19A and FIG. 19B are displayed at the same contrast although FIG. 19B was recorded with ten times the exposure duration. FIG. 19C shows adjustment of the contrast of the image in FIG. 19B allows observation of dim residual signal. Scale bars are 2.4 μm and are all in pre-expansion dimensions.

FIG. 20A-FIG. 20C show epifluorescence images of expanded 100 μm thick THY1-YFP-H mouse brain slices immunostained for YFP and subjected to various post-stain treatments. FIG. 20A shows no treatment leads to low signal intensity and patchy preservation of signal along structure. FIG. 20B shows treatment with MA-NHS after immunostaining led to higher signal levels with good retention along the original structures. FIG. 20C shows treatment with GA after immunostaining resulted in high background signal. The three images were acquired using identical illumination and exposure; the images in FIG. 20B and FIG. 20C are displayed at the same contrast, while FIG. 20A is displayed with 3× contrast to show details within the comparably dim image. Due to the comparably long (˜12 hour) digestion used here, there should be a negligibly small amount of intrinsic YFP signal remaining, in comparison to the data in FIG. 23 which show weak residual YFP signal after a 60 minute digestion. Scale bars are 12 μm and are all in pre-expansion dimensions.

FIG. 21A-FIG. 21K show a gallery of expanded synapses in mouse brain tissue. FIG. 20A, FIG. 20C, FIG. 20E, FIG. 20G, and FIG. 20I show maximum intensity projections of expanded THY1-YFP-H mouse brain tissue indirectly immunostained for YFP (blue, Atto 488), Bassoon (green, Atto 565), and Homer (red, Atto 647N). FIG. 20B, FIG. 20D, FIG. 20F, FIG. 20H, FIG. 20J and FIG. 20K show the corresponding cross-sectional profiles of the indicated individual synapses labeled as “(b)” “(d)” “(f)” “(h)” “(j)” and “(k)” respectively. In each case, the pre- and postsynaptic densities are clearly resolvable and align well with dendritic spines. In FIG. 20I, two separate synapses are shown connecting to a single dendritic spine (cross-sectional profiles indicated with arrows). All distances and scale bars correspond to pre-expansion dimensions. Scale bars are 500 nm.

FIG. 22A-FIG. 22G show a comparison of pre-expansion and post-expansion images recorded by confocal fluorescence microscopy for a 100 μm thick THY1-YFP-H mouse brain slices immunostained for YFP. FIG. 22A and FIG. 22B show a large area overlay of pre-expansion image (magenta) and post-expansion image (green) after alignment of the post-expansion image using similarity registration. FIG. 22C and FIG. 22D show overlay pre-expansion image (magenta) and post-expansion image (green) using similarity transformation in a local region. FIG. 22E and FIG. 22F show overlay of post-expansion images from before (magenta) and after (green) B-spline registration as described in FIG. 6. FIG. 22G shows RMS error versus length distortion analysis for data in FIG. 22A and FIG. 22B (see FIG. 6). All distances and scale bars correspond to pre-expansion dimensions. Scale bars: (FIG. 22A and FIG. 22B) 10 μm; (FIG. 22C, FIG. 22D, FIG. 22E and FIG. 22F) 5 μm.

FIG. 23A-FIG. 23C show epifluorescence images of 100 μm thick THY1-YFP-H mouse brain slices treated with either MA-NETS or nothing prior to gelation, a brief (60 min) digestion, and expansion. While both specimens expanded well, the MA-NETS treated brain slice in FIG. 23A showed much higher intrinsic YFP signal than the non-treated brain slice shown in FIG. 23B. The images in FIG. 23A and FIG. 23B were acquired with identical illumination and exposure and are displayed with the same contrast settings. The image in FIG. 23C is a duplicate of that in FIG. 23B but is displayed with 3× contrast. Note that use of a long digestion time (>12 hours) led to essentially zero detectable signal (data not shown). Scale bars are 30 μm (pre-expansion dimensions).

FIG. 24A-FIG. 24G show confocal fluorescence maximum intensity projections of expanded BS-C-1 cells stained for DNA or immunostained against tyrosinated tubulin using various secondary antibodies and treated with GA prior to gelation. FIG. 24B, FIG. 24C, FIG. 24E and FIG. 24F show conventional secondary antibodies were used that were directly labeled with the indicated fluorophore. FIG. 24A and FIG. 24D show samples stained for nuclear DNA using the corresponding dye without subsequent GA treatment. In FIG. 24G, a biotinylated secondary antibody was used prior to treatment with GA; after expansion the sample was incubated with Alexa Fluor 647 labeled streptavidin. Post-expansion labeling offers a way to introduce fluorophores to the sample that would otherwise not survive the polymerization step such as Alexa Fluor 647 and other cyanines. Scale bars are 3.75 μm and are all in pre-expansion dimensions.

FIG. 25A-FIG. 25D show the “fixed” pre-expansion FIG. 25A and “moving” post-expansion FIG. 25B images to be registered by Elastix. The initial unregistered overlay FIG. 25C and overlay after Elastix similarity registration FIG. 25D. The pre-expansion images are displayed in magenta and the post-expansion images in green. The dotted yellow lines in FIG. 25D outline the edges of the post-expansion image and have been added to emphasize the transformation.

### DETAILED DESCRIPTION

The present disclosure relates to methods and kits for expanding or enlarging fixed samples of interest for microscopy by synthesizing a water-swellable compound within a fixed sample, which can be physically expanded, resulting in physical magnification of the sample. Furthermore, the methods and kits disclosed allow the use of fluorescent proteins expressed within the sample and/or the use of standard fluorophore-labeled secondary antibodies in expansion microscopy (ExM). These antibodies are referred to as conventional secondary antibodies, and both fluorescent proteins expressed within the sample and/or conventional secondary antibodies can be used with conventional immunostaining for the optical imaging of a sample of interest with resolution better than the standard microscopy diffraction limit.

In one aspect the disclosure provides a method for preparing an expanded sample for microscopy comprising: (a) incubating a fixed cell sample or a fixed tissue sample comprising a detectably labeled moiety with a linking agent, for a time and under conditions to promote cross-linking by the linking agent of a target in the sample to the detectably labeled moiety, to produce a cross-linked sample; (b) permeating the cross-linked sample with hydrophilic monomers to produce a permeated sample; (c) polymerizing the monomers within the permeated sample to provide a water-swellable composition; (d) incubating the water-swellable composition for a time and under conditions to promote the formation of linkages between the linking agent and the water-swellable composition, to produce an anchored sample; (e) treating the anchored sample with a homogenizing agent for a time and under conditions to promote homogenization of the anchored sample, to produce a processed sample; and (f) dialyzing the processed sample in water, thereby expanding the water-swellable composition in the processed sample to produce an expanded sample.

In a certain embodiment of the method, the fixed cell sample or the fixed tissue sample is first contacted with a detectably labeled binding moiety for a time and under conditions to promote binding between the detectably labeled binding moiety and a target in the sample, to produce a labeled sample, wherein incubating the labeled sample with the linking agent promotes cross-linking by the linking agent of the target in the labeled sample to the detectably labeled binding moiety, to produce the cross-linked sample.

As used herein, the term “fixed cell sample” or “fixed tissue sample” generally refers to a sample that has been exposed to a fixation agent such that the cellular components become crosslinked to one another or have become denatured. A sample can include, but is not limited to, a biological sample, such as a cell or a population of cells (for example, an isolated cell or plurality of cells excised from a tissue or grown in vitro by tissue culture techniques, a population of cells may also be a plurality of cells isolated from an animal or human), cells or tissue from a biopsy, a tumor, tissue (for example, brain, heart, lung, liver, kidney, spleen, bladder, stomach, colon, bones, muscle, skin, glands, lymph nodes, genitals, breasts, pancreas, prostate, thyroid, spinal cord, and eyes), a cell isolate, or a distribution of molecules suitable for microscopic analysis. By “fixed” or “fixing” the sample (i.e., cells or tissue), was exposed a fixation agent such that the cellular components become crosslinked to one another. Any convenient fixation agent, or “fixative,” may be used to fix the sample. Fixatives for preparing the fixed cell sample or fixed tissue sample can include, for example, formaldehyde, paraformaldehyde, glutaraldehyde, acrolein, acetone, ethanol, and methanol. Typically, a fixative will be diluted in a buffer, (e.g., saline, phosphate buffer, phosphate buffered saline (PBS), citric acid buffer, potassium phosphate buffer, etc.), usually at a concentration of about 1-10% (e.g. 1%, 2%, 3%, 4%, 5%, 6%, 7%, 8%, or 10%). Exemplary fixative solutions can include, for example, 4% paraformaldehyde/0.1M phosphate buffer; 2% paraformaldehyde/0.2% picric acid/0.1M phosphate buffer; 4% paraformaldehyde/0.2% periodate/1.2% lysine in 0.1M phosphate buffer; 4% paraformaldehyde/0.05% glutaraldehyde in phosphate buffer. The type of fixative used and the duration of exposure to the fixative will depend on the sensitivity of the molecules of interest in the specimen to crosslinking or denaturation by the fixative, and will be known by the ordinarily skilled artisan or may be readily determined using conventional histochemical or immunohistochemical techniques.

As used herein, a “detectably labeled moiety” refers to labels useful in localizing to a target (e.g., proteins, lipids, steroids, nucleic acids, extracellular matrix, and sub-cellular structures) in a cell or tissue sample and providing a detectable signal. In an embodiment, the target can be diagnostic. In another embodiment, the target can be prognostic. In certain embodiments, the target can be predictive of responsiveness to a therapy. In some embodiments, the target can be candidate agents in a screen (e.g., a screen for agents that will aid in the diagnosis and/or prognosis of disease, in the treatment of a disease). In certain embodiments, the detectably labeled moiety or label provides an optically detectable signal.

As used herein, a “detectably labeled binding moiety” refers to a binding moiety comprising a detectable label useful in localizing to a target (e.g., proteins, lipids, steroids, nucleic acids, extracellular matrix, and sub-cellular structures) in a cell or tissue sample and providing a detectable signal. In an embodiment, the detectably labeled binding moiety specifically binds to a target in the cell or tissue sample. In an embodiment, the target can be diagnostic. In another embodiment, the target can be prognostic. In certain embodiments, the target can be predictive of responsiveness to a therapy. In some embodiments, the target can be candidate agents in a screen (e.g., a screen for agents that will aid in the diagnosis and/or prognosis of disease, in the treatment of a disease). In some embodiments, the method further comprises contacting the sample with one or more of a second binding moiety, a third binding moiety, a fourth binding moiety, or a fifth binding moiety. In certain embodiments, the tissue sample is labeled with a plurality of detectably labeled moieties and/or detectably labeled binding moieties, or labels. In certain embodiments, the tissue sample is labeled with 1, 2, 3, 4, 5, or more detectably labeled moieties and/or detectably labeled binding moieties. In certain embodiments, the detectably labeled binding moieties specifically bind to different target moieties. In certain embodiments, the detectably labeled moieties and/or detectably labeled binding moieties comprise different fluorophores that provide different detectable signals. In certain further embodiments, the different detectable signals are differentiable from one another.

In certain embodiments, the tissue sample is labelled after the tissue sample has been homogenized or proteolyzed.

The term “binding moiety” refers to any molecule that specifically binds to the target of interest in the sample. The binding moiety may be any molecule known in the art and will depend on the target. Interaction of the binding moiety with the target is achieved through some degree of specificity and/or affinity for the target. Both specificity and affinity are generally desirable. Binding moieties can include, but are not limited to, oligonucleotides (including nucleic acid probes), proteins, ligands, lectins, antibodies, aptamers, bactertiophages, host defense peptides (e.g., defensins), bacteriocins (e.g., pyocins), and receptors. In certain embodiments, the binding moiety can be an antibody, a nanobody, a protein, a polypeptide, a nucleic acid, or a small molecule.

Detectably labeled moieties and detectably labeled binding moieties can include, for example, a fluorescently labelled antibody, nanobody, protein, peptide, nucleic acid, or small molecule. For example, a detectably labeled binding moiety, can be a fluorophore covalently linked any binding moiety (as in, for example, an antibody covalently linked to fluorescein). In another embodiment, the detectably labeled moiety is a fluorophore and the fluorophore is a bis-benzimide, a boron dipyrromethene, a carbopyronine, a coumarin, a cyanine, a fluorescein, a merocyanine, an oxazine, a pyrene, a rhodamine, a polymer dot, a semiconductor quantum dot, or any combination thereof. In certain embodiments, the fluorophores include, but are not limited to, bis-benzimides (e.g., Hoechst 33342), coumarins, pyrene (e.g., Alexa Fluor 405), fluorescein, rhodamine (e.g., Alexa Fluor 488, Atto 488, TAMRA, Atto 565, Alexa Fluor 568, Texas Red, silicon rhodamine (SiR)), oxazine, carbopyronine (e.g., Atto 647N), semiconductor quantum dot, or polymer dot fluorophores.

In certain embodiments, the detectably labeled moiety or detectably labeled binding moiety comprises a protein or peptide. Such proteins or peptides can be expressed in the cell or tissue sample. In certain embodiments, the protein is a fluorescent protein. In some embodiments, such fluorescent proteins can include, but are not limited to, a green fluorescent protein (GFP), a yellow fluorescent protein (YFP), an orange fluorescent protein (OFP), a cyan fluorescent protein (CFP), a blue fluorescent protein (BFP), a red fluorescent protein (RFP), a far-red fluorescent protein, or a near-infrared fluorescent protein, DsRed, mCherry, and UnaG. In a non-limiting example, a cell sample can express a target protein that is expressed in-frame with a fluorescent protein or peptide (e.g., a GFP protein). A cell or tissue sample comprising such a GFP-tagged target protein can be modified by the methods and kits disclosed herein for expansion microscopy without the use of a binding moiety (i.e., DNA or antibody).

In another embodiment, the method further comprises contacting the processed sample with a dye. For example, it may be desirable to contact the cells and intracellular structures of the tissue sample with one or more macromolecules. For example, macromolecules may be provided that promote the visualization of particular cellular target biomolecules (e.g., proteins, lipids, steroids, nucleic acids, extracellular matrix, and sub-cellular structures). In a non-limiting example, the cell or tissue sample may be contacted with nucleic acid stains like TO-PRO3, DAPI, or Hoechst, thus labeling the nuclei of cells.

As used herein, a “linking agent” refers to a compound that crosslinks cellular components to one another, to the water-swellable composition, and can crosslink cellular components to the detectably labeled moiety and/or to the detectably labeled binding moiety. In certain embodiments, the linking agent covalently binds the detectably labeled moiety and/or to the detectably labeled binding moiety and covalently or non-covalently associates with the water-swellable composition. By covalently binding the detectably labeled moiety and/or to the detectably labeled binding moiety and covalently or non-covalently associating with the water-swellable composition, as well as the cellular components, the linking agents create an interlinked network that expands evenly in three dimensions when the cell sample or tissue sample is homogenized (e.g. by proteolysis) and the water-swellable composition is expanded by dialyzing in water.

Linking agents can be either homo- or hetero-bifunctional reagents with identical or non-identical reactive groups, respectively, permitting the establishment of inter- as well as intra-molecular crosslinkages. Chemical crosslinking involves the formation of covalent bonds between two proteins by using bifunctional reagents containing reactive end groups that react with functional groups (such as primary amines and sulfhydryls) of amino acid residues. Bifunctional reagents, specifically reacting with primary amine groups (i.e., ε-amino groups of lysine residues) can form stable inter- and intra-subunit covalent bonds. Bifunctional imidoesters can have varying lengths of the spacer arm between their reactive end groups (e.g., dimethyl adipimidate (DMA), dimethyl suberimidate (DMS) and dimethyl pimelimidate (DMP); with spacer arms of 8.6 Å, 11 Å and 9.2 Å, respectively). Some bifunctional reagents can form stable thioester bonds between two interacting proteins. For instance, a linking agent with one amine-reactive end and a sulfhydryl-reactive moiety can be used in situations where the catalytic site of one of the protein contains an amine (e.g., bifunctional reagents with a NHS ester at one end and an SH-reactive groups (i.e., maleimides or pyridyl disulfides) can be used.

In certain embodiments, the linking agent can be:

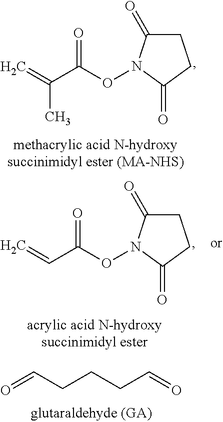

Glutaraldehyde exists in aqueous solution as a complex equilibrium distribution of monomeric and polymeric forms which contain aldehyde and alkene groups. Both aldehydes and alkene groups on glutaraldehyde could in principle become covalently linked to the acrylamide polymer. Additionally, it is possible that the glutaraldehyde polymer could become linked to the water-swellable composition by topological (mechanical) entanglement with the acrylamide polymer, or a combination of covalent and topological mechanisms.

In certain embodiments, the linking agent comprises a polymerizable group and a label-reactive group (a label-reactive group can be designed to interact with the detectably labeled moiety and/or with the detectably labeled binding moiety). In an embodiment, the polymerizable group comprises a vinyl moiety. In some embodiments, the polymerizable group of the linking agent comprises a moiety according to one of the formulas:

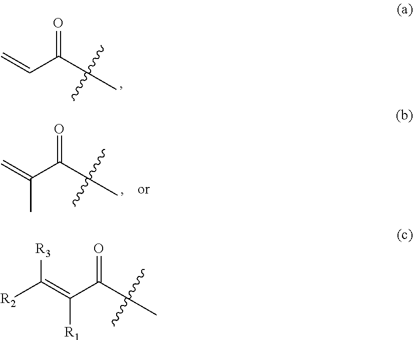

wherein R₁, R₂, and R₃ are each independently selected from H, alkyl, haloalkyl, halo,

aryl, and heteroaryl. As used herein, the term “alkyl” means a saturated straight chain or branched non-cyclic hydrocarbon having from 1 to 10 carbon atoms. Representative saturated straight chain alkyls include methyl, ethyl, n-propyl, n-butyl, n-pentyl, n-hexyl, n-heptyl, n-octyl, n-nonyl and n-decyl; while saturated branched alkyls include isopropyl, sec-butyl, isobutyl, tert-butyl, isopentyl, 2-methylbutyl, 3-methylbutyl, 2-methylpentyl, 3-methylpentyl, 4-methylpentyl, 2-methylhexyl, 3-methylhexyl, 4-methylhexyl, 5-methylhexyl, 2,3-dimethylbutyl, 2,3-dimethylpentyl, 2,4-dimethylpentyl, 2,3-dimethylhexyl, 2,4-dimethylhexyl, 2,5-dimethylhexyl, 2,2-dimethylpentyl, 2,2-dimethylhexyl, 3,3-dimtheylpentyl, 3,3-dimethylhexyl, 4,4-dimethylhexyl, 2-ethylpentyl, 3-ethylpentyl, 2-ethylhexyl, 3-ethylhexyl, 4-ethylhexyl, 2-methyl-2-ethylpentyl, 2-methyl-3-ethylpentyl, 2-methyl-4-ethylpentyl, 2-methyl-2-ethylhexyl, 2-methyl-3-ethylhexyl, 2-methyl-4-ethylhexyl, 2,2-diethylpentyl, 3,3-diethylhexyl, 2,2-diethylhexyl, 3,3-diethylhexyl and the like. As used herein, the term “haloalkyl” means and alkyl group in which one or more (including all) the hydrogen radicals are replaced by a halo group, wherein each halo group is independently selected from —F, —Cl, —Br, and —I. Representative haloalkyl groups include trifluoromethyl, bromomethyl, 1,2-dichloroethyl, 4-iodobutyl, 2-fluoropentyl, and the like. As used herein, the term “haloaryl” refers to aryl groups with one or more halo or halogen substituents. For example, haloaryl groups include phenyl groups in which from 1 to 5 hydrogens are replaced with a halogen. Haloaryl groups include, for example, fluorophenyl, difluorophenyl, trifluorophenyl, chlorophenyl, clorofluorophenyl, and the like. As used herein, the term, “heteroaryl” or like terms means a monocyclic or polycyclic heteroaromatic ring comprising carbon atom ring members and one or more heteroatom ring members. Each heteroatom is independently selected from nitrogen, which can be oxidized (e.g., N(O)) or quaternized; oxygen; and sulfur, including sulfoxide and sulfone. Representative heteroaryl groups include pyridyl, 1-oxo-pyridyl, furanyl, benzo[1,3]dioxolyl, benzo[1,4]dioxinyl, thienyl, pyrrolyl, oxazolyl, imidazolyl, thiazolyl, a isoxazolyl, quinolinyl, pyrazolyl, isothiazolyl, pyridazinyl, pyrimidinyl, pyrazinyl, a triazinyl, triazolyl, thiadiazolyl, isoquinolinyl, indazolyl, benzoxazolyl, benzofuryl, indolizinyl, imidazopyridyl, tetrazolyl, benzimidazolyl, benzothiazolyl, benzothiadiazolyl, benzoxadiazolyl, indolyl, tetrahydroindolyl, azaindolyl, imidazopyridyl, quinazolinyl, purinyl, pyrrolo[2,3]pyrimidinyl, pyrazolo[3,4]pyrimidinyl, imidazo[1,2-a]pyridyl, and benzothienyl.

In certain embodiments, the linker comprises a label-reactive group, configured to covalently associate to the detectably labeled moiety and/or to the detectably labeled binding moiety. In an embodiment, the label-reactive group covalently binds to the detectably labeled moiety and/or to the detectably labeled binding moiety. In other embodiments, the label-reactive group non-covalently associates with the detectably labeled moiety and/or with the detectably labeled binding moiety. In certain embodiments, the label-reactive group of the linking agent is selected from the group consisting of an aldehyde, an N-hydroxysuccinimidyl ester, a maleimide, an epoxide, a thiosulfonate, an imidoester, a pentafluorophenyl ester, a haloacetyl, a thiosulfonate, a vinylsulfone, a pyridylsulfide, and a carbodiimide group.

As used herein, the term “hydrophilic monomer” refers to reagents useful in polymerizing water-swellable compounds in a tissue sample. In certain embodiments, hydrophilic monomers and reagents are configured to not only polymerize into a water-swellable compound, but also polymerize the water-swellable compound within the tissue sample. As used herein, the term “water-swellable composition” generally refers to a material that expands in three dimensions when contacted with a liquid, such as water. In an embodiment, the water-swellable composition expands evenly in three dimensions. Additionally, the water-swellable composition can be transparent such that, upon expansion, light can pass through the sample. In certain embodiments, the water-swellable composition is formed in situ from precursors thereof (e.g., acrylamide, acrylate, and bis-acrylamide) by chemically crosslinking water soluble monomers or polymers (thus, the method disclosed herein envisions adding precursors of the water-swellable composition to the sample and rendering the precursors swellable in situ).

In some embodiments, one or more hydrophilic monomers can comprise polymerizable materials, monomers or polymers. Any water-soluble, ethylenically unsaturated monomer may be used without limitations in the methods of disclosed herein. In certain embodiments, the water-soluble, ethylenically unsaturated monomer may be an anionic monomer or a salt thereof, a non-ionic hydrophilic monomer, an amino group-containing unsaturated monomer and a quaternary salt thereof, or a combination thereof. Non-limiting examples of water-soluble, ethylenically unsaturated monomers include, but are not limited to, anionic monomers or salts thereof, such as acrylic acid, methacrylic acid, anhydrous maleic acid, fumaric acid, crotonic acid, itaconic acid, 2-acryloylethanesulfonic acid, 2-methacryloylethanesulfonic acid, 2-(meth)acryloylpropanesulfonic acid, and 2-(meth)acrylamide-2-methylpropane sulfonic acid; non-ionic hydrophilic monomers, such as (meth)acrylamide, N-substituted (meth)acrylate, 2-hydroxyethyl (meth)acrylate, 2-hydroxypropyl (meth)acrylate, methoxypolyethyleneglycol (meth)acrylate, and polyethylene glycol (meth)acrylate; and an amino group containing unsaturated monomers or quaternary salts thereof, such as (N,N)-dimethylaminoethyl (meth)acrylate, and (N,N)-dimethylaminopropyl (meth)acrylamide, with preference for an acrylic acid or a salt thereof. Additionally and/or alternatively, polymerizable materials can include, but are not limited to, water soluble groups containing a polymerizable ethylenically unsaturated group, substituted or unsubstituted methacrylates, acrylates, acrylamides, bisacrylamides, methacrylamides, vinylalcohols, vinyl amines, allylamines, allylalcohols, including divinylic crosslinkers thereof (e.g., N,N-alkylene bisacrylamides). In some embodiments, the water-swellable composition comprises one or more of a polyacrylic acid, a polyacrylamide, a polyvinyl alcohol, an alginate, or a chitosan.

In certain embodiments, the fixed cell sample or fixed tissue is permeated with one or more monomers or a solution comprising one or more monomers or precursors which are then reacted to form a water-swellable composition. For example, the sample can be permeated with acrylamide or a solution comprising the acrylamide (for example, a solution comprising acrylamide, bis-acrylamide, and acrylate). Once the sample, or labeled sample, is permeated, the solution can be initiated to form a polyacrylamide. For example, tetramethylethylenediamine (TEMED) and ammonium persulfate (APS) can be used to initiate and/or catalyze the polymerization of acrylamide. In an embodiment, the solution comprising the monomers is aqueous.

In certain embodiments, after the fixed sample is permeated with the hydrophilic monomers, the monomers are polymerized within the permeated sample to provide a water-swellable composition comprising linkages between the linking agent and the water-swellable composition, to produce an anchored sample. Such an anchored sample is considered to be crosslinked to the water-swellable composition material before expansion. In some embodiments, this can be accomplished by chemically crosslinking the detectably labeled moiety and/or the detectably labeled binding moiety with the water-swellable composition, such as during or after the polymerization of or in situ formation of the water-swellable composition.

In certain embodiments, after the labeled, cross-linked sample has been anchored to the water-swellable composition, the anchored sample can be subjected to a homogenization or disruption of the endogenous biological molecules, leaving the detectably labeled moieties, tags, labels or fluorescent dye molecules intact and anchored to the water-swellable composition in a processed sample. In this way, the mechanical properties of the processed sample comprising the water-swellable composition in complex with the detectably labeled moiety and/or detectably labeled binding moiety and cellular components are rendered more spatially uniform, allowing isotropic expansion in three dimensions with minimal distortion or artifacts.

As used herein, a “homogenizing agent” refers to an agent that causes the disruption of the endogenous biological molecules of the sample. In certain embodiments, this generally refers to the mechanical, physical, chemical, biochemical, or enzymatic digestion, disruption or break up of the sample so that it will not resist expansion. It is preferable that the disruption does not impact the structure of the water-swellable composition, but disrupts the structure of the sample. Thus, the sample homogenization should be substantially inert to the water-swellable composition. The degree of homogenization can be sufficient to compromise the integrity of the mechanical structure of the sample. In some embodiments, the sample can be homogenized by denaturation with SDS, an enzyme (i.e, a protease), by physical disruption (for example sonication or exposing the sample to temperatures of about 70-95° C.), by chemical proteolysis (e.g. cyanogen bromide), or other chemical treatments (e.g., treatment with a concentrated basic solution). In an embodiment, a protease enzyme can be used to homogenize the anchored sample comprising the water-swellable composition. Protease enzymes useful in proteolyzing samples are configured to break the peptide bonds that make up the proteins of the tissue sample. In certain embodiments, the proteases can include, but are not limited to, serine proteases, cysteine proteases, threonine proteases, aspartic proteases, glutamic proteases, metalloproteases, and asparagine peptide lyases. In an embodiment, the protease enzyme can be Proteinase K.

In certain embodiments, following homogenization of the anchored sample, the sample can be then expanded by dialyzing in an aqueous solution. The aqueous solution can be added to the processed/homogenized sample, which is then absorbed by the water-swellable composition and causes expansion. In an embodiment, the addition of water allows for the sample to expand approximately 2 times, approximately 3 times, approximately 4 times, approximately 5 times, approximately 6 times, or more its original size in three dimensions. In an embodiment, the addition of water allows for the sample to expand approximately 2-6 fold, 3-4 fold, or 4.0-4.3 fold. Because the composition swells isotropically, the anchored detectably labeled moiety and/or detectably labeled binding moiety maintain their relative spacial relationship in the sample and distortion is minimal. For example, distortions can be below 100 nm (root mean square distance) over length scales of up to 30 μm; distortions can be below 25 nm (root mean square distance) over length scales of up to 20 μm; and over length scales of up to 30 μm distortions can be generally below 0.2 μm.

In certain embodiments of the method, the fixed cell sample or fixed tissue sample is incubated with the linking agent for a time and under conditions to promote cross-linking by the linking agent of a target in the sample to the detectably labeled moiety, to produce a cross-linked sample. In some embodiments of the method, the fixed cell sample or fixed tissue sample is incubated with the linking agent for 1 minute, 2 minutes, 3 minutes, 4 minutes 5 minutes, 6 minutes, 7 minutes, 8 minutes, 9 minutes, 10 minutes, 11 minutes, 12 minutes, 13 minutes, 14 minutes, 15 minutes, 20 minutes, 25 minutes, 30 minutes, 35 minutes, 40 minutes, 45 minutes, 50 minutes, 55 minutes, 60 minutes, 65 minutes, 70 minutes, 75 minutes, 80 minutes, 85 minutes, 90 minutes, 95 minutes, 100 minutes, 120 minutes, 150 minutes, 180 minutes, 210 minutes, or more minutes. In other embodiments, the fixed cell sample or fixed tissue sample is incubated with the linking agent for 5-180 minutes, 10-60 minutes, or 15-45 minutes. In certain embodiments of the method, the fixed cell sample or fixed tissue sample is incubated with the linking agent at 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C. or more. In other embodiments, the fixed cell sample or fixed tissue sample is incubated with the linking agent at 5-40° C., 10-25° C., or at 20-23° C. In an embodiment, the fixed cell sample or fixed tissue sample is incubated with the linking agent at room temperature. In certain embodiments of the method, the fixed cell sample or fixed tissue sample is incubated with 0.1 mM, 0.2 mM, 0.3 mM, 0.4 mM, 0.5 mM, 1.0 mM, 2.0 mM, 3.0 mM, 4.0 mM, 5.0 mM, 10 mM, 15 mM, 20 mM, 25 mM, 30 mM, 35 mM, 40 mM, 45 mM, 50 mM, 55 mM, 60 mM, 65 mM, 70 mM, 70 mM, 75 mM, 80 mM, 85 mM, 90 mM, 95 mM, 100 mM, or more of the linking agent. In certain embodiments of the method, the fixed cell sample or fixed tissue sample is incubated with 0.1-100 mM, 1.0-75 mM, 10-50 mM, 15-35 mM, 20-35 mM, or 25-30 mM of the linking agent. In an embodiment, the fixed cell sample or fixed tissue sample is incubated with about 25 mM of the linking agent. In another embodiment, the fixed cell sample or fixed tissue sample is incubated with about 1 mM of the linking agent. In certain embodiments of the method, the fixed cell sample or fixed tissue sample is incubated with 0.01%, 0.02%, 0.03%, 0.04%, 0.05%, 0.075%, 0.10%, 0.11%, 0.12%, 0.13%, 0.14%, 0.15%, 0.20%, 0.25%, 0.30%, 0.35%, 0.40%, 0.45%, 0.50%, 0.55%, 0.60%, 0.70%, 0.80%, 0.90%, 1.0%, 2.0%, 2.5%, 3.0%, 3.5%, 4.0%, 4.5%, 5.0%, 5.5%, 6.0%, 7.0%, 8.0%, 9.0%, 10.0%, 20%, 30%, 40%, 50% or more of the linking agent. In certain embodiments of the method, the fixed cell sample or fixed tissue sample is incubated with 0.01-50%, 0.05-5%, 0.1-0.5%, 0.15-0.35%, 0.20-0.35%, or 0.25-0.3% of the linking agent. In an embodiment, the fixed cell sample or fixed tissue sample is incubated with 0.25% of the linking agent. In another embodiment, the fixed cell sample or fixed tissue sample is incubated with 0.1% of the linking agent.

In an embodiment of the method, the crosslinked sample is permeated with hydrophilic monomers to produce a permeated sample. In certain embodiments, the crosslinked sample is permeated with hydrophilic monomers for about 10 seconds, about 30 seconds, about 45 seconds, about 1 minute, about 90 seconds, about 2 minutes, about 3 minutes, about 4 minutes, about 5 minutes, about 10 minutes, about 15 minutes, about 30 minutes, about 45 minutes, about 60 minutes, about 90 minutes, about 120 minutes, about 150 minutes or more. In some embodiments, the crosslinked sample is permeated with hydrophilic monomers for about 10 seconds to about 3 minutes, about 45 seconds to about 90 seconds, about 10 minutes to about 45 minutes, about 60 minutes to about 120 minutes. In an embodiment, the crosslinked sample is permeated with hydrophilic monomers for about 1 minute. In another embodiment, the crosslinked sample is permeated with hydrophilic monomers for about 45 minutes. The duration of monomer permeation may be optimized depending on the specific specimen and is readily determined by an ordinarily skilled artisan. In certain embodiments, the crosslinked sample is permeated with hydrophilic monomers at about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C. or more. In other embodiments, the crosslinked sample is permeated with hydrophilic monomers at about 4-40° C., 10-25° C., or at 20-23° C. In an embodiment, the crosslinked sample is permeated with hydrophilic monomers at about 4° C. In another embodiment, the crosslinked sample is permeated with hydrophilic monomers at about 37° C.

In certain embodiments, the water-swellable composition is incubated for a time and under conditions to promote the formation of linkages between the linking agent and the water-swellable composition, to produce an anchored sample. In some embodiments, the monomers permeated with the sample are polymerized within the permeated sample to provide a water-swellable composition. In certain embodiments, an initiator or catalyst can be used to start the polymerization (or gelation) of the water-swellable composition. In some embodiments, the monomers permeated with the sample are polymerized for about 5 minutes, 10 minutes, 15 minutes, 30 minutes, 45 minutes, 60 minutes, 65 minutes, 90 minutes, 120 minutes, 180 minutes, or more minutes. In other embodiments, the fixed cell sample or fixed tissue sample is incubated with the linking agent for 5-180 minutes, 10-60 minutes, or 15-45 minutes. In an embodiment, polymerization (gelation) was allowed to proceed for about 30 minutes. In another embodiment, polymerization (gelation) was allowed to proceed for about 2-2.5 hours. In certain embodiments, polymerization (gelation) occurs at about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C. or more. In other embodiments, polymerization (gelation) occurs at about 4-40° C., 10-25° C., or at 20-23° C. In an embodiment, polymerization (gelation) occurs at about 4° C. In another embodiment, polymerization (gelation) occurs at about 37° C.

In certain embodiments, the anchored sample is treated with a homogenizing agent for a time and under conditions to promote homogenization of the anchored sample, to produce a processed sample. In some embodiments, the anchored sample is treated with a homogenizing agent for about 10 minutes, about 15 minutes, about 30 minutes, about 45 minutes, about 60 minutes, about 90 minutes, about 120 minutes, about 3 hours, about 4 hours, about 5 hours, about 8 hours, about 10 hours, about 12 hours, about 14 hours, about 16 hours, about 18 hours, or more. In an embodiment, the anchored sample is treated with a homogenizing agent for about 30 minutes. In another embodiment, the anchored sample is treated with a homogenizing agent for about 18 hours. In certain embodiments, the anchored sample is treated with a homogenizing agent at about 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., or more. In other embodiments, the anchored sample is treated with a homogenizing agent at about 4-60° C., 10-25° C., or at 20-23° C. In an embodiment, the anchored sample is treated with a homogenizing agent room temperature. In another embodiment, the anchored sample is treated with a homogenizing agent at about 37° C.

In certain embodiments, the processed sample is dialyzed in water, thereby expanding the water-swellable composition in the processed sample to produce an expanded sample. In some embodiments, the processed sample is dialyzed for about 5 minutes, 10 minutes, 15 minutes, 30 minutes, 45 minutes, 60 minutes, 90 minutes, 120 minutes, 150 minutes, 180 minutes or more. In an embodiment, the processed sample is dialyzed for about 90 minutes. In another embodiment, the processed sample is dialyzed for about 90 minutes where the water was exchanged approximately every 15 to 30 minutes until expansion was complete.

In some embodiments, the method comprising cross-linking, permeating, polymerizing, homogenizing, and dialyzing can be performed in less than 8 hours, less than 10 hours, less than 12 hours, less than 14 hours, less than 16 hours, less than 18 hours, less than 20 hours, less than 22 hours, or less than 24 hours.

In certain embodiments, the expanded sample can be imaged on any optical microscope, allowing effective imaging of features below the classical diffraction limit. Since the resultant specimen is preferably transparent, custom microscopes capable of large volume, wide field of view, 3D scanning may also be used in conjunction with the expanded sample. In some embodiments, the samples prepared by the methods disclosed herein can be analyzed by any of a number of different types of microscopy, for example, optical microscopy (e.g. bright field, oblique illumination, dark field, phase contrast, differential interference contrast, interference reflection, epifluorescence, confocal microscopy), laser microscopy, electron microscopy, and scanning probe microscopy.

Also provided are reagents and kits thereof for practicing one or more of the above-described methods. Reagents and kits may include one or more of the following: a linking agent; hydrophilic monomers; reagents for polymerizing the hydrophilic monomers to the water-swellable composition; and a homogenizing agent. Additionally, the kit may include clearing reagents, a detection macromolecule (e.g., labeled and or un-labeled antibodies, nucleic acid probes, and oligonucleotides), buffers (e.g. buffer for fixing, washing, clearing, and/or staining samples), mounting medium, embedding molds, and dissection tools). The reagents and kits thereof may vary greatly.

In a second aspect, the disclosure provides a kit comprising:
(a) a linking agent;
(b) hydrophilic monomers;
(c) reagents for polymerizing the hydrophilic monomers to the water-swellable composition; and
(d) a homogenizing agent.

In certain embodiments of the kit, the water-swellable composition comprises a polyacrylic acid, a polyacrylamide, a polyvinyl alcohol, an alginate, a chitosan, or polymers thereof. In an embodiment, the linking agent comprises a polymerizable group and a label-reactive group. In some embodiments of the kit, the linking agent is methacrylic acid N-hydroxy succinimidyl ester, acrylic acid N-hydroxy succinimidyl ester, or glutaraldehyde.

In certain embodiments, the kit comprises: a label comprising a fluorophore and a target binding moiety; hydrophilic monomers and reagents for polymerizing the hydrophilic monomers into a water-swellable composition; a linking agent configured to covalently bind the detectably labeled moiety and/or the detectably labeled binding moiety and covalently or non-covalently associate with the water-swellable composition; and a protease enzyme.

In certain embodiments, the kits of the present disclosure comprise one or more of:
nucleic acids encoding the protein labels or fluorescent proteins described herein,
viral vectors comprising nucleic acids encoding the protein labels or fluorescent proteins described herein, and
host cells comprising viral vectors comprising nucleic acids encoding the protein labels or fluorescent proteins described herein.
   Such kits can be used to express the protein labels or fluorescent proteins (e.g., GFP) within the cell and/or tissue sample endogenously. In certain embodiments, these kits further comprise reagents to express the protein labels, either endogenously within the tissue sample or in a host cell.

In addition to the above components, the kits may further include instructions for practicing the subject methods. These instructions may be present in the subject kits in a variety of forms, one or more of which may be present in the kit. One form in which these instructions may be present is as printed information on a suitable medium or substrate (e.g., a piece or pieces of paper on which the information is printed, in the packaging of the kit, in a package insert). Yet another means would be a computer readable medium (e.g., diskette, CD, digital storage medium), on which the information has been recorded. Yet another means that may be present is a website address which may be used via the Internet to access the information at a removed site. Any convenient means may be present in the kits.

As described further herein, in certain embodiments, the labels comprise proteins. In certain embodiments, the protein labels can be expressed endogenously in the tissue sample itself. Expression of the protein labels can be accomplished by methods known to those of skill in the art, including through the use of naked nucleic acids encoding the protein labels and viral vectors comprising the nucleic acids encoding the protein labels. In other embodiments, the protein labels can be expressed using host cells comprising viral vectors comprising nucleic acids encoding the protein labels.

### Examples

Methods that allow expansion microscopy (ExM) to use standard fluorophore-labeled secondary antibodies lacking DNA are shown. These antibodies are referred to as conventional secondary antibodies, and to their use as conventional immunostaining. The methods also allow the direct use of intrinsic fluorescent protein signal (e.g., GFP) in ExM.

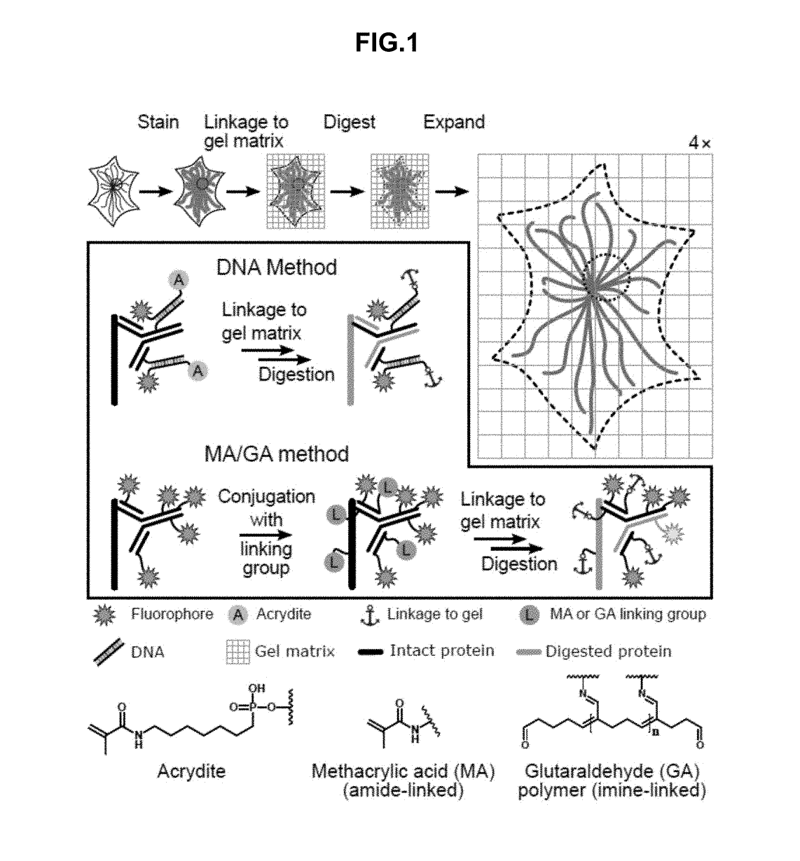

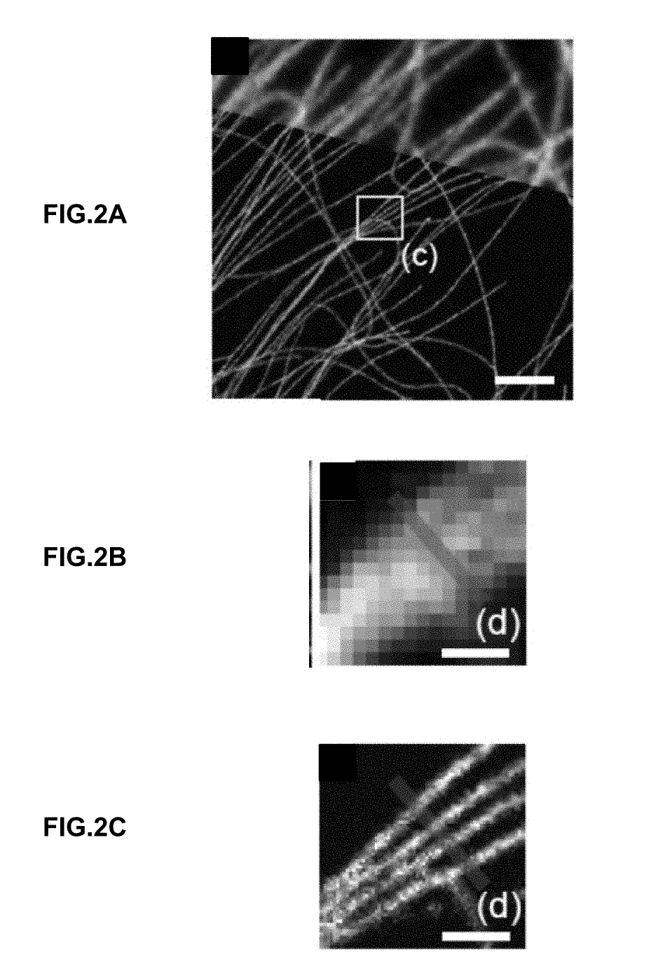

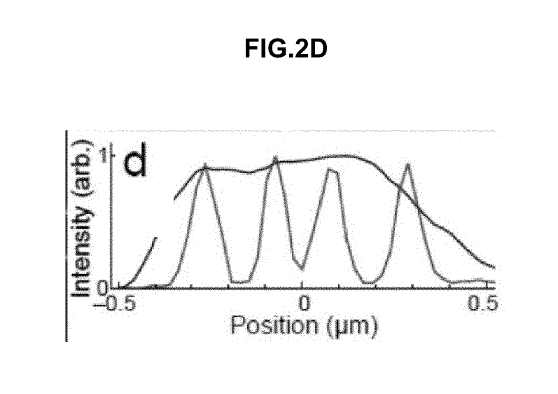

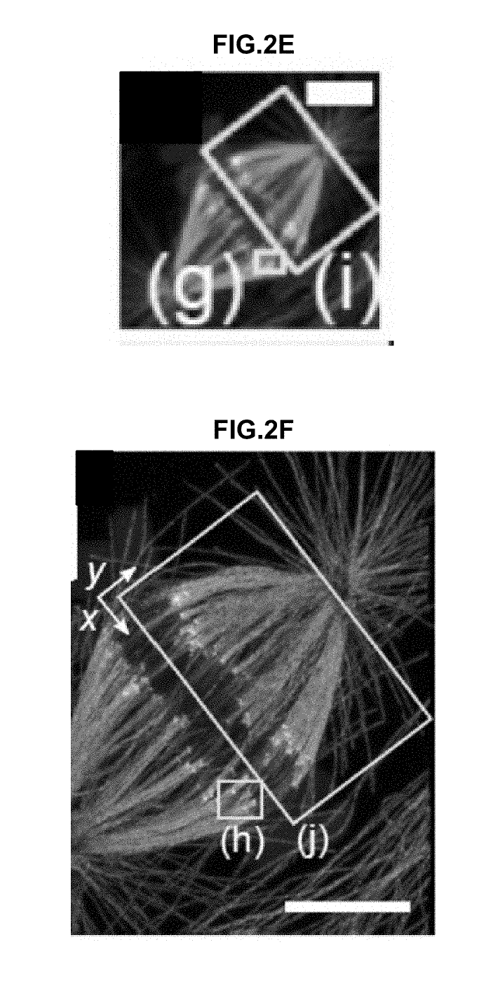

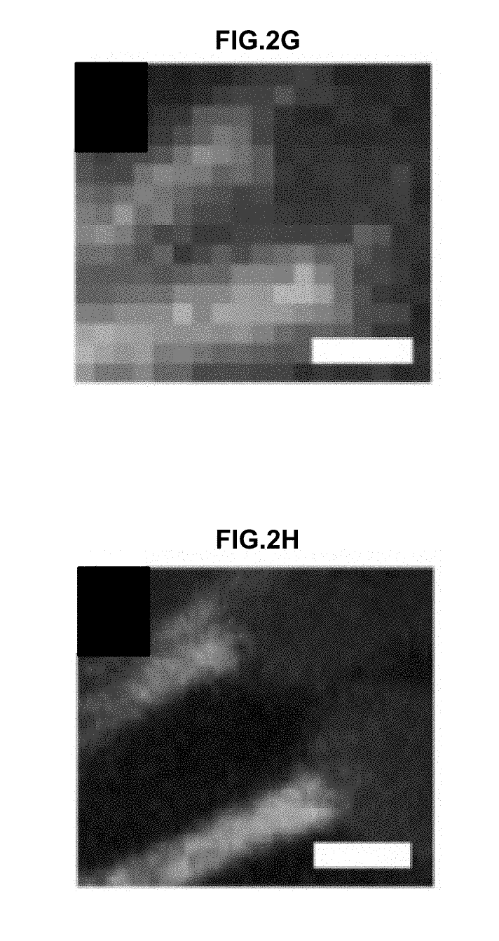

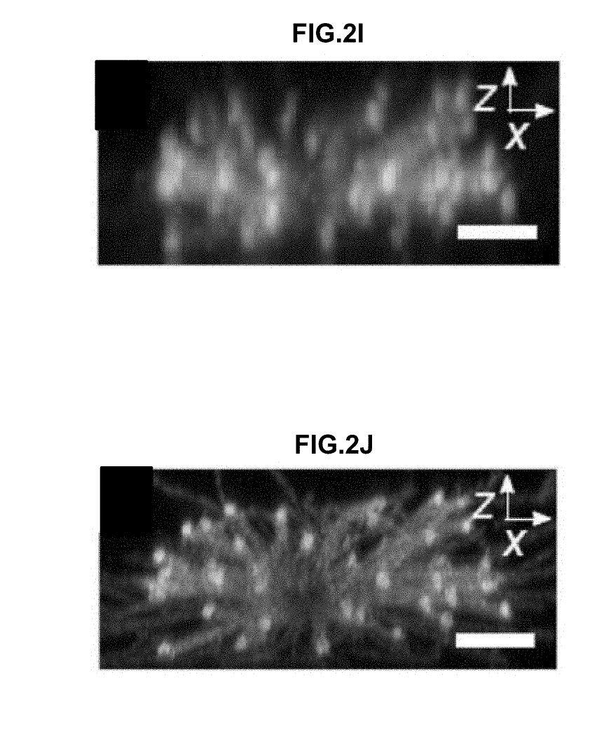

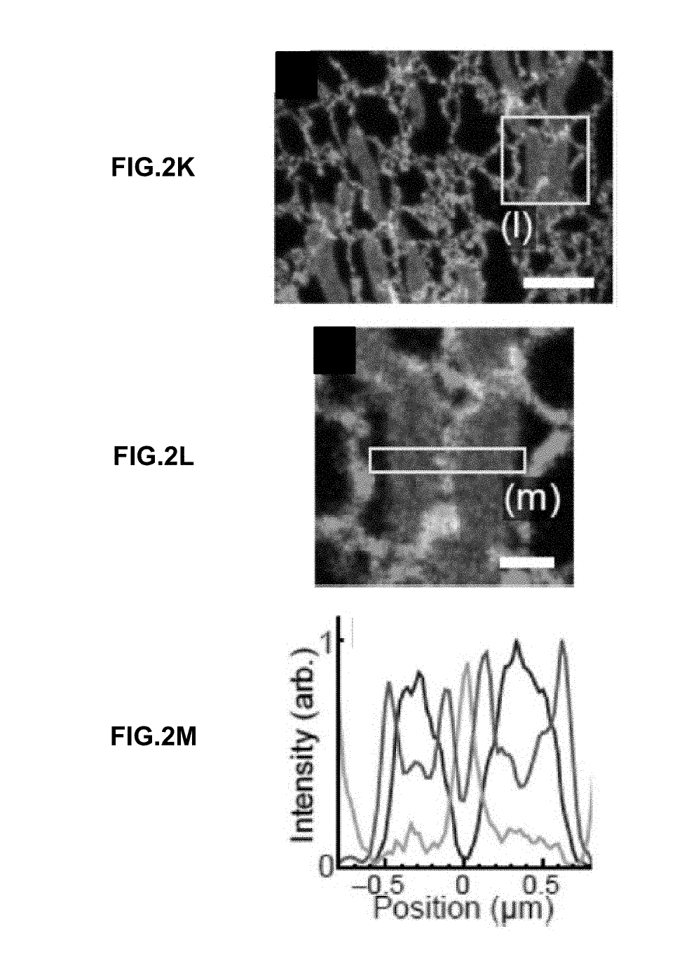

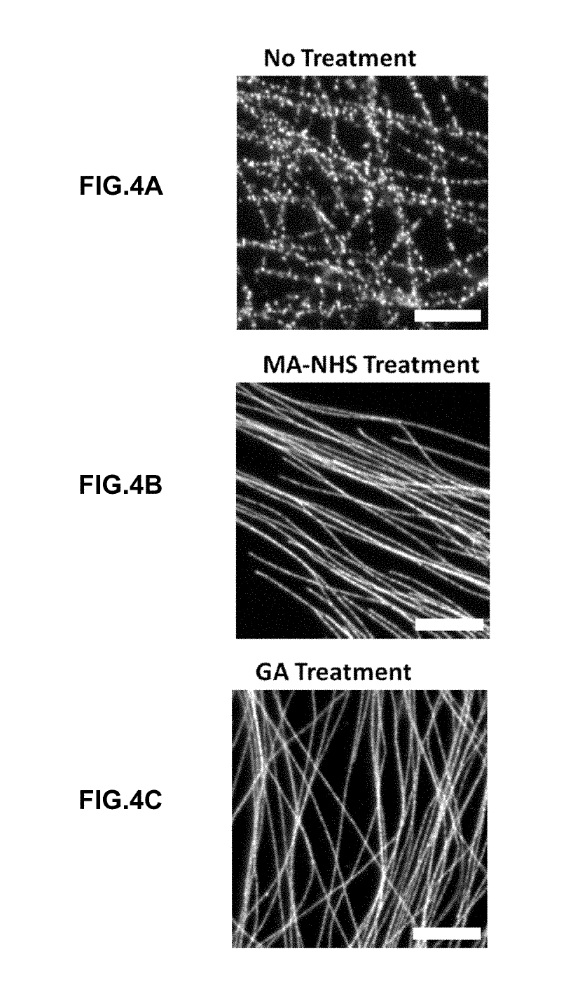

The overall strategy for linking the antibodies and hydrogel is shown in FIG. 1. Treatment of a fixed and conventionally immunostained cultured cells for 60 minutes with a 25 mM solution of the amine-reactive small molecule MA-NETS (methacrylic acid N-hydroxy succinimidyl ester) conferred excellent retention of fluorescent signal after digestion and expansion (FIG. 2A-FIG. 2D). Omission of the MA-NETS treatment resulted in distorted images with poor retention of fluorescence (see FIG. 4).

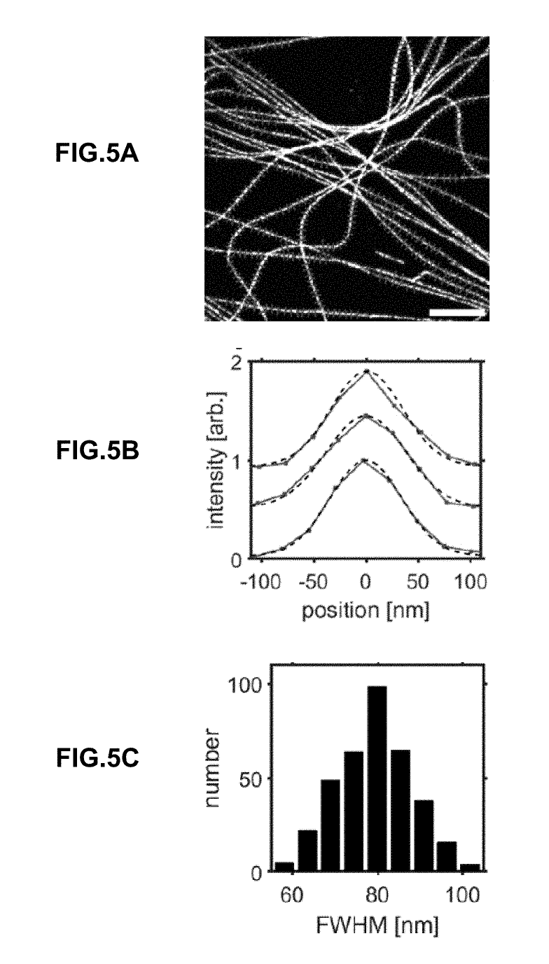

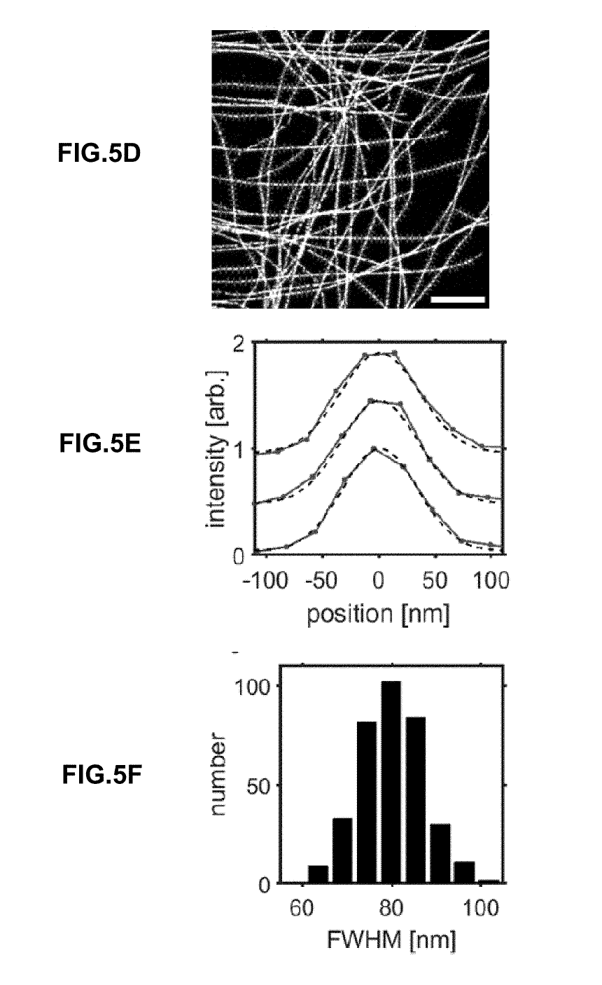

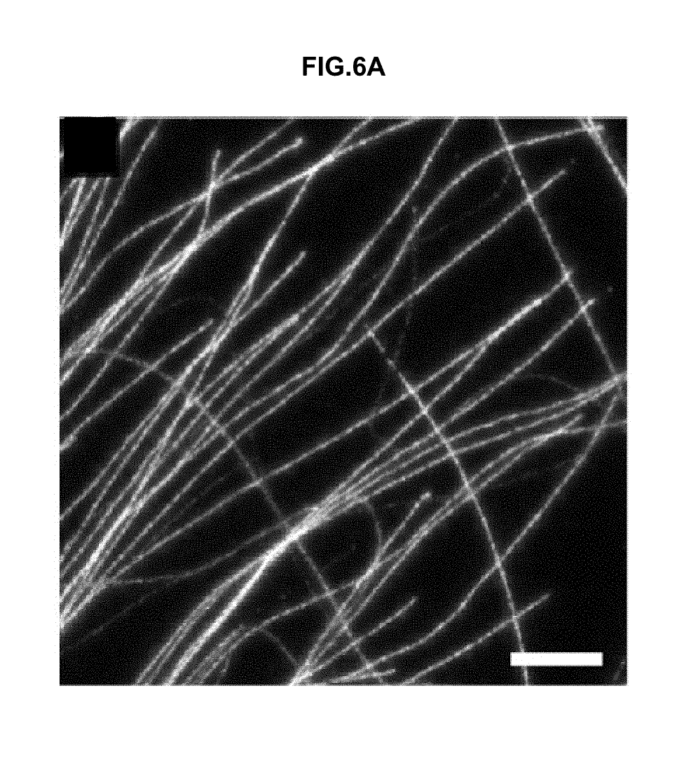

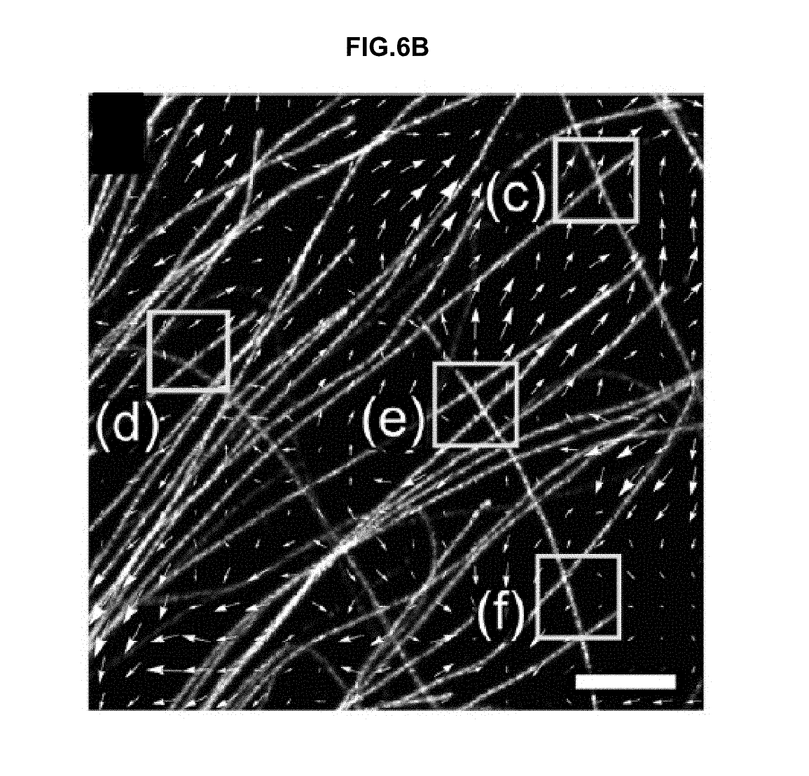

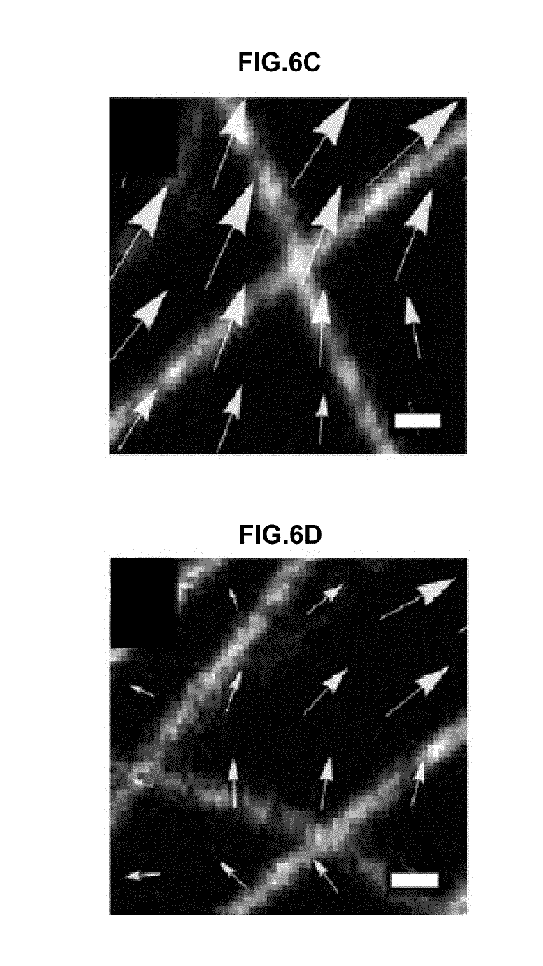

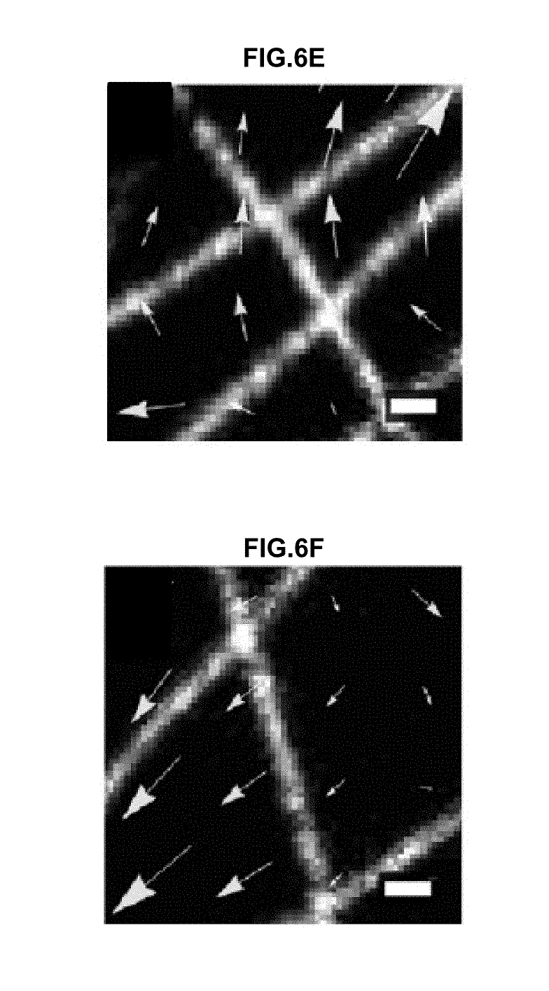

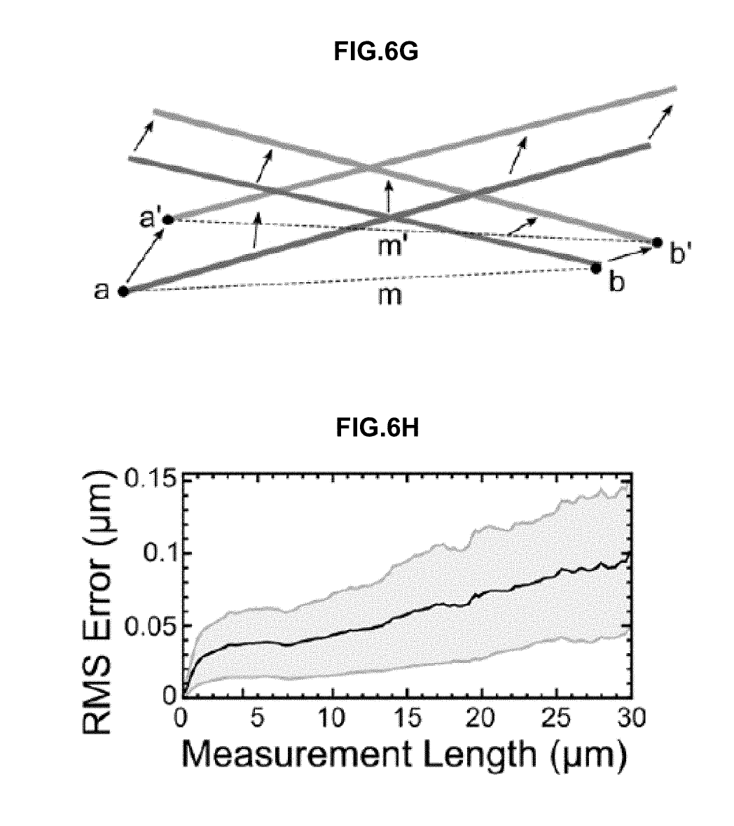

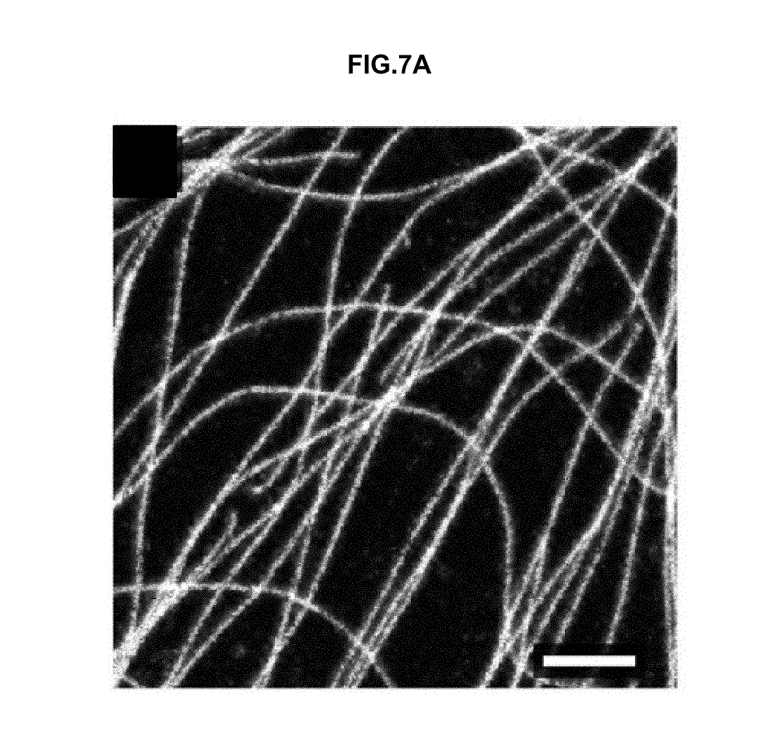

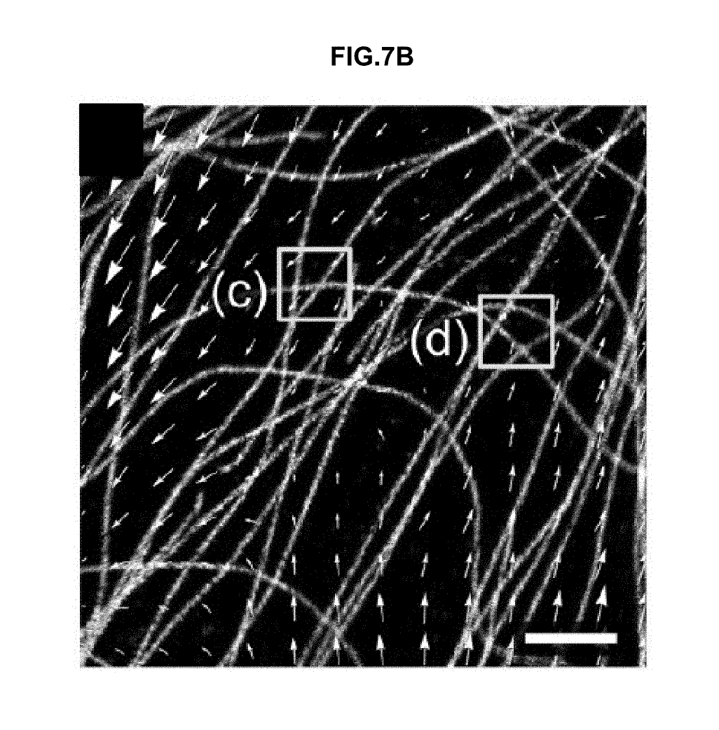

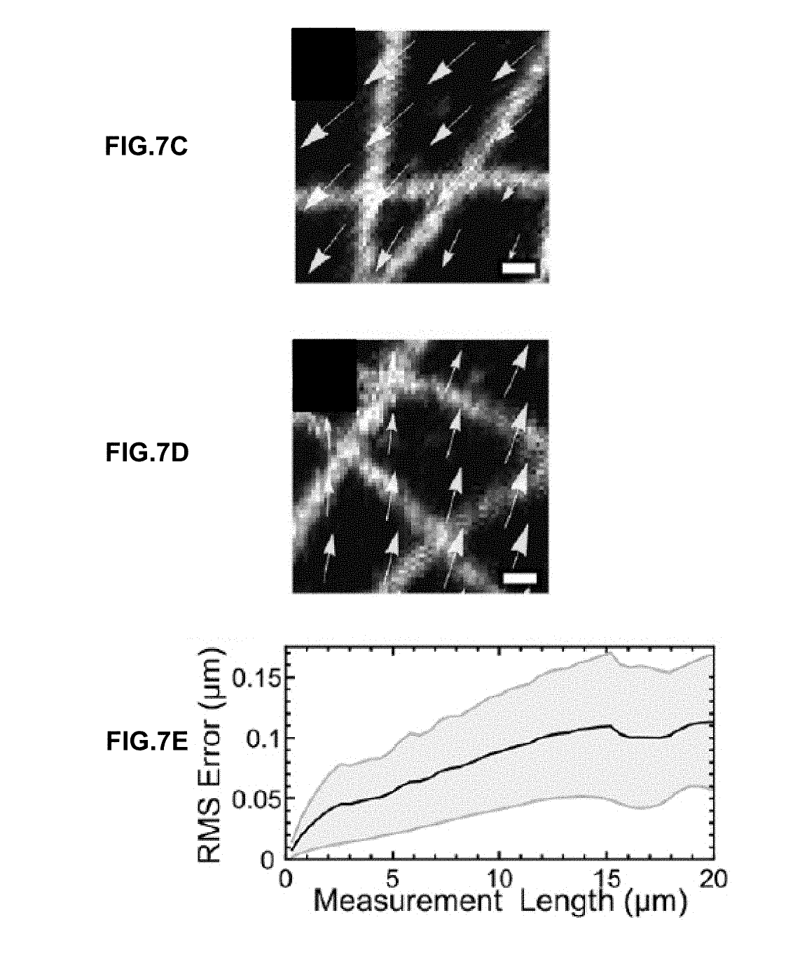

Fine details were observed in the images of expanded specimens which were hidden in images of the unexpanded specimens (see FIG. 2). The cross-sectional profile of expanded microtubules yields an average Gaussian-fitted full width at half maximum (FWHM) of 79±9 nm (mean±SD (standard deviation), see FIG. 5). This 79 nm width is consistent with a convolution of the double-peaked cross-sectional profile of indirectly immunolabeled microtubules measured by localization microscopy (i.e., stochastic optical reconstruction microscopy (STORM), photo activated localization microscopy (PALM), etc.) and an estimated ˜65 nm expansion-corrected lateral spatial resolution. The uniformity of expansion is remarkably good across the sample, and an analysis of distortions between corresponding pre-expansion and post-expansion images recorded by confocal microscopy showed that distortions were generally below 100 nm (root mean square distance) over length scales of up to 30 μm (see FIG. 6). A comparison of expansion fidelity using DNA-labeled secondary antibodies also yielded similar results (see FIG. 7). Note that all distances and scale bars for expanded specimens presented here have been divided by their respective, measured expansion factors of 4-4.2 and that all distances and scale bars therefore refer to pre-expansion dimensions.

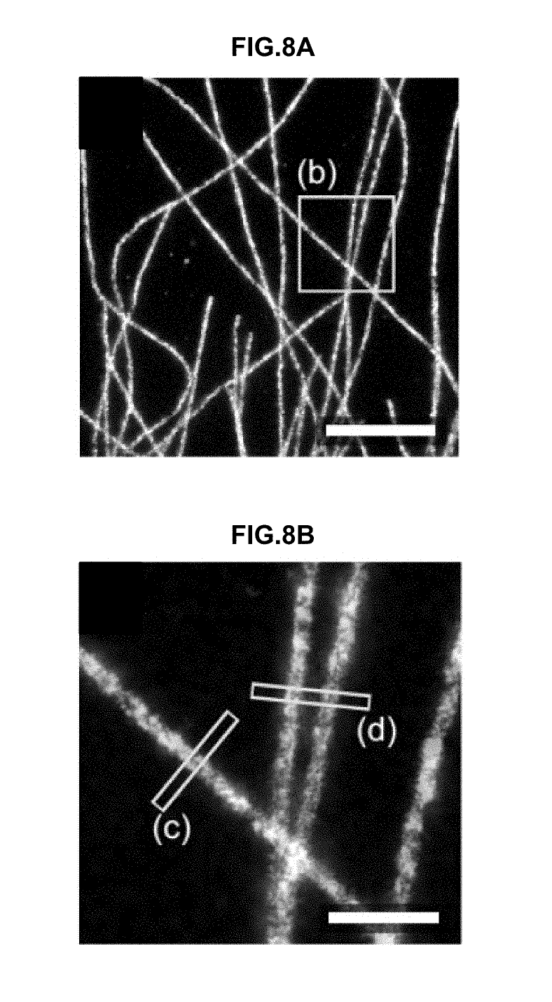

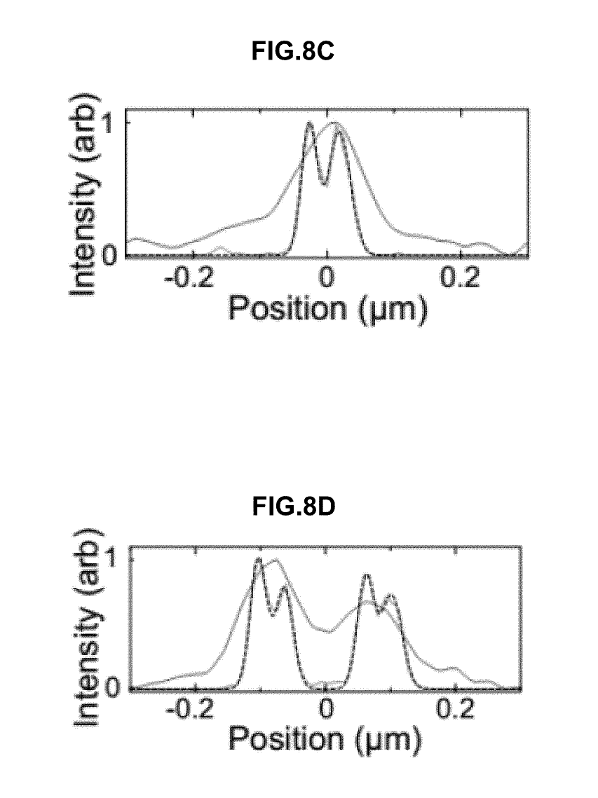

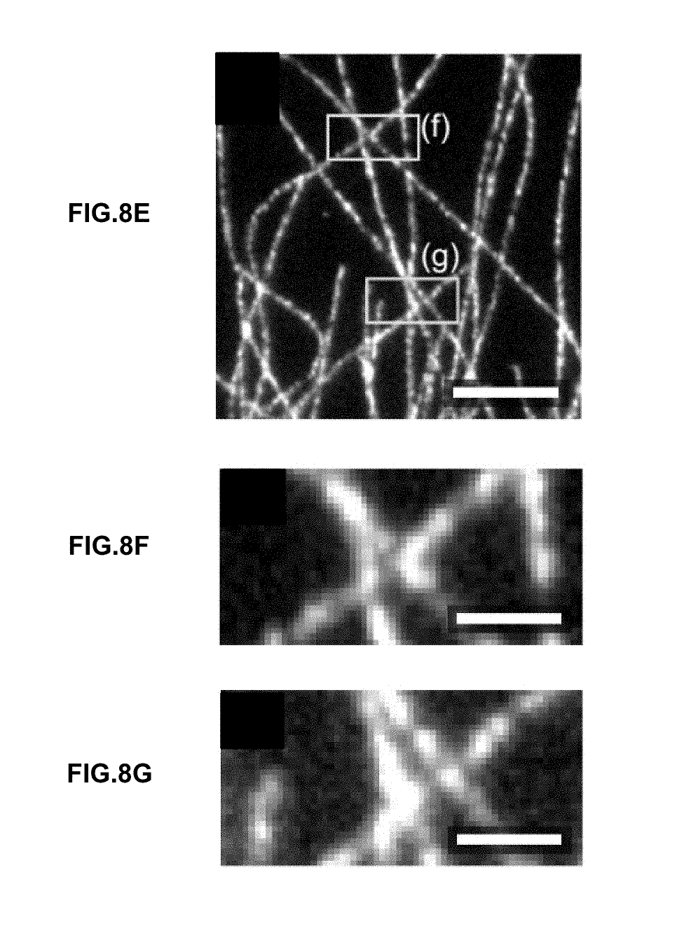

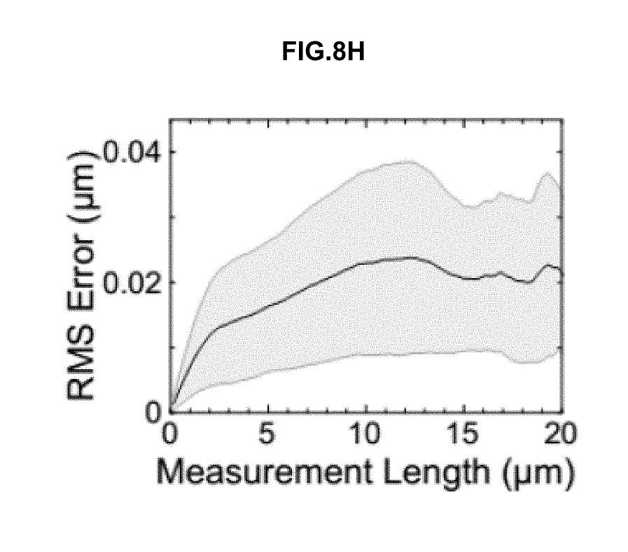

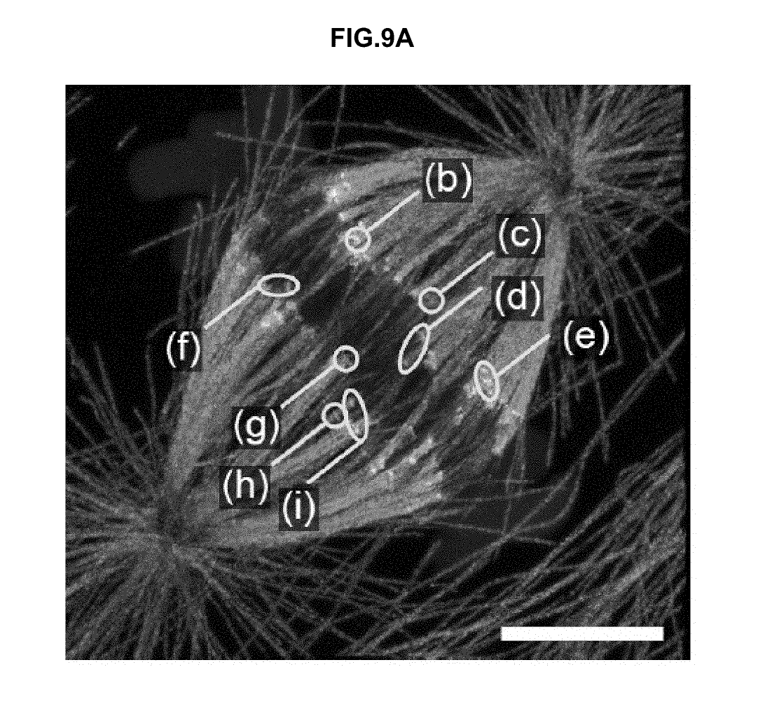

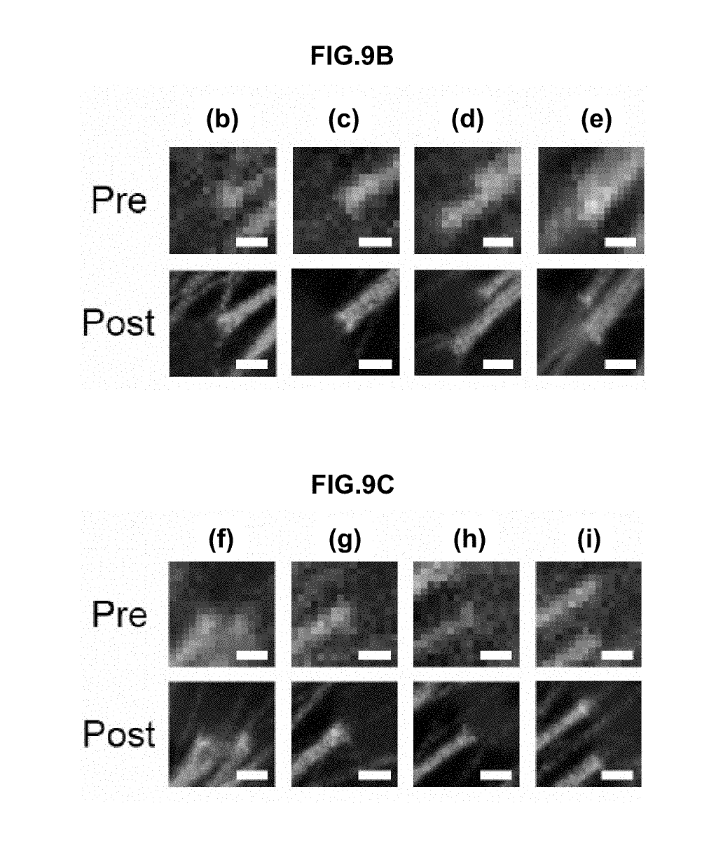

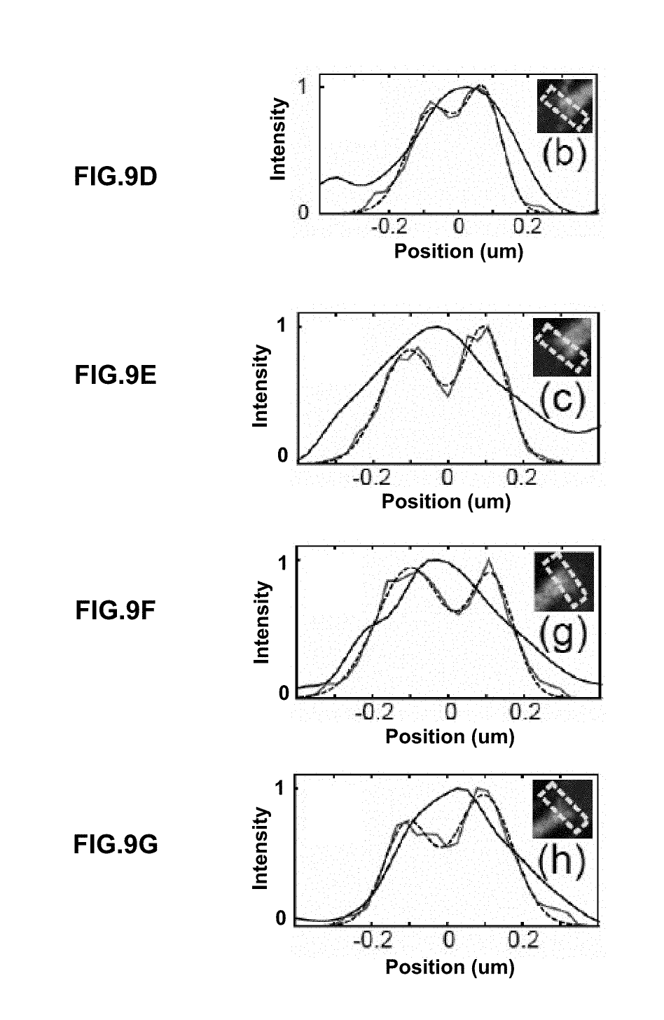

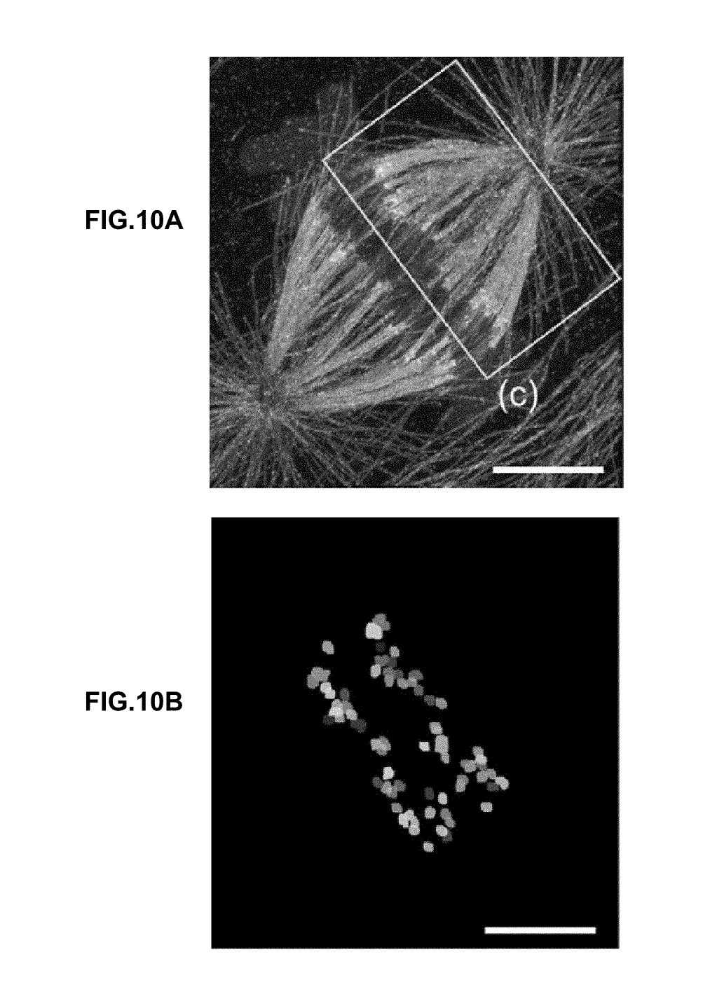

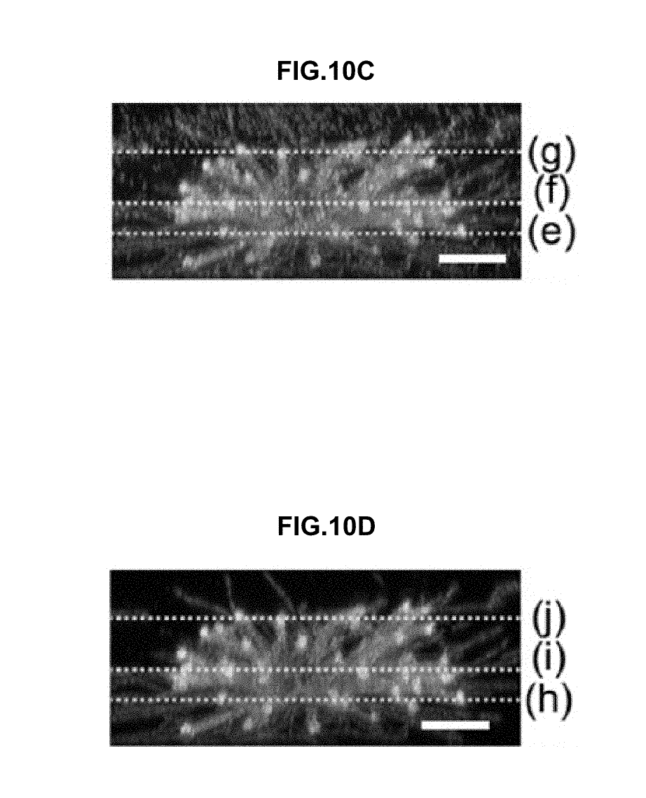

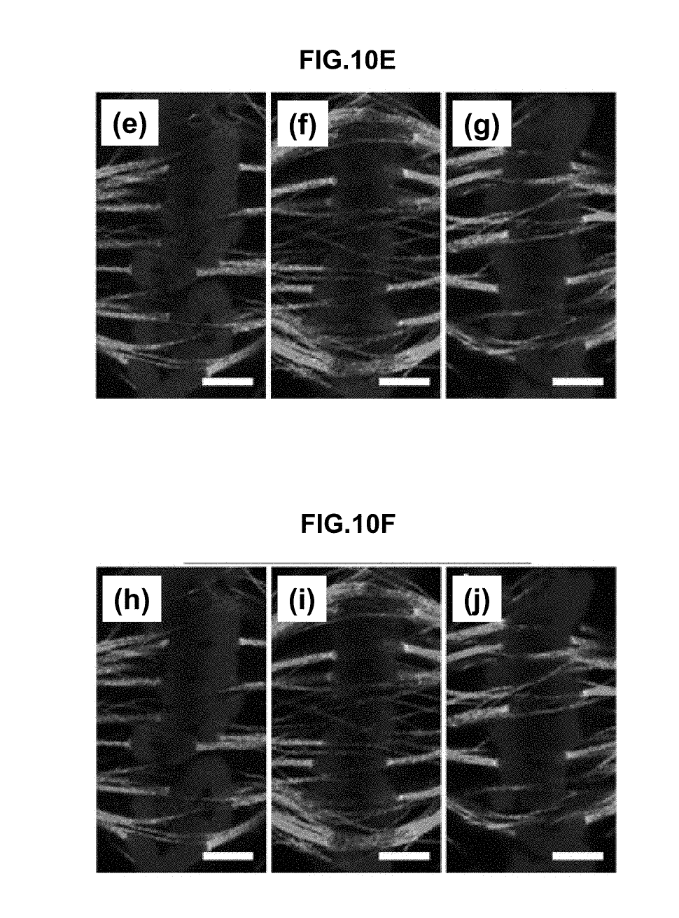

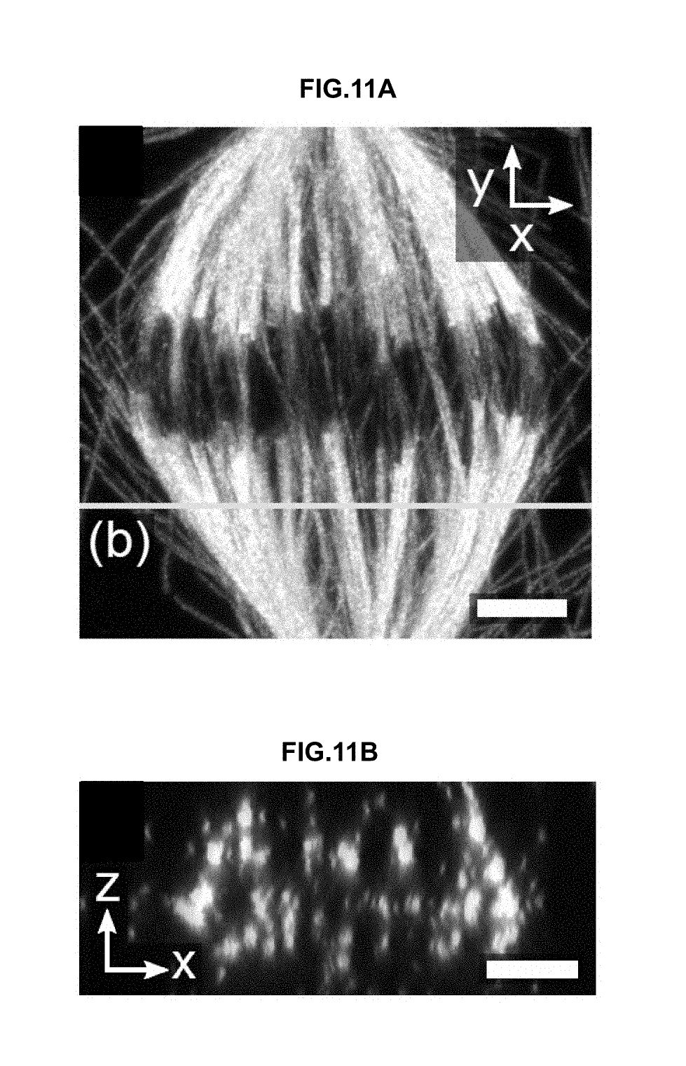

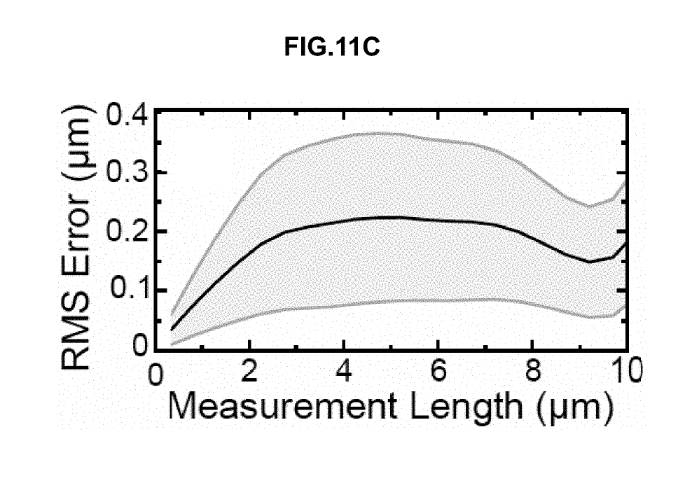

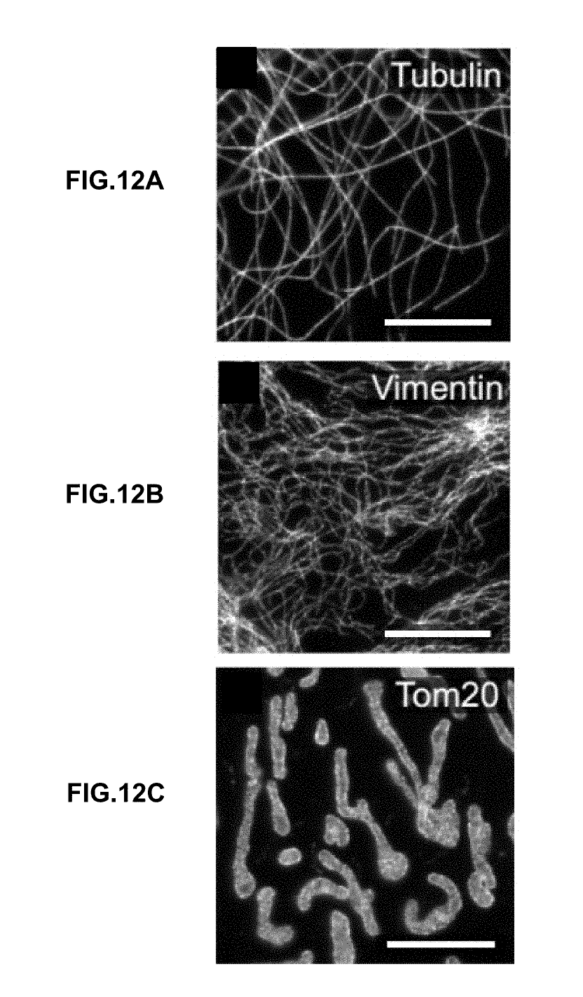

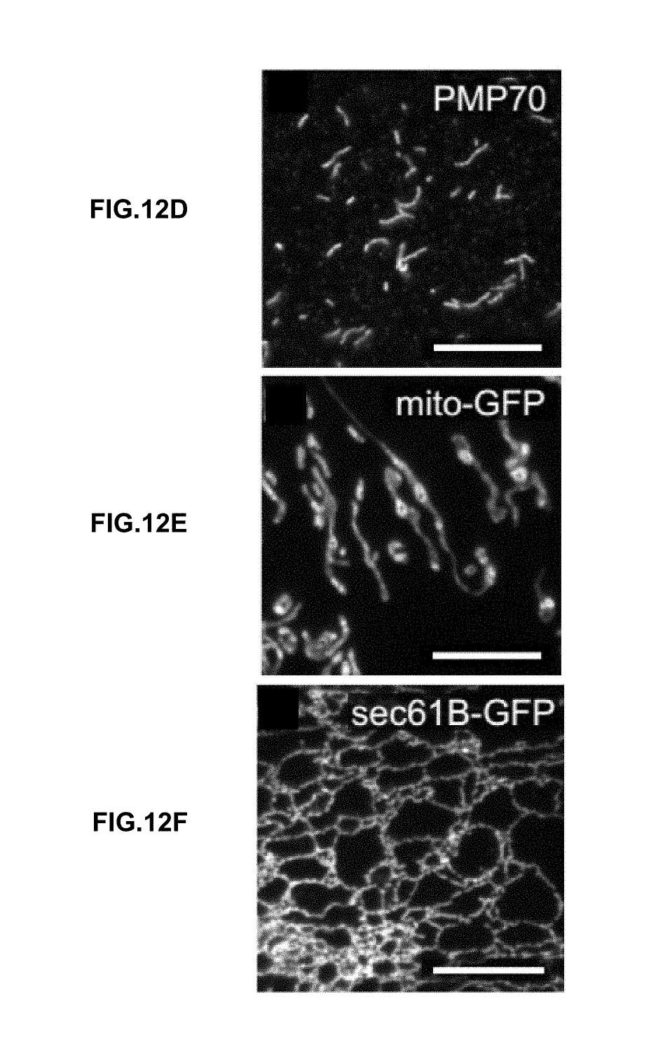

In a second approach, treatment of conventionally immunostained cultured cells with glutaraldehyde (GA) also yielded excellent fluorescence retention after digestion (see FIG. 4). Although GA post-fixation is used in immunofluorescence assays, GA crosslinking is also used in linking proteins or enzymes to polyacrylamide gels. Correlated pre-expansion localization microscopy and post-expansion confocal microscopy measurements using GA treatment of immunostained cells revealed that distortions were generally below 25 nm (root mean square distance) over length scales of up to 20 μm (see FIG. 8). Microtubule cross sectional profiles had an average Gaussian-fitted FWHM of 80±7 nm (mean±SD, see FIG. 5), indicating a spatial resolution of ˜65 nm as before. A three-color stain of an early anaphase PtK1 cell produced clear images of the mitotic spindle and distinctly resolved attachments between kinetochore-fiber microtubule bundles and chromosomes with good expansion fidelity (see FIG. 2E-J, FIG. 9, FIG. 10, and FIG. 11). Although the DNA stain TO-PRO-3 is quenched by the polymerization reaction, DNA was able to be stained after expansion through a brief incubation step with the dye (see methods). A panel of GA-treated immunostained cells for a variety of cytoskeletal structures and sub-cellular organelles are shown in FIG. 12.

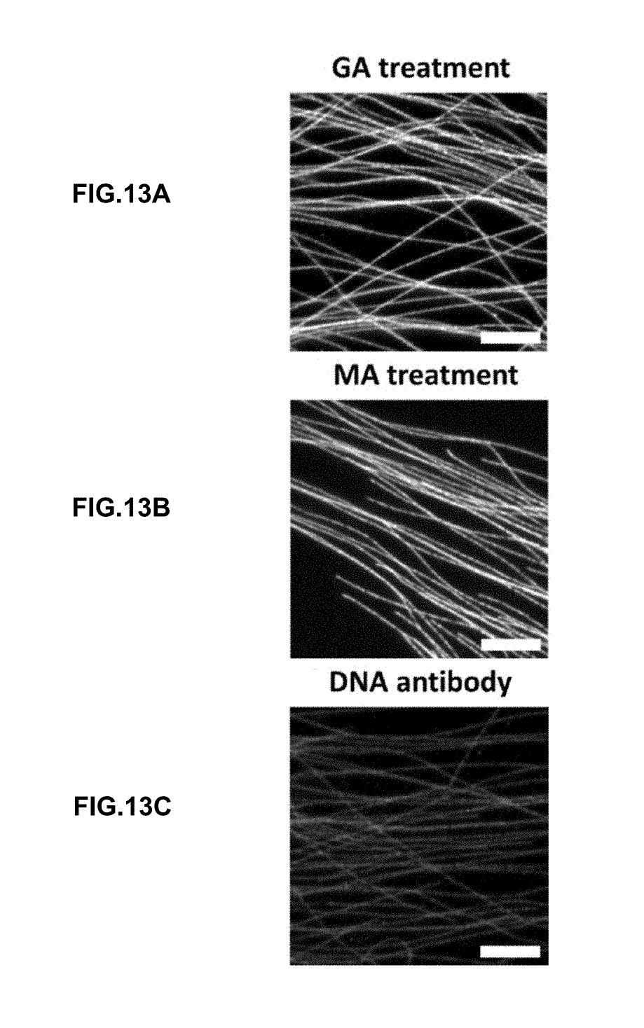

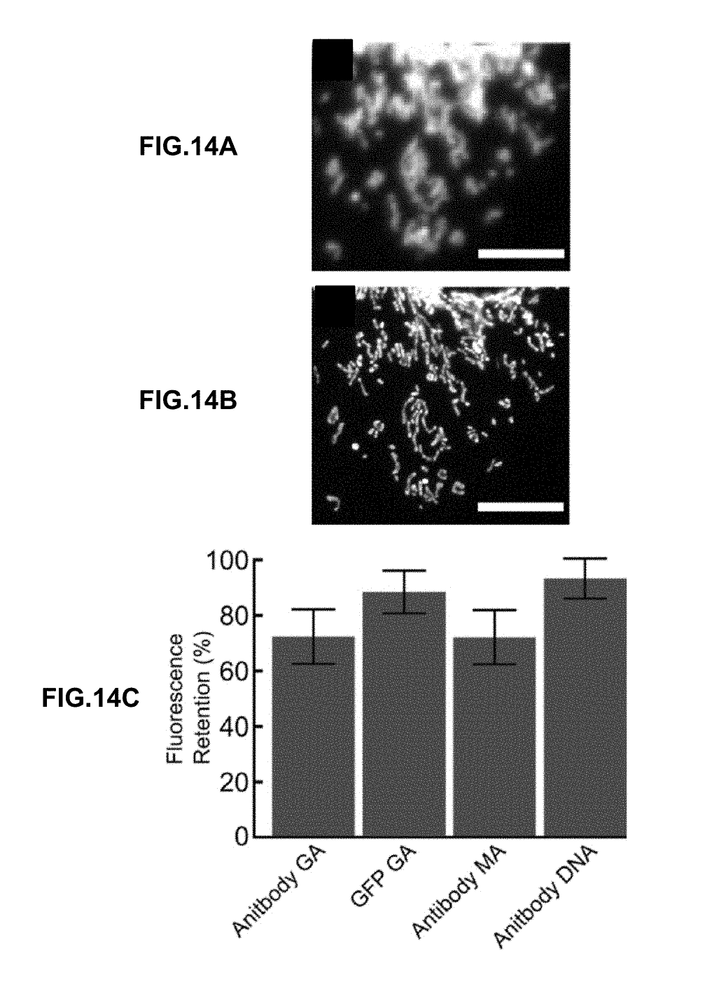

Conventionally immunostained cells treated with either MA-NETS or GA showed 3-4× brighter signal after expansion compared to untreated cells using DNA-labeled antibodies (FIG. 13). Although fluorescence retention post-expansion was somewhat better using DNA-labeled antibodies than with MA-NHS or GA treatment of conventional antibodies (˜90% compared to ˜70%, see FIG. 14), it was found that pre-expansion specimens were ˜4× brighter with conventional antibodies than with DNA-antibodies. The higher brightness likely results from the ability to conjugate more of the small fluorophore molecules (˜600 g mol⁻¹) to an antibody than the comparably large and highly negatively charged single-stranded oligonucleotides (˜6,000 g mol⁻¹) before compromising the antibody's binding ability.

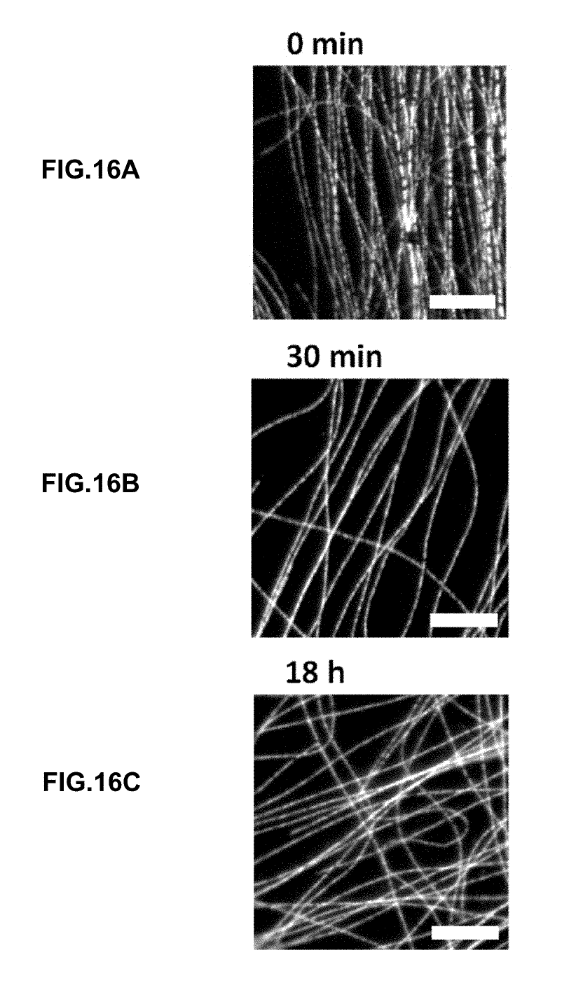

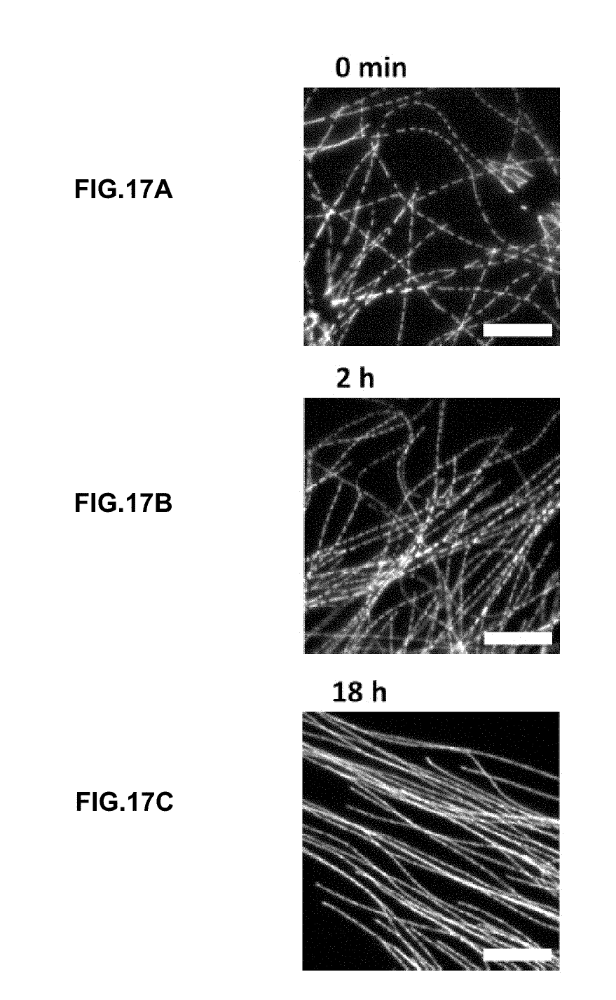

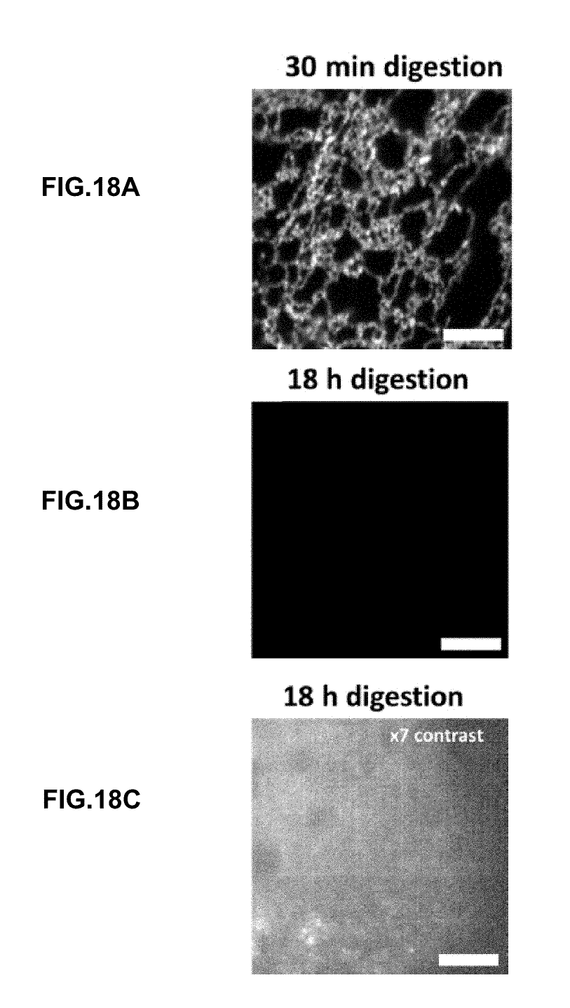

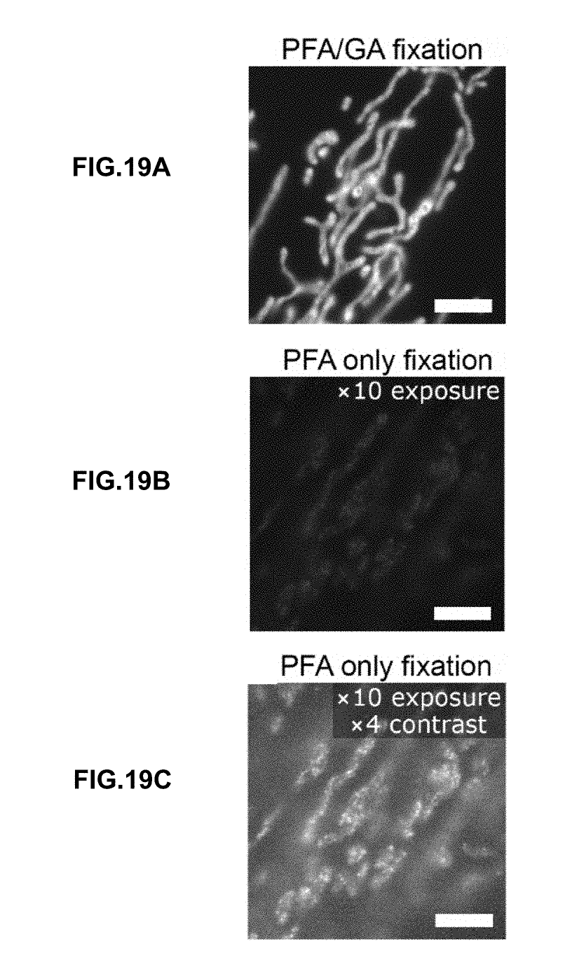

It was observed in cultured cells that GA-treated specimens tolerated short digestion times (˜30 minutes) with low distortion, while MA-treated specimens required longer digestion times to avoid distortion (˜12-18 hours, see FIG. 16 and FIG. 17). It was determined that cells treated with GA retained intrinsic fluorescence signal from fluorescent proteins (GFP, DsRed) targeted to various structures when using a ˜30 minute digestion time (see FIG. 2K-M, and FIG. 14). The use of long digestion times (>12 hours), or the omission of GA treatment, resulted in little retained fluorescent protein (FP) signal (see FIG. 18 and FIG. 19). Hybrid experiments using a mixture of FP and antibody stains are straightforward (FIG. 2K-M).

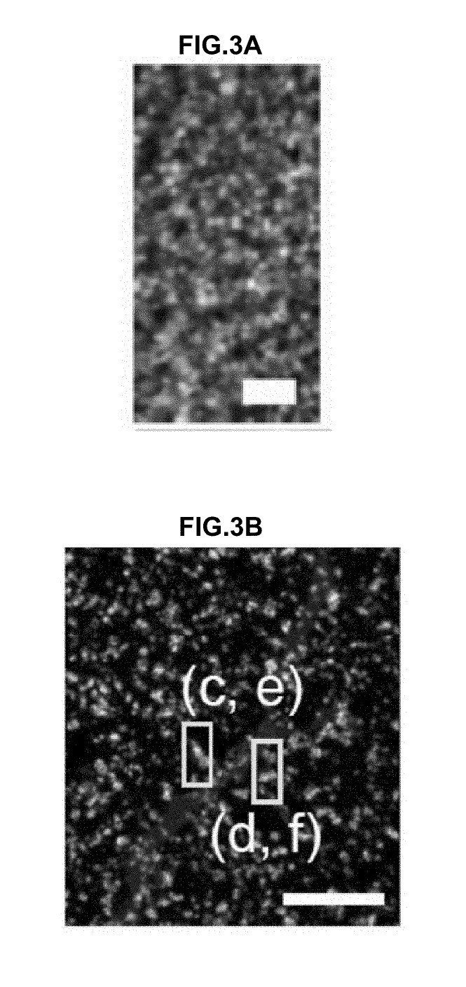

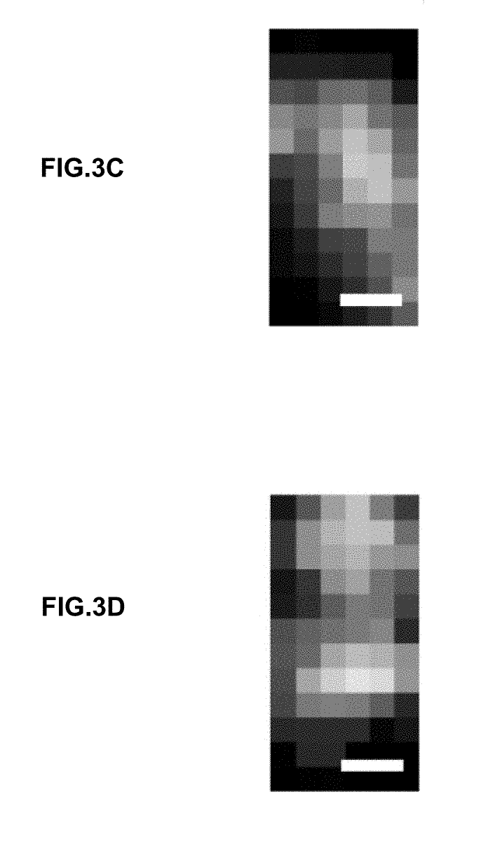

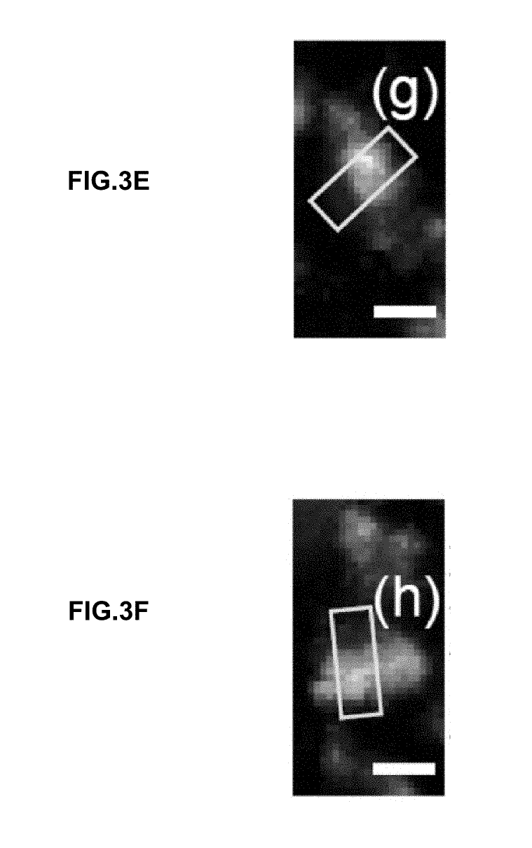

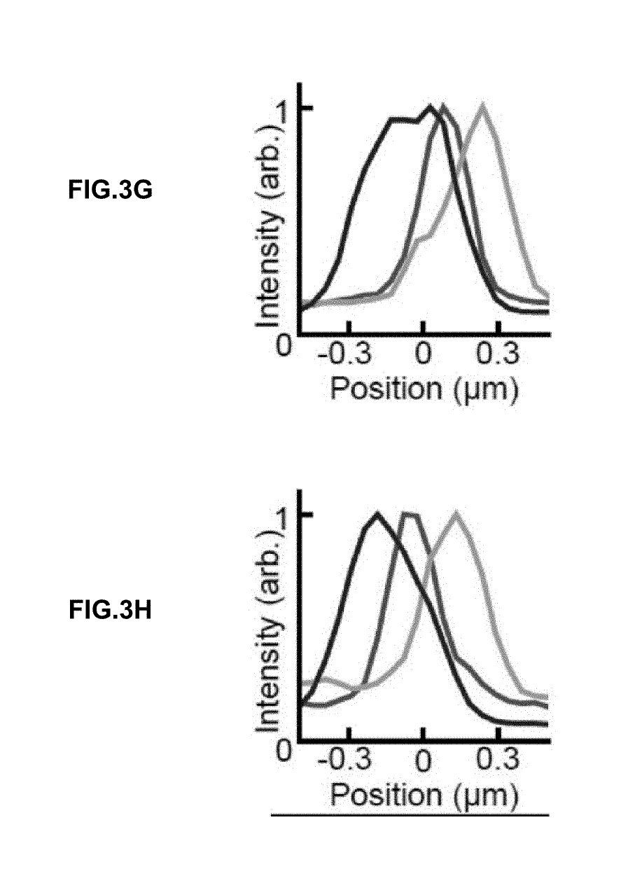

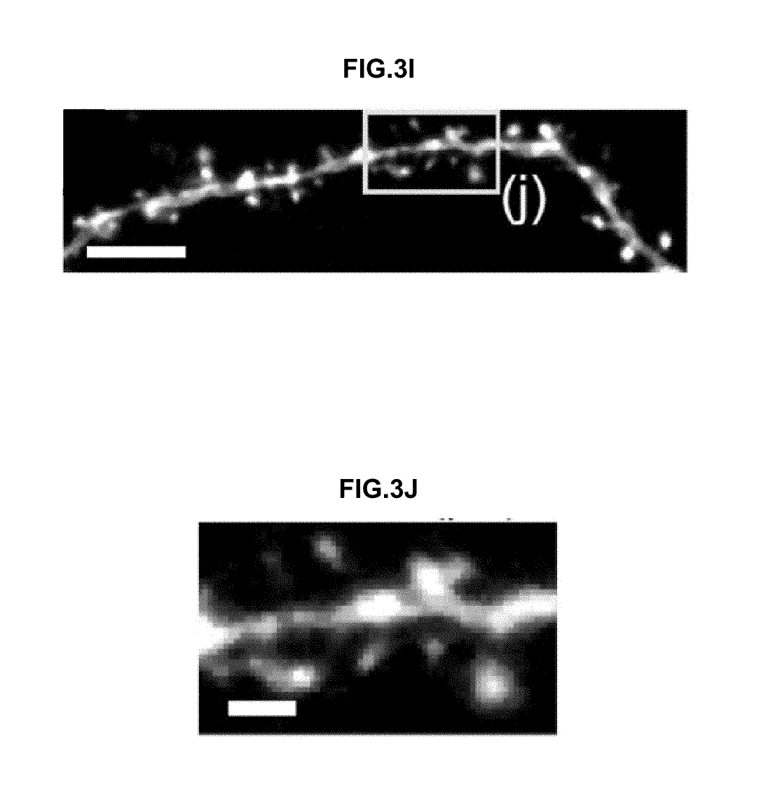

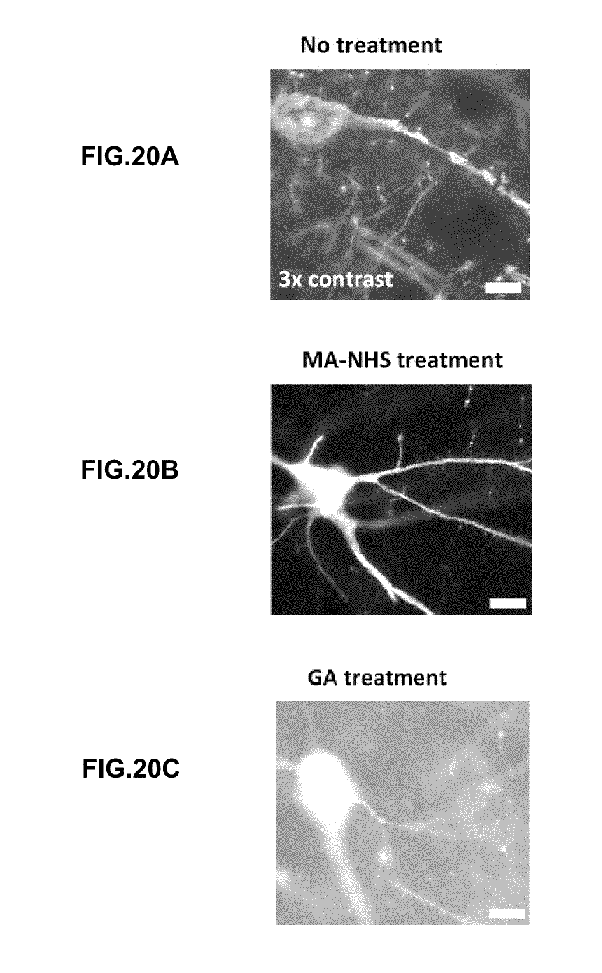

The above methods extended well to brain tissue. The treatment of conventionally immunostained 100 μm-thick THY1-YFP-H mouse brain slices with MA-NHS (FIG. 3) or GA retained antibody fluorescence, although the MA-NHS treatment may be preferred in brain tissue because treatment with GA leads to high levels of background fluorescence (see FIG. 20). Complete, high-fidelity expansion in tissue required a lower MA-NHS concentration than in cultured cells (1 mM for 60 minutes), presumably due to physical differences between the specimens.

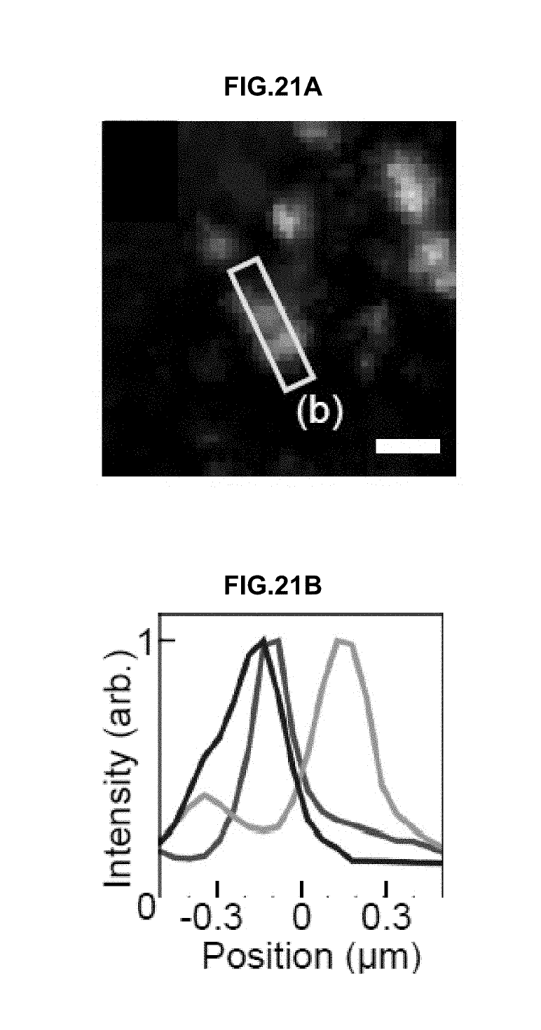

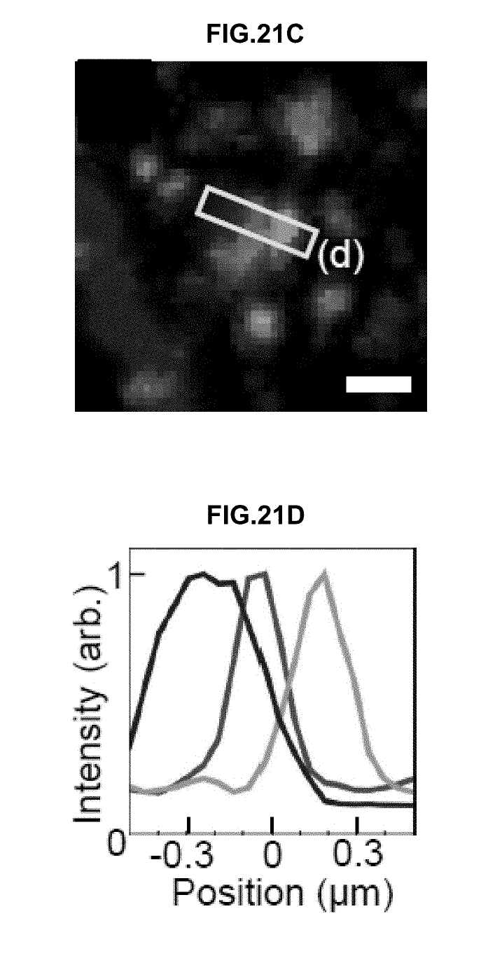

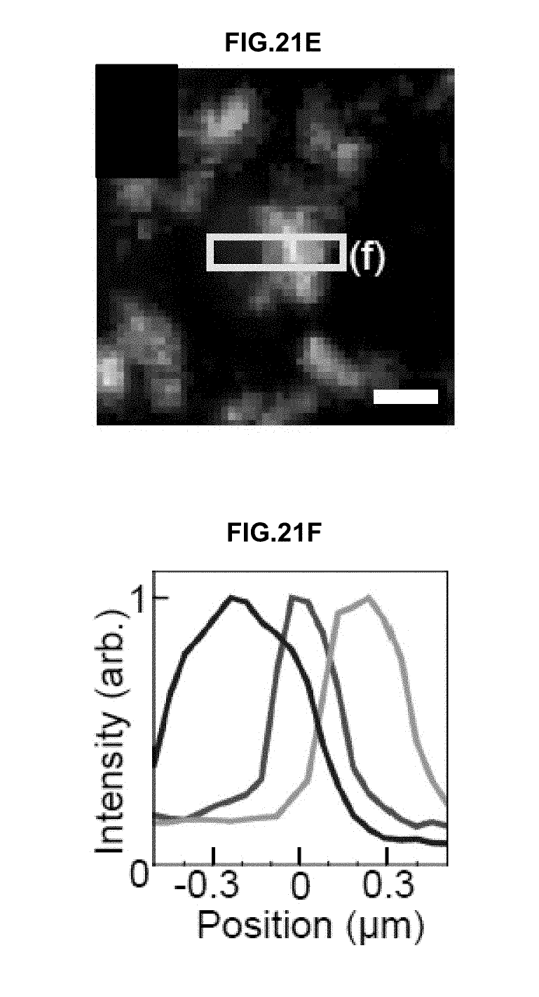

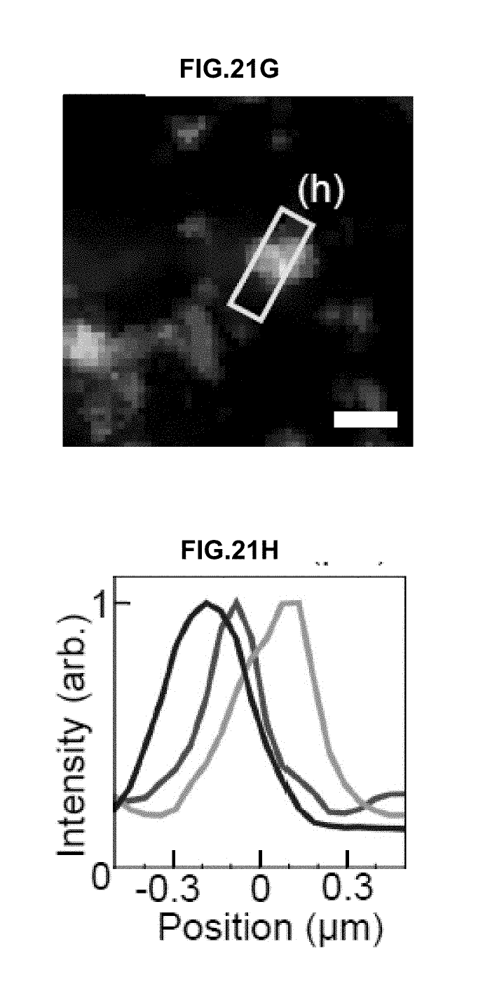

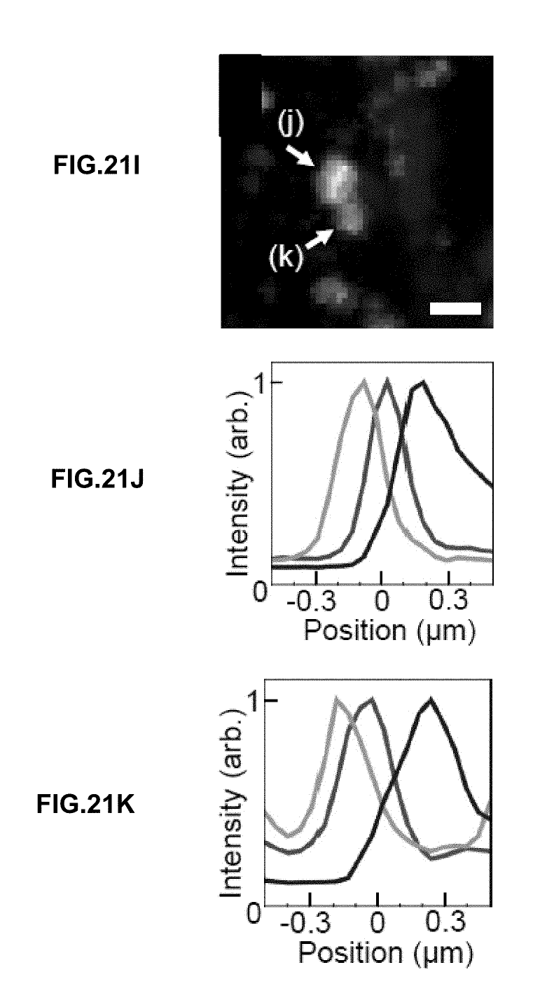

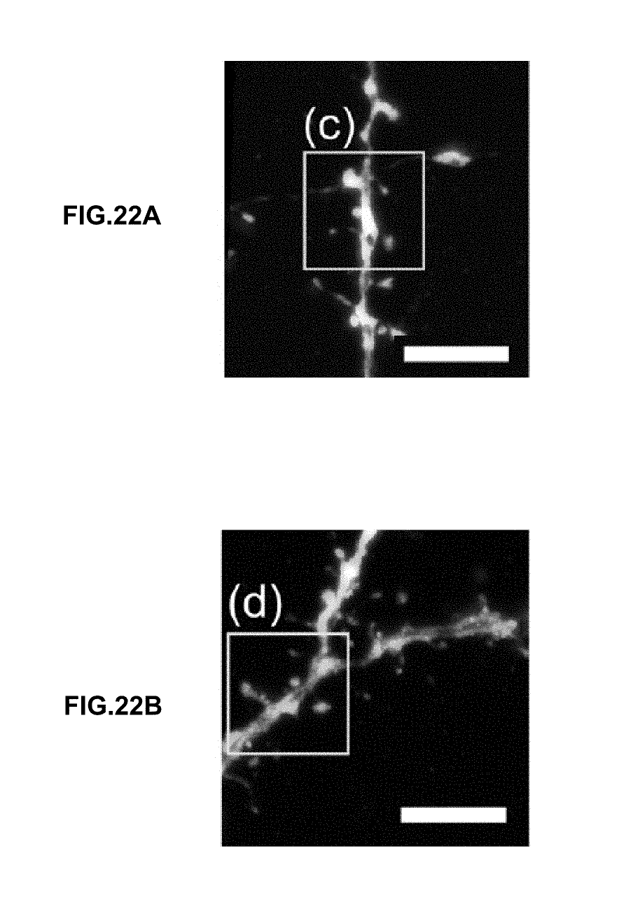

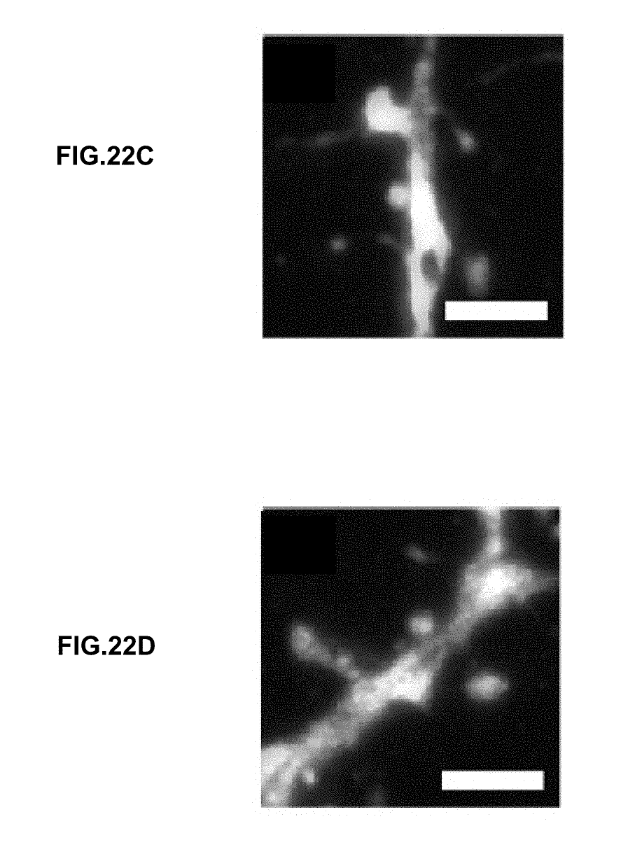

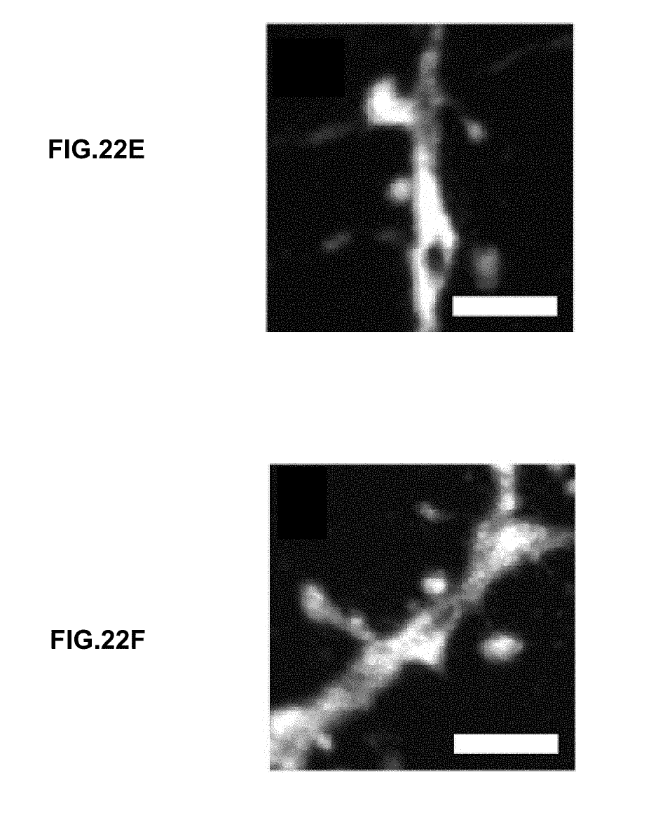

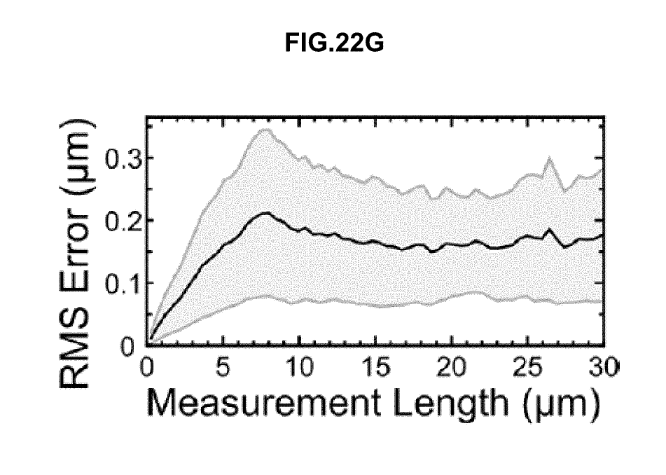

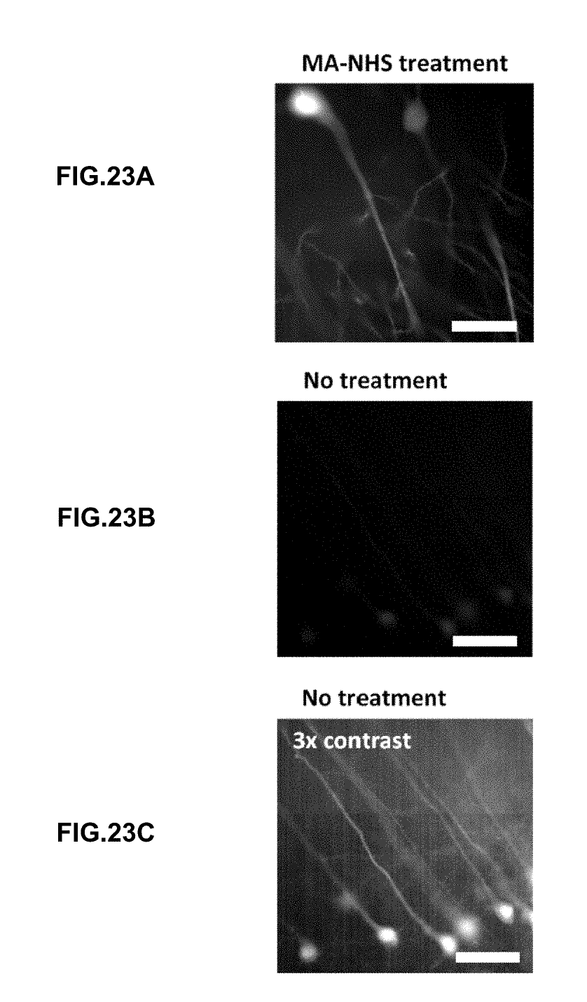

THY1-YFP-H brain slices were immunostained for YFP-expressing neurons and the pre- and postsynaptic markers Bassoon and Homer using conventional secondary antibodies (FIG. 3A-F) and treated with MA-NETS before gelation, digestion, and expansion. Presynaptic and postsynaptic densities were well-resolved and junctions between synapses and dendritic spines were clearly observable (FIG. 3A-F and FIG. 21). Over length scales of up to 30 μm distortions generally below 0.2 μm were observed (see FIG. 22). By decreasing the digestion time for MA-treated mouse brain tissue to 1 hour (rather than 12-18 hours), intrinsic YFP fluorescence was preserved in expanded brain tissue and dendritic spines could be observed on a neurite even using a rudimentary epifluorescence microscope equipped with a 20×0.45 NA air objective lens (see FIG. 3I-J). Omission of MA-NHS treatment results in very weak intrinsic YFP fluorescence levels (see FIG. 23).

Overall, MA-NHS is preferred for treatment for brain tissue due to its lower background signal and GA treatment for cultured cells due to its generality with both immunolabeled specimens and fluorescent proteins. Table 1 summarizes stain procedures and imaging conditions used in this disclosure.

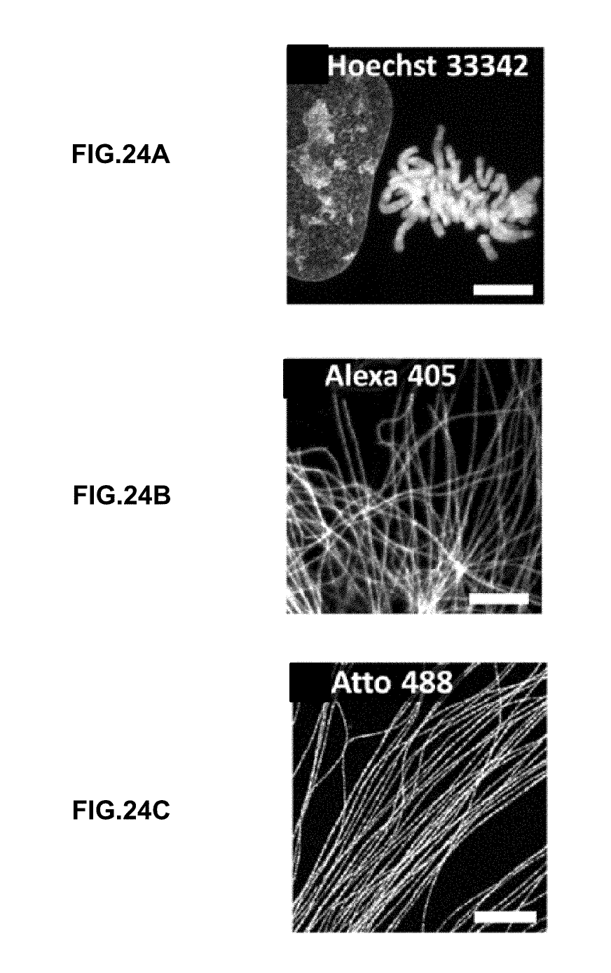

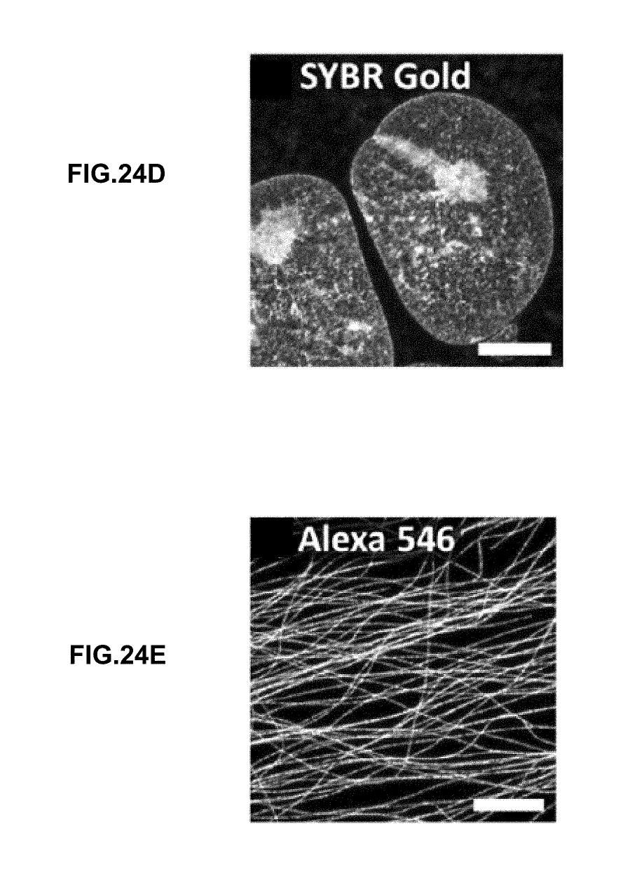

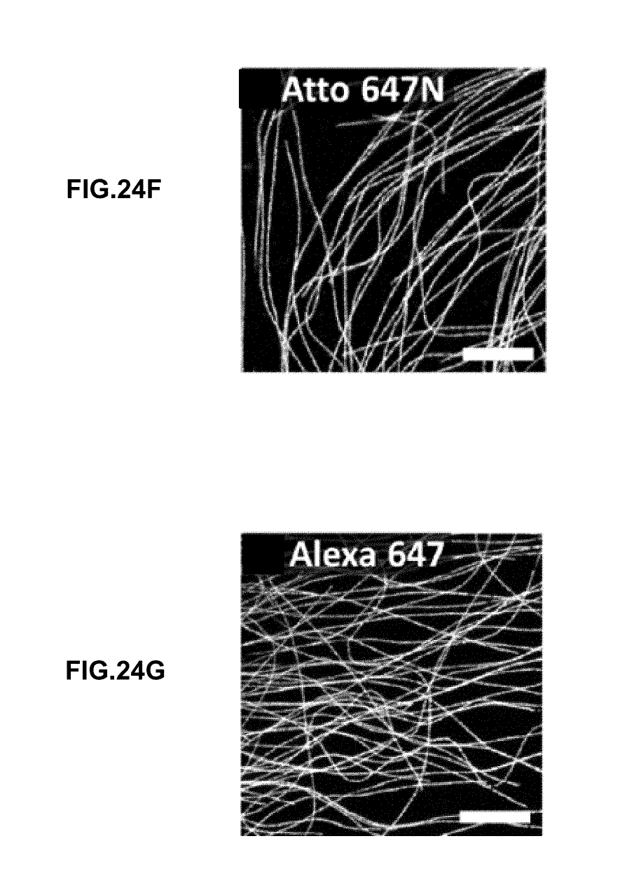

Not all organic fluorophores survive the polymerization step (e.g., several cyanine fluorophores do not survive); however the following non-limiting examples appear to survive polymerization: Alexa Fluor 488, TAMRA or Atto 565, Atto 647N, Alexa Fluor 405, Atto 488, Alexa Fluor 532, Alexa Fluor 546, Alexa Fluor 568, GFP, YFP, DsRed, Hoechst 33342, and SYBR Gold (FIG. 2 and FIG. 24). Additionally, fluorophores may be introduced post-digestion to avoid quenching or bleaching by the polymerization reaction, such as by incubating the gel with labeled streptavidin for a specimen that has been labeled with a biotin-labeled secondary antibody, or through incubation with DNA-binding fluorophores such as TO-PRO-3, for example. (see FIG. 2E-J and FIG. 24).

The methods presented here demonstrate and characterize new polymer-linking methods for expansion microscopy which enable the use of conventional fluorophore-labeled antibodies and FPs and should help to rapidly disseminate the ExM to a large and growing community of researchers applying super-resolution techniques to a wide range of biological questions. The methods improve the brightness of immunostained specimens compared to DNA-conjugated antibodies while making use of conventional secondary antibodies that are in many cases already available in research laboratories. Immunostaining of FPs may be preferred due to its enhancement of signal brightness. However, the use of intrinsic FP signals with ExM creates flexibility in multi-channel situations when compatible antibody species may not be available or when FPs are separable spectrally, but not antigenically (e.g., CFP-YFP). The use of intrinsic FP signals may also provide advantages when antibody penetration into thick samples is limited.

Reagents and Reagent Preparation.

Unconjugated secondary antibodies were purchased from Jackson Immunoresearch (West Grove, Pa., USA) including donkey anti-rat (712-005-151), donkey anti-rabbit (711-005-152), donkey anti-mouse (715-005-151), and donkey anti-chicken (703-005-155). An Alexa Fluor 488 conjugated donkey anti-rat antibody (712-545-150) was purchased from Jackson Immunoresearch. Primary antibodies are listed as follows: Rat anti-alpha tubulin (MA1-80017, Thermo Fisher Scientific, Waltham, Mass., USA), Rabbit anti-detyrosinated tubulin (ab48389, Abcam, Cambridge, Mass., USA), Mouse anti-HEC1 (ab3613, Abcam), Rabbit anti-TOM20 (sc-11415, Santa Cruz Biotechnology, Santa Cruz, Calif., USA), Rabbit anti-GFP (A31857, Life Technologies, Carlsbad, Calif., USA), Chicken anti-GFP (A10262, Thermo Fisher Scientific), Rabbit anti-Homer1 (160003, Synaptic Systems, Goettingen, Germany), Mouse anti-Bassoon (ab82958, Abcam). Bovine serum albumin (BSA) was purchased from Santa Cruz Biotechnology. NHS-functionalized (amine-reactive) dyes and biotin were obtained from Sigma-Aldrich, (Atto 488, Atto 565, Atto 647N, St. Louis, Mo., USA) or Thermo Fisher Scientific (Alexa Fluor 405, Alexa Fluor 488, Alexa Fluor 532, Alexa Fluor 546, Alexa Fluor 647, EZ-link NHS-PEG-4-Biotin). Dyes were obtained in 1 mg aliquots from the suppliers, dissolved at a concentration of ˜100 mg mL⁻¹ in anhydrous DMSO, sub-aliquoted into anhydrous DMSO at 1 and 10 mg mL⁻¹, and stored at −20° C. NAP-5 size-exclusion chromatography columns were obtained from GE Healthcare (Little Chalfont, Buckinghamshire, United Kingdom) and were reused ten or more times by washing with 5 mL aqueous 1 M sodium hydroxide between uses and storage at 4° C. in phosphate-buffered saline (PBS) containing 2 mM sodium azide for up to several months. Methacrylic acid N-hydroxy succinimidyl ester (MA-NHS), anhydrous dimethyl sulfoxide (DMSO), sodium bicarbonate, PIPES salt (for buffer), ethylene diamine tetraacetic acid (EDTA), magnesium chloride, Triton X-100, and sodium borohydride were obtained from Sigma-Aldrich. MA-NETS was dissolved in anhydrous DMSO at a concentration of 1 M and stored at −20° C. until used. Paraformaldehyde (32%) and glutaraldehyde (50%) were obtained from Electron Microscopy Sciences (Hatfield, Pa., USA). All DNA was purchased from Integrated DNA Technologies (Coralville, Iowa, USA). DNA stains including Hoescht 33342 (NucBlue Live), SYBR Gold, and TO-PRO-3 were purchased from Life Technologies. Tetramethylethylenediamine (TEMED, 17919) and ammonium persulfate (APS, 17874) were purchased from Thermo Fisher Scientific. 4-hydroxy-TEMPO (97%, 176141), and sodium acrylate (97%, 408220) were purchased from Sigma-Aldrich. 40% acrylamide (1610140) and 2% bis bis-acrylamide (1410142) solutions were purchased from Bio-Rad Laboratories (Hercules, Calif., USA).

Preparation of Fluorophore-Labeled Antibodies and Streptavidin.

Fluorophore-conjugated antibodies or streptavidin were prepared as follows. To 40 μL of unconjugated protein (˜1.3 mg mL⁻¹ IgG, or 1 mg mL⁻¹ streptavidin) was added 5 μL of aqueous 1 M sodium bicarbonate (pH ˜8.3) and 1 μL of NETS-dye stock in DMSO. These reagents were allowed to react at room temperature (22° C.) for ˜30 minutes. During the reaction, a NAP-5 size-exclusion chromatography column, for purification of labeled antibody from free dye, was equilibrated by flowing ˜10 mL of PBS through each column. The ˜50 μL reaction was loaded onto the column followed by flowing through and discarding 650 μL of PBS and flowing through and keeping 300 μL eluate. The eluate was characterized by absorption spectroscopy by measuring the average concentration of dye and average concentration of antibody according to the instructions provided by the dye manufacturers. Care was taken to avoid adding more than ˜5% DMSO to the antibody solution to avoid disturbing the antibody in all antibody-labeling reactions. The obtained dye to protein ratios are listed in Table 1. The DNA-antibody conjugate was prepared using 5′ amine modified DNA (5′-TAC GCC CTA AGA ATC CGA ACT TTA CGC CCT AAG AAT CCG AAC-3′; SEQ ID NO:01) according to the protocol described previously (see Chen et al., “Expansion microscopy.” Science 347:543-48 (2015)). The tri-functional linker was prepared from 5′ acrydite and 3′ amine modified DNA (5′-GTT CGG ATT CTT AGG GCG TA-3′; SEQ ID NO:02), reacted with a tenfold molar excess of Atto 488 NHS for 1 hour at pH 8.3, and purified by cold ethanol precipitation.

Fluorescence Microscopes.

Confocal microscopy was performed on a Leica SP5 inverted confocal scanning microscope at the UW Biology Imaging Core (FIG. 2, FIG. 5-11, and FIG. 24) using a 63×1.2 NA water lens (Leica, Nussloch, Germany), or an Olympus upright FV1000 (FIG. 3, FIG. 21, and FIG. 22) with a 25×1.0 NA SCALE objective. Conventional widefield epifluorescence imaging was performed on an inverted Nikon Ti-S microscope configured with a 10×0.25 NA air objective lens (Nikon, Melville, N.Y., USA), 20×0.45 NA air objective lens (Nikon), or a 60×1.2 NA water-immersion objective lens (Nikon). The widefield microscope was illuminated using a four-channel light emitting diode source (LED4D120, Thorlabs, Newton, N.J., USA) using a multiband filter set (LF405/488/532/635-A-000, Semrock, Rochester, N.Y., USA) and images were captured with a Zyla 5.5 sCMOS camera (Andor, Windsor, Conn., USA) (FIG. 4, FIG. 12-20, and FIG. 23). Localization microscopy (FIG. 8) was performed on a homebuilt Nikon Ti-U system configured for total internal reflection fluorescence using a Nikon CFI Plan Apo Lambda 100×1.45 NA objective and a 647-nm diode-pumped solid-state laser source (MPB Communications, Pointe-Claire, QC, Canada). A 405-nm solid state laser (Obis, Coherent) was used for activation to increase the rate of fluorophore blinking. Localization images were acquired on an EMCCD (iXon Ultra 897, Andor) operating at 200 frames per second. A custom-built focus lock using an objective nanopositioner (Nano F-100S, Mad City Labs, Madison, Wis., USA) and a 940-nm diode laser (LP-940, Thorlabs) was used to control axial drift.

Cell culture. BS-C-1 and Ptk1 cells were obtained from ATCC and both tested negative for mycoplasma using 4′,6-diamidino-2-phenylindole dihydrochloride. Cell lines obtained from ATCC were used without additional authentication. BS-C-1 cells were cultured in EMEM (ATCC, 30-2003, Manassas, Va., USA) containing penicillin and streptomycin (PS, 15140-122, Life Tech.), 10% FBS (FB22-500, Serum Source International, Charlotte, N.C., USA), and non-essential amino acids (NEAA, 11140-050, Life Tech.). PtK1 cells were cultured in RPMI (11875-093, Life Tech.) containing PS, 10% FBS and NEAA. Cells were maintained at 37° C. environment with 5% CO₂.

Immunostaining of Cultured Cells.

See also Table 1 for a summary and detailed list of concentrations and reagents for the preparation of all imaged specimens.

Immunostaining of BS-C-1 cells was conducted as follows. Cells were seeded at a density of ˜50,000 cells per well of a 24-well plate containing a 12 mm #1.5 coverglass and incubated overnight. Cells were optionally extracted for 30 s with PEM (0.1 M PIPES pH 7, 1 mM EDTA, 1 mM MgCl₂) containing 0.5% Triton-X-100 immediately prior to fixation. The extraction step is important for high-quality stains of cytoskeletal structures, but was not used on stains of organelle structures where treatment with detergent would likely destroy the structure (see Supplementary Table 1). Specimens were fixed for 10 minutes in a solution containing 3.2% paraformaldehyde and 0.1% glutaraldehyde in PEM (for microtubules) or PBS (for organelles), followed by brief washing in PBS and reduction in an aqueous solution of 10 mM sodium borohydride for 5 minutes. After reduction, samples were washed three times with PBS and then incubated with blocking/permeabilization buffer (PBS with 3% BSA and 0.5% Triton X-100) for 30 minutes. Specimens were then incubated with primary antibodies in blocking/permeabilization buffer for 45 minutes, washed three times with PBS, and incubated for 45 minutes with secondary antibodies in blocking/permeabilization buffer. After three more washes with PBS, cells were treated with either GA or MA-NETS to produce a crosslinked sample. GA-treatment consisted of a 10 minute, room-temperature incubation with 0.25% GA in PBS followed by washing three times with PBS. MA-NETS-treatment consisted of a 60 minute, room-temperature incubation with 25 mM MA-NETS in PBS followed by washing three times with PBS. For correlative pre-expansion localization microscopy and post-expansion widefield imaging of fixed BS-C-1 cells in FIG. 8, a tertiary antibody immunostain was performed including steps for: primary rat anti-tubulin, secondary Alexa Fluor 647 mouse anti-rat, tertiary Atto 488 donkey anti-mouse antibody and finally GA treatment.

Immunostaining of PtK1 cells was conducted using a variation of the above protocol for BS-C-1 cells, but with the following differences. Cells were incubated with rat anti-tubulin and mouse anti-HEC1 primary antibodies overnight at 4° C. After washing, cells were incubated at room temperature for 45 minutes with secondary antibodies consisting of donkey anti-rat secondary antibody labeled with Atto 488 and a donkey anti-mouse secondary antibody that was dually labeled Alexa Fluor 546 and biotin. After secondary labeling, samples were treated with GA as described above for BS-C-1 cells. Prior to post-ExM imaging, the expanded samples were incubated with 2 μg mL⁻¹ Alexa Fluor 546 labeled streptavidin in PBS containing 3% BSA for one hour. After contracting during this incubation, the gel was allowed to re-expand to full size in DI water. Additionally, immediately prior to pre- and post-ExM imaging, cells were incubated with 1 μM TO-PRO-3 in water for 15 minutes.

Transfection of Cultured Cells.

BS-C-1 cells were dissociated and concentrated to ˜10⁶ cells mL⁻¹ by centrifugation at 90 g for 10 min and resuspended in Solution SF (Lonza, Basel, Switzerland). A 100 μL volume of cells was mixed with 5 μg of plasmid: pAcGFP1-Mito (Clontech, Mountain View, Calif., USA) in FIG. 12 and FIG. 19, or pAc-GFPC1-Sec61β (a gift from Tom Rapoport (Harvard Medical School), Addgene plasmid#15108) in FIG. 12 and FIG. 18, or Sec61Bβ and pDsRed2-Mito (BD Biosciences, Franklin Lakes, N.J., USA) in FIG. 2. The cells were then electroporated in an electrode cuvette with pulse code X-001 in a Lonza Amaxa nucleofector, immediately resuspended in warm media, and plated in a 24-well plate as described above. After 24-48 hours, the cells were fixed with paraformaldehyde and glutaraldehyde (FIG. 18 and FIG. 19A, or paraformaldehyde only in FIG. 19B-E), or fixed and immunostained for outer mitochondrial membrane (FIG. 2) or with anti-GFP (FIG. 12) as described above.

Mouse Brain Tissue Dissection and Preparation.

All animal experiments were carried out in accordance with the Institutional Animal Care and Use Committee at the University of Washington. Mice (strain C57BL/6) were anesthetized with isoflurane and perfused transcardially with PBS, followed by paraformaldehyde (PFA, 4% wt/vol in PBS). Brains were dissected out, postfixed in 4% PFA in PBS at 4° C. for one hour and washed in PBS. Then, the brains were sliced to 100 μm thickness using a vibratome. All mice used in this work were between the ages of 1 and 4 months at the time of dissection. Both male and female mice were used.

Immunostaining of Tissue Slices.

100 μm thick mouse brain slices were first incubated in blocking/permeabilization buffer (3% BSA and 0.1% Triton X-100 in PBS) for 6-12 h at 4° C. The tissue was then incubated in primary antibody diluted into blocking/permeabilization buffer for at least 24 h at 4° C. and was then washed three times in blocking/permeabilization buffer (20 min each). Tissues were then incubated with secondary antibody diluted into blocking/permeabilization buffer for 24 h at 4° C. and afterwards were washed three times with PBS (20 min each). Following immunostaining, the brain slices were then either treated with 0.1% GA in PBS or 1 mM MA-NETS in PBS for 1 h at room temperature followed by three washes with PBS to produce a crosslinked sample. Tissue slices that were not immunostained (samples with fluorescent protein signal preserved) were simply treated with GA or MA-NETS. See also Table 1 for a summary and detailed list of concentrations and reagents for the preparation of all imaged specimens.

Gelation, Digestion, and Expansion of Cultured Cell Specimens.

Fixed cell samples on 12 mm round coverglass were incubated in monomer solution (1×PBS, 2 M NaCl, 2.5% (wt/wt) acrylamide, 0.15% (wt/wt) N,N′-methylenebisacrylamide, 8.625% (wt/wt) sodium acrylate) for ˜1 minute at room temperature prior to gelation. Concentrated stocks of ammonium persulfate (APS) and tetramethylethylenediamine (TEMED) at 10% (wt/wt) in water were diluted in monomer solution to concentrations of 0.2% (wt/wt) for gelation, with the initiator (APS) added last. The gelation solution (˜70 μl) was placed in a 1 mm deep, 1 cm diameter Teflon well and the coverglass was placed on top of the solution with cells face down. Gelation was allowed to proceed at room temperature for 30 min. The coverglass and gel were removed with tweezers and placed in digestion buffer (1×TAE buffer, 0.5% Triton X-100, 0.8 M guanidine HCl) containing 8 units mL⁻¹ Proteinase K (E00491, Thermo or P8107S, New England BioLabs, Ipswich, Mass., USA) added freshly. Unless otherwise indicated, gels were digested at 37° C. for various amounts of time as follows: MA-treated cells were digested overnight, GA-treated cells were digested for 30 min to 1 h, and fluorescent protein samples were digested for 30 min maximum. The gels (sometimes still attached to the coverglass) were removed from digestion buffer and placed in ˜50 mL DI water to expand. Water was exchanged every 30 minutes until expansion was complete (typically 3-4 exchanges).

Post Expansion Labeling of Expanded Cultured Cell Specimens with Streptavidin.

Expanded cultured cell specimens initially immunostained with biotin-modified antibodies were submerged in a streptavidin solution (2 μg mL⁻¹) in PBS containing 3% BSA for 45 min. The contracted gels were then washed and re-expanded in DI water.

Gelation, Digestion, and Expansion of Mouse Tissue Specimens.

Tissue samples were incubated in monomer solution at 4° C. for 45 min prior to gelation. Tissue was gelled with the same solution as cells but with the addition of 4-hydroxy-2,2,6,6-tetramethylpiperidin-1-oxyl (4-hydroxy-TEMPO) at a concentration of 0.01% (wt/wt) from a 1% (wt/wt) stock as an inhibitor to allow complete diffusion of the monomers throughout the tissue. The glass slide with the sample and a #1.5 coverglass on top separated by spacers (one #1 coverglass) on either side of the tissue was used as a gelation chamber. The samples were allowed to gel for 2-2.5 hours at 37° C. Excess gel around the samples was removed, the glass around the samples was cut to leave the tissue on a small glass square, and the samples were placed in digestion buffer with 8 units mL⁻¹ and were allowed to digest at 37° C. for various amounts of time: stained samples were digested overnight and fluorescent protein samples were digested for 1 hour. The gels were removed from the digestion solution (using the glass square to support the gel) and placed in DI water to expand. Gradually increasing the amount of water helped prevent the gels from folding.

Expanded Specimen Handling.

Expanded gels were cut to fit on coverglass (2-4 cm edge-length rectangles) excess water was removed and then gently placed on coverglass substrates for imaging. When possible, gels were immobilized using a small amount of cyanoacrylate glue on the periphery after wicking away excess water from the edges.

Correlative Localization Microscopy and ExM.

Pre-expansion localization microscopy images of Alexa Fluor 647 labeled microtubules were acquired at 200 Hz for ˜80,000 frames at ˜2 kW cm⁻² in an oxygen scavenging switching buffer (100 mM Tris pH 8, 10% glucose (wt/wt), 0.5 mg mL⁻¹ glucose oxidase, 40 μg mL⁻¹ catalase, and 143 mM 2-mercaptoethanol). After localization microscopy, samples were washed to remove the switching buffer, gelled, digested, and expanded as described above. During gelation, the Alexa Fluor 647 signal was destroyed, however the Atto 488 from the tertiary antibody remained fluorescent for widefield epifluorescence imaging.

Image Processing.

Expanded cell culture confocal z-stacks were aligned frame by frame using an automated rigid registration routine in Mathematica in order to correct for minor lateral drift during acquisition. Mitotic spindle confocal z-stacks of PtK1 cells were processed to remove peripheral non-specific adsorption of the HEC1 antibody as follows: A binary 3D mask of the kinetochore attachments was generated by binarizing the kinetochore channel and retaining connected-component features larger than 100 voxels and within 1 μm of the outer surface of the chromosomes. The kinetochore binary mask was then dilated by three pixels and multiplied by the original channel data. The processing was performed to clarify the maximum intensity projections in FIG. 2, but had little effect on the individual z-sections as shown in detail in FIG. 10. Localization microscopy images were analyzed as described previously (Dempsey et al., Nat. Methods 8:1027-36 (2011)). Registration of pre- and post-expansion correlative images were carried out in the open-source software Elastix, using rigid (similarity) and non-rigid (B-spline) transformations to determine the expansion factor and quantify distortions. Details, including example data and processing scripts, are included in the Supplemental Protocol.

Reproducibility.

All experiments were carried out ≧3 times including all sample preparation and analysis, except as noted below. Representative data for each experiment are shown. Experiments for FIG. 8, FIG. 13-15 and FIG. 19 were performed only once.

Materials and Methods

Expansion microscopy is a highly attractive imaging modality owing to its compatibility with conventional microscopes and conventional probes, its robust multicolor and 3D capabilities, and its optical clearing properties for thick tissues. While the method is limited to fixed specimens whose mechanical properties do not prevent expansion, the currently achieved ˜65 nm resolution is sufficient to answer a wide range of biological questions and is likely to improve with further development.

Supplementary Protocol 1. Detailed protocol for magnification calculation and distortion analysis. In this work, an open-source software Elastix was used for analysis of correlated pre- and post-expansion images in order to calculate the physical magnification (referred to as the expansion factor in the main text) and to perform analysis of expansion-related distortions. The output from Elastix was further processed using custom-written Mathematica scripts. In this supplementary protocol, detailed instructions on how to perform these analyses for a computer based on a Microsoft Windows operating system are provided. This protocol also makes use of the widely used open-source Image)-based software package Fiji.

This supplementary protocol is accompanied by the file “SupplementaryAnalysis.zip”. The .zip file contains three subfolders: “original_data” contains original confocal data files for corresponding pre-expansion and post-expansion images; “similarity_example” contains input files for rigid registration analysis using Elastix; “spline_example” contains input files for distortion analysis with Elastix that are derived from the output of the similarity analysis. The spline_example folder also contains a Mathematica script file (.nb) for processing of the Elastix B-spline output file for distortion analysis.

Elastix Installation

The open-source software Elastix was used for rigid (similarity) and nonrigid (B-spline) registration of correlated pre- and post-expansion images. Elastix may be downloaded from the program's website at hypertext transfer protocol //elastix.isi.uu.nl. Once installed, add the installed Elastix directory to the system's PATH variable. Elastix is controlled through the Command Prompt, and the following font and gray background will be used to denote command line inputs: command line inputs. To check whether the installation was successful, open a Command Prompt and enter elastix-help to see the version and command options (an error is returned if the installation was unsuccessful or if Elastix directory has not been added to the PATH variable). For more detailed information on installation, information about image registration, and all further procedures, consult the Elastix manual found on the homepage. The Elastix parameter database also has helpful example parameter files for analysis (see Hypertext Transfer Protocol //elastix.bigr.nl/wiki/index.php/Parameter_file_database).

Image Data Formatting Preparation

Elastix is based on the Image Registration and Segmentation Toolkit (ITK), and therefore all input/output image files must be compatible with ITK, such as .mhd or .mha files that store image data in uncompressed binary format. It is convenient to use other imaging applications such as Fiji (see Hypertext Transfer Protocol //fiji.sc/Fiji) to create or view these binary image files. To create binary image files for our sample pre-expansion data located in the original_data folder, perform the following steps: 1) Load the example pre-expansion data file “Pre_ExM.tif” (a 128×128 pixel 16 bit TIFF) into Fiji; 2) Use bicubic interpolation to resample the image with 4× smaller pixels (Image→Scale . . . →X Scale=4, Y Scale=4), resulting in a 512×512 image, so that the pre-expansion data will have approximately the same scale as the post-expansion data; 3) Save the image as a binary file by selecting (File→Save As . . . →Raw Data . . . ), and name it “fixed.raw”; 4) Manually create a “.mhd” metadata file (MetaImage medical data) that contains the information shown below. The binary image file and metadata files generated according to this procedure are included in the similarity_example folder as “fixed.raw” and “fixed.mdh”, respectively.

ObjectType=Image

NDims=2

BinaryData=True

BinaryDataByteOrderMSB=True

ElementSpacing=1 1

DimSize=512 512

ElementType=MET_USHORT

ElementDataFile=fixed.raw

Follow a similar procedure to create a binary image file and metadata file for the example post-expansion image “Post_ExM.tif” (a 512×512 pixel 16 bit TIFF), but omitting the bicubic interpolation step. These binary image and metadata files are included in the similarity_example folder as “moving.raw” and “moving.mdh”, respectively.

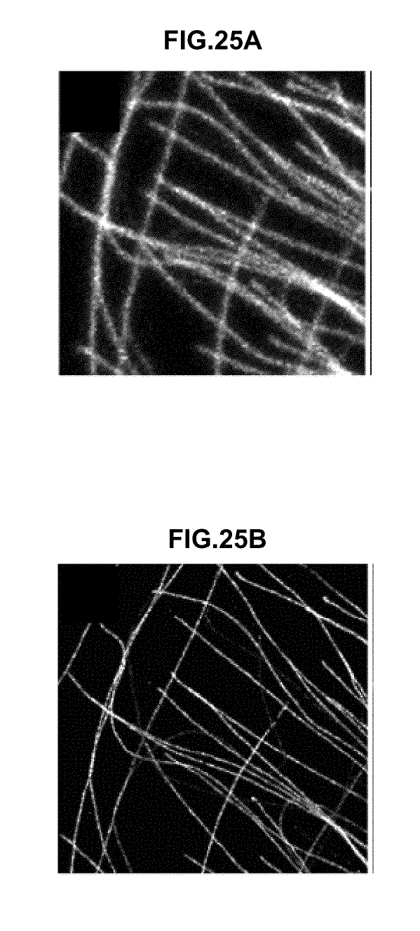

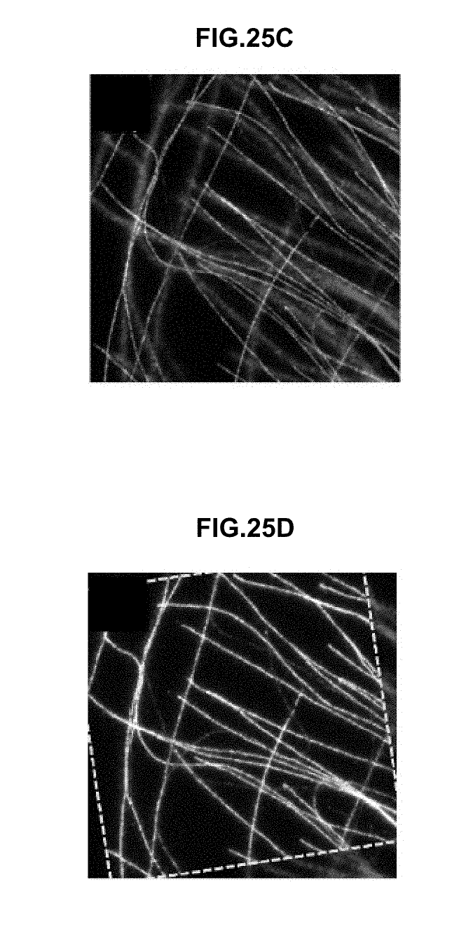

Troubleshooting note regarding file formats: Depending on the software and/or computer preferences for byte order (i.e., “endianness”), the .mdh metadata parameter BinaryDataByteOrderMSB may need to be changed to either True or False in order to be loaded properly by Elastix. In ImageJ and Fiji, “Raw Data . . . ” export should default to big-endian byte order and the BinaryDataByteOrderMSB option should be set to True in the .mhd file. Validate the byte ordering is correct by loading the “.mhd” file into Fiji; when correctly formatted, the original images should appear normally as shown in Appendix FIGS. 1a and b (i.e., not scrambled). The initial overlay should be roughly the same region and scaling as in FIG. 25).

General Elastix Usage: Similarity Transform

Elastix compares two input images, denoted the fixed image and the moving image, and will attempt to rigidly or nonrigidly transform the moving image so that it matches the fixed image file. Example files are provided in the similarity_example and spline_example folders. The example files in each folder include a fixed image, a moving image, the corresponding .mhd metadata files, and an Elastix parameter files.

In this example, we will use the parameter file “Parameters_Similarity.txt” provided in the example files. To run Elastix, open a Command Prompt inside the “similarity_example” folder by pressing together Shift+Right Click, selecting “Open command window here”, and entering:

elastix-f fixed.mhd-m moving.mhd-p Parameters_Similarity.txt-out.

The -f and -m indicate the fixed and moving image “.mhd” input files, the -p indicates the parameters input file, and -out indicates where the output files will be written. The period (.) after -out is shorthand for the current directory of the command prompt, however any valid path will work. In general, use file names that do not contain spaces (underscores are acceptable), or alternatively enclose names or full file paths with quotation marks. After Elastix finishes running, an output binary image file “result.0” and its corresponding “result.0.mhd” file should be generated. Check the output image by dragging the “result.0.mhd” file into Fiji. Overlay the fixed and result.0 images to display the registration result, as displayed in Appendix FIG. 1d. Note that signedness of the output (MET_SHORT) is different from the input (MET_USHORT) and is specified in corresponding .mhd files; however the output will be displayed correctly when opened with FIJI.

Troubleshooting Notes Regarding Elastix Command Line Usage.

If Elastix does not run, observe the error output in the command window, or look for the “elastix.txt” output file, which should also contain the error. Common errors include incorrect input of file names into the command line, file names containing spaces, or an incorrect “ElementDataFile” name referencing the binary data in the .mhd file. Additionally, be wary of extra file extensions that may become appended (particularly in Windows), but appear hidden on the .raw and .mhd files, which will cause Elastix to respond with an error.

Expansion Factor Determination with Elastix

The similarity transformation (used in the previous example) attempts to match the moving image to the fixed image using only rotation, translation and isotropic scaling; and can therefore be used to calculate the isotropic expansion factor. In the previous example, the pre-expansion image was interpolated by a factor of 4; this factor was the estimated expansion factor determined macroscopically with a ruler (by measuring the size of the gel in millimeters before and after expansion). All ExM samples in this work had expansion factors ranging from 4.0-4.3, so a flat factor of 4 is a good initial guess for the similarity transform. Even this type of rough macroscopic measurement can yield results accurate to within 5-10% of the true expansion factor. Note, if the images were acquired with different pixel sizes (such as on a confocal microscope with adjustable magnification), it is convenient to first interpolate one of the images to match the smaller pixel size of the two; this is unnecessary if images were acquired with the same pixel size, such as on a CCD/CMOS array using the same objective lens. After successfully performing the similarity transform and ensuring proper registration of the two images, as in FIG. 25, look for the output text file named “TransformParameters.0.txt” which contains the following parameters of the similarity transform at the top of the document:

(Transform “SimilarityTransform”)

(NumberOfParameters 4)

(TransformParameters 1.029177 0.163145 13.092766 17.873457)

(InitialTransformParametersFileName “NoInitialTransform”)

(HowToCombineTransforms “Compose”)

The key numbers are the TransformParameters, which represent the image scaling factor, rotation, translation in X, and translation in Y, respectively. The transformation is applied to the moving image (post-expansion image) and since the pre-expansion image was previously interpolated by the estimated factor of 4, this factor is multiplied by the scaling factor to get the true expansion factor: 4×1.03=4.12.

Troubleshooting Similarity Transform.

If the similarity transformation does not return acceptable registration, it is useful to first try and select corresponding areas of the input pre-expansion and post-expansion images to be as close as possible by eye before running Elastix. This includes scaling by the estimated expansion factor (as described previously), as well matching the image orientations by rotating one of the images (In Fiji, Image→Transform→Rotate . . . ). Additionally it is possible to tune the input parameter file “Parameters_Similarity.txt”. Some useful parameters to consider are the (NumberofResolutions 8) or (MaximumNumberOfIterations 1000). Elastix will begin initial registration at a reduced image resolutions and increasing to full resolution, (by default each resolution to run is decreased by factor of 2), unless otherwise specified in the parameters file, and the MaximumNumberOfIterations will allow for convergence during each resolution. These parameters are set initially at higher values for more robust registrion, however often times if the initial input images are similar, the number of resolutions and max iterations can be decreased to save computation time. Note that the similarity transform is a rigid transform, and only performs uniform scaling in X and Y, rotation and translation. If the scaling in X and Y are not uniform, which is typically not the case for ExM (unless for example, the gel is being stretched or imaging during pre- and post-expansion imaging was not performed on the same axis), it may be necessary to use an affine registration by changing the (Transform “Similarity”) to (Transform “AffineTransform”) in the parameters file.

Nonrigid B-Spline Registration with Elastix

The similarity transform is a rigid registration and attempts to make a global best match, but correct for local deviations from the fixed image, making it necessary to apply a nonrigid bspline registration. Essentially, the output of the similarity transform is plugged back into Elastix as the moving image, and a second registration using B-spline parameters is used to correct for nonrigid deformations that may be present between the pre-expansion and post-expansion, similarity transformed output image. The data for this example is in the “spline_example” folder, and should contain a fixed and moving binary data files and corresponding .mhd files, as well as a “Parameters_BSpline.txt” file. Although the files are already included, the “moving” and “moving.mhd” are simply copies of “result.0” and “result.0.mhd” from the “similarity_example” folder, and renamed accordingly (it is important to change the ElementDataFile name in the .mhd as well). The Command Prompt input to run this parameter set in the spline_example folder is:

elastix-f fixed.mhd-m moving.mhd-p Parameters_BSpline.txt-out.

The resulting image “result.0” should show only minor deformation when overlayed with the input “moving” image. Further processing to create the deformation vector field plot and measurement RMS error plot using the output B-spline transformation parameters is possible using another program included in the Elastix installation called Transformix.

Vector Fields and RMS Error Error Using Transformix Output

Transformix is a complementary program to Elastix that is used to apply a deformation to an image, or a list of XY coordinates. The deformation information is contained within the “TransformParameters.0.txt” files. Here, Transformix is used to apply a deformation to a set of input points (an example of using Transformix on an image file is provided later). Due to the more advanced formatting, parsing and plotting requirements of the input and output data with Transformix, an example Mathematica notebook “Vector and RMS plot.nb” is included to generate the deformation vector field plots, as well as measure the RMS error (as in FIG. 6). The script is commented to contain instructions.

Briefly described here, to create the vector plot, the deformation field is applied to an input array of points sampled at a set interval, in this case every 10 pixels. Transformix is used deform these input points, and the deformation vector at each point is then used to make a plot of the deformation field. The Command Prompt input to run Transformix on set of input points is:
transformix-def inputPoints.txt-out.-tp TransformParameters.0.txt

The input points should be formatted as follows (see “inputPoints.txt” file in the spline_example folder):

| Index | |
|---|---|
| Total # of points | |
| X1 | Y1 |
| X2 | Y2 |
| . . . | . . . |

To generate the measurement RMS error plots, a similar procedure to the vector plot is used, however the input points are the coordinates of a binary skeleton of the fixed image. In the script, the distance between a pair of points is calculated (m), as is the distance between the deformed coordinates (m′, see FIG. 6). The absolute value of the difference is the error. This is performed for all combinations of input coordinates in the image skeleton, and RMS error is calculated and plotted.

Gaussian Blurring of Post-ExM Images

For the sake of simplicity in the previous examples, the following steps on Gaussian blurring of the initial moving image were excluded from this protocol, but were carried out in analysis in the FIGS. 4-24. When comparing the pre-expansion and post-expansion example images (in these examples, microtubules), there is a disparity in the microtubule width between the two, due to the increase in resolution in post-expansion space. To ensure that this width disparity does not affect the similarity or Bspline registration process, we first apply a Gaussian blur to the post-expansion image in Fiji (Process→Filters→Gaussian Blur . . . →Radius=4) to make the microtubule widths roughly equivalent, then proceed with this blurred image as the moving image in similarity registration and subsequently, the blurred similarity output in the Bspline registration. Once the transformation parameters have been determined, the deformations can be applied to the original, unblurred image using Transformix. By using the following command:
transformix-in unblurred.mhd-out.-tp TransformParameters.0.txt

Where the unblurred.mhd file corresponds to the original unblurred moving image, and “TransformParameters.0.txt” correspond to the similarity transform parameters output in the “similarity_example” folder. The Transformix output will be called “result” and “result.mhd”; these images are then plugged back into Transformix using the Bspline output parameters in the “spline_example” folder likewise.

3D Registration in Elastix

Rigid and nonrigid registration is easily extended into three dimensions using the earlier procedures with minor changes. Beginning from an image stack (assume a 512×512×128 pixel image) in Fiji, save the data as “Raw Data . . . ” as done previously. The corresponding metadata .mhd must be modified to contain:
ObjectType=Image
NDims=3
BinaryData=True
BinaryDataByteOrderMSB=True
ElementSpacing=1 1 1
DimSize=512 512 128
ElementType=MET_SHORT
ElementDataFile=moving.raw

The important fields to update are the NDims=3, to denote three dimensional data, and DimSize with the appropriate image dimensions (in this case, the 128 refers to the number of z-planes). Again, it is helpful to check that the metadata file is correct by dragging it into Fiji and checking if the image opens correctly. Finally, change the Elastix parameter files (“Parameters_Similarity.txt” or “Parameters_Spline.txt”) FixedImageDimension and MovingImageDimension fields to read:
(FixedImageDimension 3)
(MovingImageDimension 3)

Once these changes to the metadata and parameters files are made, Elastix can be called from the command line in the familiar manner.

In general, due to the large amount of book-keeping involved for image, metadata and Elastix outputs files, it is recommended running Elastix using a user preferred scripting language to automate the process, such as Mathematica, MATLAB, Python, etc. Many of these tools are already in existence, refer to Additional Tools on the Elastix Wiki (see Hypertext Transfer Protocol //elastix.isi.uu.nl/wiki.php) or SimpleElastix (see Hypertext Transfer Protocol //simpleelastix.github.io). This protocol and basic command line usage is meant to serve as a primer for using Elastix with correlative expansion microscopy.

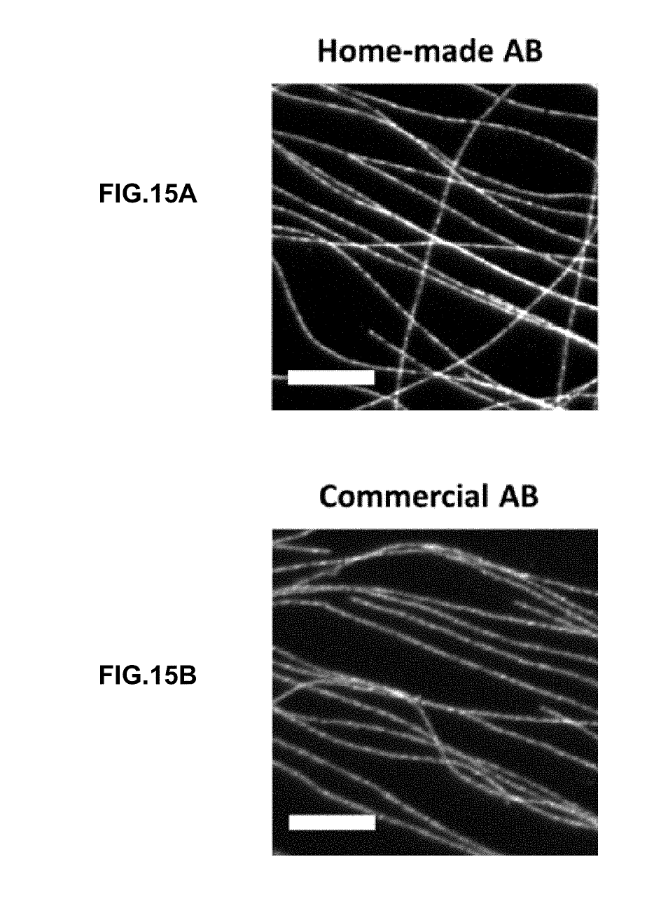

TABLE 1
Summary of sample preparation and imaging conditions

| | | | | 2° Ab, etc., & | |
|---|---|---|---|---|---|
| | | | | dyes/protein | |
| | | | 1° Ab | 1-2.5 μg/mL, except as | Polymer- |
| FIG. | Specimen | Fixation | all 1-2 μg/mL | indicated | linking |
| 2 a-c | BS-C-1 cell, | Extracted, | Rat × Tub & | D × Rat Atto 488 (~5.6 | 25 mM MA- |
| | wildtype | then | Rb × dTub | d/p) & | NHS, |
| | | PFA/GA | | D × Rb Alexa 546 (~12 | 60 min |
| | | | | d/p) | |
| 2 e-j, | PtK1 cell, | Extracted, | Rat × Tub & | D × Rat Atto 488 (~7.1 | 0.25% GA |
| FIG. 9, | wildtype | then | Ms × HEC1 | d/p) & | 10 min |
| 10, 11 | | PFA/GA | | D × Ms Alexa 546 (~5 | |
| | | | | d/p) + | |
| | | | | biotin | |
| 2 k-1 | BS-C-1 cell | PFA/GA, | Rb × TOM20 | D × Rb Atto 647 N | 0.25% GA |
| | expressing | 37° C. | | (~2.7 d/p) | 10 min |
| | Sec61β-GFP | | | | |
| | & mito- | | | | |
| | DsRed | | | | |
| FIG. 4 | BS-C-1 | Extracted, | Rat × Tub | D × Rb Atto 488 (9-12 | a) no |
| | cells, | then | | d/p) | treatment |
| | wildtype | PFA/GA | | | b)25 mM |
| | | | | | MA-NHS |
| | | | | | 60 min |
| | | | | | c) 0.25% GA |
| | | | | | 10 min |
| FIG. 5 | BS-C-1 | Extracted, | Rat × Tub | D × Rat Atto 488 (~5.6 | a) 0.25% GA |
| | cells, | then | | d/p) | 10 min |
| | wildtype | PFA/GA | | | c) 25 mM |
| | | | | | MA-NHS |
| | | | | | 60 min |
| FIG. 6 | BS-C-1 cell, | Extracted, | Rat × Tub | D × Rat Atto 488 (~5.6 | 25 mM MA- |
| | wildtype | then | | d/p) | NHS, |
| | | PFA/GA | | | 60 min |
| FIG. 7 | BS-C-1 cell, | Extracted, | Rat × Tub | D × Rat DNA | |
| | wildtype | then | | | |
| | | PFA/GA | | | |
| FIG. 8 | BS-C-1 cell, | Extracted, | Rat × Tub | Ms × Rat Alexa 647 | 0.25% GA |
| | wildtype | then | | (~5.3 d/p) | 10 min |
| | | PFA/GA | | 3° Ab D × Ms Atto 488 | |
| | | | | (~6 d/p) | |
| FIG. 12 | BS-C-1 | a-b) | a) Rat × Tub | a) D × Rat Atto 488 (4-6 | 0.25% GA |
| | cells: a-d) | extracted, | b) Ms × Vim | d/p) | 10 min |
| | wildtype; | fixed with | c) Rb × | b) D × Ms Atto 488 (4-6 | |
| | expressing | PFA/GA | TOM20 | d/p) | |
| | e) mito-GFP | c-f) not | d) Rb × | c) D × Rb Atto 488 (4-6 | |
| | or | extracted, | PMP70 | d/p) | |
| | f) Sec61β- | fixed with | e, f) Rb × GFP | d) D × Rb Atto 488 (4-6 | |
| | GFP | PFA/GA | | d/p) | |
| | | | | e, f) D × Rb Atto 488 | |
| | | | | (4-6 d/p) | |
| FIG. 13 | BS-C-1 | Extracted, | Rat × Tub | a-b) D × Rat Atto 488 | a) 0.25% GA |
| | cells, | then | | (~8 d/p) c) D × Rat | 10 min |
| | wildtype | PFA/GA | | DNA (2.25 μg/mL) + 1 μM | b)25 mM |
| | | | | acrydite-DNA-Atto | MA-NHS |
| | | | | 488 | 60 min |
| | | | | | c) no post- |
| | | | | | stain linking |
| FIG. 14 | BS-C-1 | Not | Rb × TOM20 | D × Rb Atto 488 (~8 | Either 0.25% |
| | cells, | extracted, | for antibody | d/p) | GA 10 min, |
| | wildtype and | fixed with | measurements | D × Rb DNA (2.25 μg/mL) + | 25 mM MA- |
| | expressing | PFA/GA | | 1 μM | NHS 60 min, |
| | mito-GFP | | | acrydite-DNA-Atto 488 | or no post- |
| | | | | | stain linking |
| | | | | | (DNA) |
| FIG. 15 | BS-C-1 | Extracted, | Rat × Tub | a) D × Rat Atto 488 (~8 | 0.25% GA |
| | cells, | then | | d/p) | 10 min |
| | wildtype | PFA/GA | | b) D × Rat Alexa 488 | |
| | | | | (~8 d/p, commercial) | |
| FIG. 16 | BS-C-1 | Extracted, | Rat × Tub | D × Rat Atto 488 (~8 | 0.25% GA |
| | cells, | then | | d/p) | 10 min |
| | wildtype | PFA/GA | | | |
| FIG. 17 | BS-C-1 | Extracted, | Rat × Tub | D × Rat Atto 488 (~8 | 25 mM MA- |
| | cells, | then | | d/p) | NHS |
| | wildtype | PFA/GA | | | 60 min |
| FIG. 18 | BS-C-1 cells | PFA/GA, | — | — | Initial |
| | expressing | 37° C. | | | fixation |
| | Sec61β-GFP | | | | included |
| | | | | | 0.1% GA for |
| | | | | | 10 min |
| FIG. 19 | BS-C-1 cells | a) PFA/GA | — | — | Initial |
| | expressing | b, c) PFA | | | fixation |
| | mito-GFP | | | | included |
| | | | | | 0.1% GA for |
| | | | | | 10 min |
| 3 a-f | THY1-YFP- | Cardiac | Ch × GFP | a) D × Ch Atto 488 (~6 | 1 mM MA- |
| | H mouse | perfusion | Rb × Homer | d/p) | NHS |
| | brain, 100 μm | with PFA, | Ms × Bassoon | b) D × Rb Atto 647N | 60 min |
| | slice | then 1 h PFA | | (~2.7 d/p) | |
| | | after slicing | | c) D × Ms Atto 565 | |
| | | | | (~5.2 d/p) | |
| 3 i-j | THY1-YFP- | Cardiac | — | — | 1 mM MA- |
| | H mouse | perfusion | | | NHS |
| | brain, 100 μm | with PFA, | | | 60 min |
| | slice | then 1 h PFA | | | |
| | | after slicing | | | |
| FIG. 20 | THY1-YFP- | Cardiac | Rb × GFP | D × Rb Atto 488 (~9 | a) 1 mM |
| | H mouse | perfusion | | d/p) | MA-NHS |
| | | with PFA, | | | 60 min |
| | | then 1 h PFA | | | b) 0.1% GA |
| | | after slicing | | | 10 min |
| FIG. 21 | THY1-YFP- | Cardiac | Ch × GFP | a) D × Ch Atto 488 (~6 | 1 mM MA- |
| | H mouse | perfusion | Rb × Homer | d/p) | NHS |
| | | with PFA, | Ms × Bassoon | b) D × Rb Atto 647N | 60 min |
| | | then 1 h PFA | | (~2.7 d/p) | |
| | | after slicing | | c) D × Ms Atto 565 | |
| | | | | (~5.2 d/p) | |
| FIG. 22 | THY1-YFP- | Cardiac | Ch × GFP | a) D × Ch Atto 488 (~6 | 1 mM MA- |
| | H mouse | perfusion | Rb × Homer | d/p) | NHS |
| | | with PFA, | Ms × Bassoon | b) D × Rb Atto 647N | 60 min |
| | | then 1 h PFA | | (~2.7 d/p) | |
| | | after slicing | | c) D × Ms Atto 565 | |
| | | | | (~5.2 d/p) | |
| FIG. 23 | THY1-YFP- | Cardiac | — | — | a) 1 mM |
| | H mouse | perfusion | | | MA-NHS |
| | | with PFA, | | | 60 min |
| | | then 1 h PFA | | | b) No |
| | | after slicing | | | treatment |
| FIG. 24 | BS-C-1 | Extracted, | Rat × Tub for | a) Hoechst (2 | a-e) 0.25% |
| | cells, | then | tubulin stains | drops/mL) | GA |
| | wildtype | PFA/GA | only | b) D × Rat Alexa 405 | 10 min |
| | | | | (~3 d/p) | |
| | | | | c) D × Rat Atto 488 | |
| | | | | (~10 d/p) | |
| | | | | d) SYBR Gold (10x) | |
| | | | | e) D × Rat Alexa 546 | |
| | | | | (~10 d/p) | |
| | | | | f) D × Rat Atto 647N | |
| | | | | (~5.5 d/p) | |
| | | | | g) D × Rat Biotin | |

| | | Imaging |
|---|---|---|
| | Digestion time & | Image thicknesses in pre-expansion |
| FIG. | other notes | dimensions |
| 2 a-c | Overnight digestion | Confocal, 63 × 1.2NA water lens |
| | | Image thicknesses: a) 900/200 nm; b) 900 nm; |
| | | c) 225 nm |
| 2 e-j, | Overnight digestion; | Confocal, 63 × 1.2NA water lens. |
| FIG. 9, | post-expansion | Image thicknesses: 2e, f) 5.6 μm; 2g) 900 nm; |
| 10, 11 | incubation with | 2h) 420 nm; 9) ~800 nm; 10a) 5.6 μm; 10e-j) |
| | streptavidin Alexa | 225 nm; 11a) 5.6 μm; 11b) 130 nm. |
| | 546 (2 μg/mL, ~7 | |
| | d/p) and TO-PRO-3 | |
| | (1 μM) | |
| 2 k-1 | 30 min. digestion | Confocal, 63 × 1.2NA water lens. Detected |
| | | intrinsic GFP & YFP signal as well as signal |
| | | from Atto 647N stain. Image thicknesses: k) 1 μm; |
| | | l) 225 nm |
| FIG. 4 | Overnight digestion | Epifluorescence, 60 × 1.2NA water lens |
| FIG. 5 | Overnight digestion | Confocal, 63 × 1.2NA water lens. Image |
| | | thickness ~225 nm |
| FIG. 6 | Overnight digestion | Confocal, 63 × 1.2 NA water lens. Image |
| | | thickness ~225 nm |
| FIG. 7 | Overnight digestion | |
| FIG. 8 | Overnight digestion | Pre-expansion localization microscopy with |
| | | 100 × 1.45NA TIRF lens; post-expansion |
| | | imaging by epifluorescence with 60 × 1.2NA |
| | | water lens |
| FIG. 12 | Overnight digestion | Epifluorescence, 60 × 1.2NA water lens |
| FIG. 13 | Overnight digestion | Epifluorescence, 60 × 1.2NA water lens |
| FIG. 14 | Both GA: 30 min | Epifluorescence, 20 × 0.45 NA air lens. |
| | Antibody MA and | Detected antibody or intrinsic GFP signal as |
| | DNA: overnight | indicated. |
| FIG. 15 | Overnight digestion | Epifluorescence, 60 × 1.2NA water lens |
| FIG. 16 | a) No digestion, | Epifluorescence, 60 × 1.2NA water lens |
| | b) 30 min. digestion | |
| | c) 18 h digestion | |
| FIG. 17 | a) No digestion, | Epifluorescence, 60 × 1.2NA water lens |
| | b) 2 h digestion | |
| | c) 18 h digestion | |
| FIG. 18 | a) 30 min digestion | Epifluorescence, 60 × 1.2NA water lens. |
| | b, c) 18 h digestion | Detected intrinsic GFP signal. |
| FIG. 19 | 30 min digestion | Epifluorescence, 60 × 1.2NA water lens. |
| | | Detected intrinsic GFP signal. |
| 3 a-f | Digestion: overnight | Confocal, 25 × 1.0 NA water SCALE lens. |
| | | Image thicknesses: a) ~1.2 μm (single z- |
| | | plane); b) ~3.8 μm; c-d) ~1.2 μm (single z- |
| | | plane); e, f) 1.4 μm. |
| 3 i-j | 60 min digestion | Epifluorescence, 20 × 0.45NA air lens |
| FIG. 20 | Overnight digestion | Epifluorescence, 10 × 0.25 NA air lens |
| FIG. 21 | Digestion: overnight | Confocal, 25 × 1.0 NA water lens. Image |
| | | thicknesses: a) 0.8 μm; c) 1.6 μm; e) 1.8 μm; |
| | | g) 2 μm; i) 2.2 μm. |
| FIG. 22 | Digestion: overnight | Confocal, 25 × 1.0 NA water lens. |
| | | Image thicknesses: 13.2 μm |
| FIG. 23 | Digestion: overnight | Epifluorescence, 20 × 0.45 NA air lens. |
| | | Detected intrinsic YFP signal. |
| FIG. 24 | a-f) Overnight | Confocal, 63 × 1.2 NA water lens. |
| | digestion | Image thicknesses: tubulin, 225 nm; nuclei, 7 μm. |
| | g) 1 h digestion. | |
| | Post-expansion with | |
| | streptavidin Alexa | |
| | 647 (3 dyes/SA, 2 μg/mL) | |

PFA/GA = paraformaldehyde and glutaraldehyde
PFA = paraformaldehyde
GA = glutaraldehyde
MA-NHS = methacrylic acid N-hydroxy succinimidyl ester

### REFERENCES

CHEN et al., Expansion microscopy. Science 347, 543-548 (2015).
CHUNG et al., Structural and molecular interrogation of intact biological systems. Nature 497, 332-337 (2013).
DEMPSEY et al., Evaluation of fluorophores for optimal performance in localization-based super-resolution imaging. Nat. Methods 8, 1027-1036 (2011).
HELL, Far-field optical nanoscopy. Science 316, 1153 (2007).
HERN & HUBBELL, Incorporation of adhesion peptides into nonadhesive hydrogels useful for tissue resurfacing. J. Biomed. Mater. Res. 39, 266-276 (1998).
HUANG et al., Breaking the diffraction barrier: super-resolution imaging of cells. Cell 143, 1047-1058 (2010).
KIM & PARK, Swelling and mechanical properties of superporous hydrogels of poly(acrylamide-co-acrylic acid)/polyethylenimine interpenetrating polymer networks. Polymer 45, 189-196 (2004).
KLEIN et al., elastix: A Toolbox for Intensity-Based Medical Image Registration. IEEE Trans. Med. Imaging 29, 196-205 (2010).
LEE et al., Autofluorescence generation and elimination: a lesson from glutaraldehyde. Chem. Commun. 49, 3028 (2013).
MIGNEAULT et al., Glutaraldehyde: behavior in aqueous solution, reaction with proteins, and application to enzyme crosslinking. Biotechniques 37, 790-806 (2004).
OLIVIER et al., Resolution Doubling in 3D-STORM Imaging through Improved Buffers. PLoS ONE 8, e69004 (2013).
SCHINDELIN et al., Fiji: an open-source platform for biological-image analysis. Nat. Methods 9, 676-682 (2012).
VOELTZ et al., A Class of Membrane Proteins Shaping the Tubular Endoplasmic Reticulum. Cell 124, 573-586 (2006).
WESTON & AVRAMEAS, Proteins coupled to polyacrylamide beads using glutaraldehyde. Biochem. Biophys. Res. Commun. 45, 1574-1580 (1971).
YANG et al., Single-Cell Phenotyping within Transparent Intact Tissue through Whole-Body Clearing. Cell 158, 945-958 (2014).

1. A method for preparing an expanded sample for microscopy comprising:
(a) incubating a fixed cell sample or a fixed tissue sample comprising a detectably labeled moiety with a linking agent, for a time and under conditions to promote cross-linking by the linking agent of a target in the sample to the detectably labeled moiety, to produce a cross-linked sample;
(b) permeating the cross-linked sample with hydrophilic monomers to produce a permeated sample;
(c) polymerizing the monomers within the permeated sample to provide a water-swellable composition;
(d) incubating the water-swellable composition for a time and under conditions to promote the formation of linkages between the linking agent and the water-swellable composition, to produce an anchored sample;
(e) treating the anchored sample with a homogenizing agent for a time and under conditions to promote homogenization of the anchored sample, to produce a processed sample; and
(f) dialyzing the processed sample in water, thereby expanding the water-swellable composition in the processed sample to produce an expanded sample.

2. The method of claim 1, wherein the linking agent comprises a polymerizable group and a label-reactive group.

3. The method of claim 2, wherein the polymerizable group comprises a vinyl moiety.

4. The method of claim 2, wherein the polymerizable group comprising a moiety according to one of the formulas: 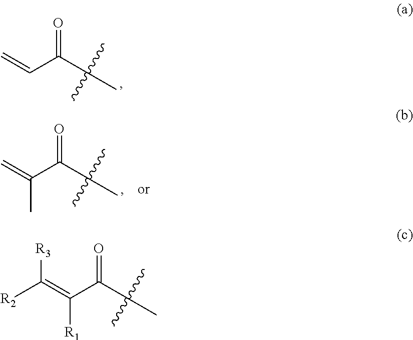
wherein R₁, R₂, and R₃ are each independently selected from H, alkyl, haloalkyl, halo, aryl, and heteroaryl.

5. The method of claim 2, wherein the label-reactive group is selected from the group consisting of an aldehyde, an N-hydroxysuccinimidyl ester, a maleimide, an epoxide, a thiosulfonate, an imidoester, a pentafluorophenyl ester, a haloacetyl, a thiosulfonate, a vinylsulfone, a pyridylsulfide, and a carbodiimide group.

6. The method of claim 1, wherein the linking agent is methacrylic acid N-hydroxy succinimidyl ester, acrylic acid N-hydroxy succinimidyl ester, or glutaraldehyde.

7. The method of claim 1, wherein the sample is incubated with the linking agent for 10 to 60 minutes at 10 to 25° C.

8. The method of claim 1, wherein the polymerization to the water-swellable composition occurs for 30 to 150 minutes at 10 to 25° C.

9. The method of claim 1, wherein the fixed cell sample or the fixed tissue sample is first contacted with a detectably labeled binding moiety for a time and under conditions to promote binding between the detectably labeled binding moiety and a target in the sample, to produce a labeled sample, wherein incubating the labeled sample with the linking agent promotes cross-linking by the linking agent of the target in the labeled sample to the detectably labeled binding moiety, to produce the cross-linked sample.

10. The method of claim 9, wherein the binding moiety is an antibody, a nanobody, a protein, a polypeptide, a nucleic acid, or a small molecule.

11. The method of claim 9, wherein the detectably labeled binding moiety is labeled with a fluorophore and the fluorophore is a bis-benzimide, a coumarin, a cyanine, a merocyanine, a pyrene, a fluorescein, a rhodamine, an oxazine, a carbopyronine, a semiconductor quantum dot, a polymer dot, or any combination thereof.

12. The method of claim 1, wherein the method is performed in less than 8 hours, less than 10 hours, less than 12 hours, less than 14 hours, less than 16 hours, less than 18 hours, less than 20 hours, less than 22 hours, or less than 24 hours.

13. The method of claim 1, wherein the water-swellable composition comprises one or more of a polyacrylic acid, a polyacrylamide, a polyvinyl alcohol, an alginate, a chitosan, or polymers thereof.

14. The method of claim 1, further comprising contacting the sample with one or more of a second binding moiety, a third binding moiety, a fourth binding moiety, or a fifth binding moiety.

15. The method of claim 1, further comprising contacting the processed sample with a dye.

16. A kit comprising:
(a) a linking agent;
(b) hydrophilic monomers;
(c) reagents for polymerizing the hydrophilic monomers to the water-swellable composition; and
(d) a homogenizing agent.

17. The kit of claim 15, wherein the water-swellable composition comprises a polyacrylic acid, a polyacrylamide, a polyvinyl alcohol, an alginate, a chitosan, or polymers thereof.

18. The kit of claim 15, wherein the linking agent comprises a polymerizable group and a label-reactive group.

19. The kit of claim 17, wherein the linking agent is methacrylic acid N-hydroxy succinimidyl ester, acrylic acid N-hydroxy succinimidyl ester, or glutaraldehyde.
